(19) United States
(12) Patent Application Publication
(10) Pub. No.: US 2025/0384146 A1
(43) Pub. Date: Dec. 18, 2025

(54) SECURE GRAPH PROCESSING WITH NORMALIZED ADJACENCY LISTS

(71) Applicant: Benjamin Leo Ostrovsky, Los Angeles, CA (US)

(72) Inventor: Benjamin Leo Ostrovsky, Los Angeles, CA (US)

(21) Appl. No.: 19/242,294

(22) Filed: Jun. 18, 2025

Related U.S. Application Data
(60) Provisional application No. 63/661,568, filed on Jun. 18, 2024.

(51) Int. Cl. G06F 21/60

(52) U.S. Cl. CPC G06F 21/60

(57) ABSTRACT

The present disclosure provides a method for processing a secret-shared adjacency list of a graph. The method includes partitioning the secret-shared adjacency list into blocks, adding a vertex identifier to each tuple in the secret-shared adjacency list, defining a boolean variable for each block, computing a secret-shared vector of row identifiers for each tuple, shuffling tuples and additional tuples, extracting components from the shuffled tuples to form a d-normalized replicated adjacency list, and storing the d-normalized replicated adjacency list in a non-volatile storage device. The method utilizes parallel processing capabilities and a hardware-based random number generator for shuffling. The method also includes securely transmitting and receiving encrypted data related to adjacency lists through a network interface.

### CROSS-REFERENCE TO RELATED APPLICATION

This application claims the benefit of U.S. Provisional Application Ser. No. 63/661,568 filed Jun. 18, 2024, the content of which is incorporated by reference herein in its entirety for all purposes.

### FIELD OF THE INVENTION

The present disclosure relates to secure computation, and more particularly to methods for converting a secret-shared adjacency list of a graph into a d-normalized replicated adjacency list and renaming vertices and attributing edges in a secret-shared adjacency list of a graph.

### BACKGROUND OF THE INVENTION

### 0.1 Secure Multi-Party Computation

Secure multi-party computation (MPC) allows two or more servers to jointly compute an arbitrary polynomial-time computable function on private data while learning only the size of the inputs and the output of the function and nothing else. These notions were developed in the 1980s both in the computational and in the information-theoretic settings. In the last decade, implementations of MPC have attracted considerable attention.

While initial work from the 1980s considered secure computation protocols solely for circuits (either Boolean or Arithmetic), it was recognized in 1997 that Random Access Memory (RAM) in the MPC setting could be realized to make MPC protocols more efficient. Follow-up works, adopting Oblivious RAM and GRAM to MPC support of RAM has gained much attention over the last decade. Integrating ORAM with MPC gave rise to distributed ORAM (DORAM). Applications of GRAM to MPC to achieve RAM access for MPC were considered in prior work.

### 0.2 Secure Graph Processing

The ability to perform random access is especially relevant for secure graph processing algorithms. Not surprisingly, graph processing has received considerable attention in the MPC literature.

Privacy-preserving graph processing has followed two common approaches:
(a) Adjacency Matrix Approach. Instead of a (secret-shared) adjacency list representation, the graph representation is converted to the adjacency matrix representation, which hides the degree of any node by scanning the entire row of the adjacency matrix.
(b) ORAM/GRAM Compilation Approach. An insecure graph algorithm is selected and compiled into a secure version using Distributed ORAM and/or Garbled RAM inside MPC.

### 0.2.1 Prior Work on Adjacency Matrix Approaches for Graph Processing

Prior works consider an adjacency matrix representation—approach (a)—to solve several graph algorithms, including breadth-first search (BFS), Single Source Shortest Path (SSSP) for an unweighted graph using BFS, minimum spanning tree (MST), and maximum flow. These achieve O(V²) work complexity for BFS, SSSP, and MST, as well as O(V³·Elog V) work for maximum flow. Other prior works implement Prim's algorithm to solve MST, with O(V log V) rounds and O(V²) work. These constructions have also been generalized to support minimum spanning forests. Prior works have also addressed SSSP for weighted graphs, where in order not to disclose the degree of any vertex, each vertex is padded to the graph's maximum n-1 degree. By permuting the adjacency matrix, they solve SSSP with O(V³) secure operations. Prior works further revised these works to achieve secure Dijkstra with O(V² log V) secure operation and O(V²) rounds.

### 0.2.2 Prior Work on ORAM/GRAM Compilers for Graph Processing

Approach (b) using Distributed ORAM to support random access inside MPC was introduced in previous work. ORAM compilation for graph processing was explored in alternative approaches. Specifically,

Previous work applied ORAM compilers to insecure Dijkstra, building all the necessary data structures to support it. Since the ORAM Compilers (of various building blocks) were not as developed as they are currently, early implementations required O(V log⁴V+Elog⁵V) secure operations and rounds.

Alternative constructions extended these ideas using an ObliVM ORAM framework, as well as two modifications: (1) loop coalescing and (2) avoiding weight updating. Loop coalescing made Dijkstra run in one loop, with a secret shared value indicating whether it was processing an edge or a vertex, as opposed to an inner and outer loop for vertex and edges, respectively. This allowed the method to avoid padding the vertices to the maximum degree while keeping the topology (i.e., the degree of each vertex) of the graph secret. The second change, avoiding decrease-key weight updating, was replacing the decrease-key step in the priority queue with an insert of a new item into the priority queue with a smaller weight. This increases the number of vertices in the Priority Queue. With these changes, O((V+E)log²V) secure operations are achieved.

It is important to examine generic transformations approach from Distributed Oblivious RAM (DORAM) and Garbled RAM (GRAM) for RAM style algorithms. It is noted that the latest DORAM does provide an addressable memory with private read/write capabilities with logarithmic overhead in the running time and logarithmic round complexity and even sub-logarithmic overhead for large blocks. However, a general compiler from arbitrary code to addressable memory adds another level of inefficiencies, such as implementing and supporting pointers and recursion and hiding which operation is performed at any particular step. For example, hiding which operation the CPU executes requires multiplexing the general-purpose CPU for all its instructions and doing it for each computation step. This alone results in considerable additional overhead. Furthermore, handling pointers and recursive program stack (if used) has to be explicitly programmed-for general MPC compilers, this leads to additional difficulties.

Recent progress on GRAM application was achieved in prior work. Alternative constructions present a variable instruction set architecture (VISA), a method of handling programs inside MPC, where all straight-line fragments of the code are unrolled into individual “custom” CPU instructions that are executed as garbled circuits, and the latest Garbled RAM is used for obvious random access. Since previous work incurs O(log³n·log log n) overhead, and insecure Dijkstra's with the HEAP for Priority Queue uses O((V+E)log V) operations, the result is O((V+E)log⁴ V log log V) secure operations and constant rounds.

Currently, ORAM overhead is far more efficient than GRAM overhead; thus, if the smallest overhead possible is desired at the expense of non-constant rounds, ORAM compilers' application to various insecure shortest path solutions should be examined. For example, if the asymptotically most efficient insecure Dijkstra algorithm is considered, which has O(V log V+E) running time, and compiled into secure DORAM, a logarithmic additional overhead is obtained for such a compilation (which is currently the best-case scenario for small blocks). That is, the naive compilation solution gets O((V log V+E)log V) secure operations and the same number of rounds. Even assuming O(log n/log log n) ORAM overhead for larger blocks, O((V log V+E)log V)/log log V) secure operations are obtained.

### 0.2.3 Graph Processing Algorithms That leak Partial Information

Some prior constructions relax the standard simulation-based security definition and permit leakage of partial graph structure. For example, one class of algorithms reveals the identity of the start node and progressively leaks which vertices have been explored, along with their distances. These constructions are not composable and are unsuitable for integration into larger secure computation frameworks.

Other constructions allow partial leakage of structural information, such as the shape of the graph or the number of exploration steps. Specifically, one prior work considers the so-called Radius-Stepping algorithm, where there is some graph structure leakage. The authors argue that such leakage can be further masked by running an algorithm for a longer number of iterations that could be determined experimentally. However, the bounds on the amount of masking to achieve provable guarantees that do not leak any information about the graph are not analyzed.

There remains a need for efficient and fully secure methods of performing graph computations in MPC settings. Ideally, such techniques would avoid information leakage, support arbitrary graph structures, and achieve favorable asymptotic and concrete performance. Advances in this area could enable privacy-preserving analysis of sensitive graph data across domains like social networks, financial systems, and healthcare.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Given a graph G (V, E), represented as a secret-sharing of an adjacency list, the present disclosure shows how to obliviously convert it into an alternative, MPC-friendly secret-shared representation, so-called d-NORMALIZED REPLICATED ADJACENCY LIST (which is abbreviated to d-normalized), where the size of the new data-structure is only 4× larger—compared to the original (secret-shared adjacency list) representation of G. Yet, this new data structure enables execution of oblivious graph algorithms that simultaneously improve underlying graph algorithms' round, computation, and communication complexity.

The d-normalization proceeds in two steps:
First, the present disclosure shows how for any graph G, given a secret-shared adjacency list, where vertices are arbitrary alphanumeric strings that fit into a single RAM memory word, vertices can be efficiently and securely renamed to integers from 1 to V that will appear in increasing order in the resulting secret-shared adjacency list. The secure renaming takes O(log V) rounds and O((V+E)log V) secure operations. The algorithm also outputs in a secret-shared form two arrays: a mapping from integers to alphanumeric names and its sorted inverse. Of course, if the adjacency list is already in such an integer format, this step could be skipped.
Second, given a secret-shared adjacency list for any graph G, where vertices are integers from 1 to V and are sorted, there exists a d-normalization algorithm that takes O(1) rounds and O(V+E) secure operations.

It is believed that both conversions may be applicable in other settings. The present disclosure demonstrates the power of these data structures by designing a privacy-preserving Dijkstra's single-source shortest-path algorithm that simultaneously achieves O((V+E)·log V) secure operations and O(V·log V·log log log V) rounds. The present disclosure also demonstrates that these techniques apply to privacy-preserving Prim's algorithm to compute MST in O ((V+E)·log V) secure operations and O(V·log V·log log log V) rounds.

The secure algorithms works for any adjacency list representation as long as all vertex labels and weights can individually fit into a constant number of RAM memory words. The algorithms work for two or a constant number of servers in the honest but curious setting. The limitation of this result (to only a constant number of servers) is due to the reliance on linear work and constantround secure shuffle.

According to aspects of the present disclosure, a method, system, and non-transitory computerreadable medium are provided for converting a secret-shared adjacency list of a graph into a dnormalized replicated adjacency list. The method includes partitioning, by at least one processor executing instructions stored in a memory, the secret-shared adjacency list into consecutive blocks of d tuples each. The method also includes adding a vertex identifier to each tuple, defining a boolean variable for each block, computing a secret-shared vector of row identifiers for each tuple, shuffling the tuples, extracting components from the shuffled tuples to form the d-normalized replicated adjacency list, and storing the d-normalized replicated adjacency list in a non-volatile storage device. The method is executed in a manner that is oblivious to the contents of the tuples.

According to other aspects of the present disclosure, the method, system, and non-transitory computer-readable medium may include one or more of the following features. The secret-shared vector of row identifiers may be computed using a prefix-sum operation. A boolean variable may be defined for each tuple to indicate whether the tuple is the first edge or the last edge within a block. Additional tuples may be created to fill empty rows with dummy clements. The boolean variable for each block may be computed using a secure comparison operation. The shuffling of the tuples may be performed using a secure shuffle algorithm. A binary continuation marker for each row may be computed using a secure evaluation of adjacency between consecutive rows.

According to other aspects of the present disclosure, a method, system, and non-transitory computer-readable medium are provided for renaming vertices and attributing edges in a secret-shared adjacency list of a graph. The method includes securely marking vertices and edges, computing a secret-shared vector of vertex identifiers, assigning addresses to tuples, performing an oblivious sort using a hardware-accelerated sorting algorithm, executing a name extension subroutine, shuffling the tuples, and revealing assigned addresses to finalize the renaming and attribution.

According to other aspects of the present disclosure, the method, system, and non-transitory computer-readable medium for renaming vertices and attributing edges may include one or more of the following features. A new variable may be added to each tuple to represent the new integer vertex name. The prefix sum operation may ensure each vertex is assigned a distinct integer identifier in increasing order. The oblivious sort may be performed based on a comparison predicate that sorts tuples alphabetically and prioritizes vertices over edges. The name extension subroutine may be executed in parallel. The secure shuffle algorithm may use a fresh permutation for each execution.

The system for converting a secret-shared adjacency list may include a plurality of processors, a memory subsystem comprising high-speed cache memory and main memory, a non-volatile storage device, a network interface configured for secure communication, and a system bus interconnecting these components. The system is configured to perform operations similar to those of the method for converting a secret-shared adjacency list.

These aspects of the present disclosure are applicable to methods, systems, and non-transitory computer-readable media for performing the described operations in a computerized system comprising multiple processors, memory subsystems, non-volatile storage devices, and network interfaces connected via a system bus.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a flowchart depicting a method for processing a secret-shared adjacency list, according to aspects of the present disclosure.

FIG. 2 depicts a flowchart showing a method for processing a secret-shared adjacency list using hardware components, according to an embodiment.

FIG. 3 illustrates a sequence diagram of secure graph processing interactions between hardware components, in accordance with example embodiments.

FIG. 4 depicts a block diagram of a secure graph processing system, according to aspects of the present disclosure.

FIG. 5 illustrates another block diagram of a secure graph processing system with external components, according to an embodiment.

FIG. 6 depicts a flowchart of a vertex renaming and edge attribution system, in accordance with example embodiments.

FIG. 7 illustrates a block diagram of a client computing architecture, according to aspects of the present disclosure.

FIG. 8 depicts a block diagram of a server-client network architecture, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

### 1 Overview of the Disclosure

### 1.1 Changing Graph Representation

Given any graph G(V, E), represented as an adjacency list, it can be that by replicating vertices and padding adjacency lists with⊥'s, any graph G can be converted into a graph on 2V (potentially repeating) vertices, such that each potentially copied vertex has (partial) adjacency list that is exactly twice the average degree of the original graph, padded with⊥'s as needed. This form of graph representation is referred to herein as a d-NORMALIZED REPLICATED ADJACENCY LIST. One aspect of the present disclosure provides a secure algorithm for converting a secret-shared adjacency list into a secret-shared d-normalized replicated adjacency list. The resulting structure increases in size by a factor of at most four compared to the original secret-shared representation.

To construct this representation, a parameter d is defined as an integer value twice the average degree of the original graph, rounded up. Both the number of vertices and total number of edges are assumed to be publicly known, so the average degree can be computed without revealing private information. For any vertex with fewer than d edges, the adjacency list is padded with⊥ symbols to achieve a length of exactly d. For vertices with more than d outgoing edges, multiple consecutive copies of the vertex are created in the replicated adjacency list representation. Each copy contains a distinct segment of at most d edges from the original vertex's adjacency list, padded as necessary.

Definition 1. d-Normalized Replicated Adjacency List. For any graph G, a d-NORMALIZED REPLICATED ADJACENCY LIST is an adjacency list representation of G in which vertex u may appear multiple times, subject to the following properties:
1. For any edge (u, v)∈G, κ appears in at least one replicated adjacency list of u.
2. Each adjacency list of u is of length exactly d, containing either vertices of G or ⊥.
3. If there is more than one adjacency list corresponding to vertex u in the replicated adjacency list, all of u's adjacency lists appear consecutively.
4. Multiple⊥ entries with d-length⊥'s for its adjacency lists are permitted.

By way of example (ignoring edge weights) consider a vertex u with outgoing edges to vertices (b, c, d, e, g). A standard adjacency list representation will include a linked list: [u, (b, c, d, e, g)]. A 2-REPLICATED ADJACENCY LIST for u could be: [u, (b, c)], [u, (d, e)], [u, (g,⊥)], [u, (⊥,⊥)] with all copies of u appearing consecutively. Similarly, a 3-NORMALIZED REPLICATED ADJACENCY LIST for u could be: [u, (b, c, e)], [u, (d, g,⊥)] or alternatively: [u, (b, c, e)], [u, (d,⊥,⊥)], [u, (g,⊥,⊥)], [u, (⊥,⊥,⊥)]. Condition 4 permits inclusion of⊥ entries in the replicated adjacency lists. By way of example, in the 2-normalized adjacency list, entries of the form (⊥, (⊥,⊥)) are permitted.

Two types of adjacency list representation are considered for any graph G(V, E):
Sorted Integer Representation: Vertices are integers from 1 to V and appear in increasing order within the adjacency list.
Alphanumeric Vertex Representation: Vertices are arbitrary alphanumeric strings, subject to the constraint that each vertex label fits into a single RAM memory word.

The following construction enables conversion from alphanumeric vertex representation to sorted integer representation.

Theorem 1. (Oblivious Graph Renaming) For c servers, assume the existence of an honest-butcurious SECURE SHUFFLE protocol with linear work and O(1) round complexity, resilient against any collusion of at most u<c servers. Further assume the existence of a c-server MPC protocol exists for Arithmetic Black Box (ABB) operations tolerating at most u<c colluding servers. Given an adjacency list A for any graph G(V, E), where vertex labels are arbitrary alpha-numeric strings that fit within a single memory word, there exists a secure algorithm for c servers, tolerating u<c collusions, to convert [symbol] [symbol] [symbol] into [symbol] [symbol] [symbol] , where [symbol] is an adjacency list of G with vertices that are ordered integers from 1 to V. The conversion algorithm executes in O(log V) rounds and performs O((V+E)log V) secure operations. The algorithm also outputs a secret-sharing of the mapping from ordered integers to original alphanumeric labels and from sorted alphanumeric labels to integers.

The Oblivious Graph Renaming algorithm described above may be applicable in other settings. For example, knowledge graphs and Privacy-Enhancing Technologies (PETs) often work on graphs where alphanumeric labels represent data. In information science, ontology graphs are used with alphanumeric vertex labels. The disclosed algorithm enables secure and efficient conversion of such graphs into integer-labeled representations suitable for cryptographic computation. Moreover, the construction supports secret-shared mappings to allow recovery of original vertex labels following computation.

d-Normalization. The present disclosure includes a secure algorithm for obliviously converting an integer-labeled adjacency list of G (where integer labels range from 1 to V) into a d-normalized replicated adjacency list. This result relies on the counting argument described in lemma 6. The dnormalized representation is secret-shared and at most four times larger than the original adjacency list.

As with previous construction, this algorithm assumes the existence of a secure shuffle protocol. At the time of this writing, secure shuffle protocols are known for a small number of honest-but-curious, non-colluding servers (typically two or three). The methods described herein treat the secure shuffle as a black-box primitive. As such, if future developments enable secure shuffling with linear work and constant round complexity for a larger number of servers, the disclosed algorithms and theorems remain applicable in those extended settings (see formal definition in Section 2.2). Additionally, ABB operations are assumed, with the same collusion threshold.

Theorem 2. (Secure d-Normalization) For c servers, assume the existence of an honest-but-curious SECURE SHUFFLE protocol with linear work and O(1) rounds, resilient against any collusion of at most u<c servers. Further assume the existence of a c-server MPC protocol for ABB operations, tolerating at most u<c colluding servers. Assume that e servers hold a secret-shared adjacency list [symbol] [symbol] [symbol] for a graph G(V, E), where vertex labels are integers from 1 to V and appear in increasing order within [symbol] . Then, there exists an honest-but-curious secure algorithm, tolerating up to u collusions, to obliviously convert [symbol] [symbol] [symbol] into a ┌2E/V┐-normalized replicated adjacency list of size 4 [symbol] [symbol] [symbol] . This conversion takes O(1) rounds and performs O(V+E) secure operations.

Theorems 1 and 2 do not rely on SISO-PRF as part of the ABB functionally (see Section 2.1). Therefore, the above results for three or a constant number of servers are unconditional.

Secure Dijkstra. Given a secret-sharing of the start vertex s and a secret-sharing of a directed weighted graph G with non-negative weights, the objective is to compute Dijkstra's shortest path algorithm in a secure manner. More specifically, the goal is to compute the Single Source Shortest Path (SSSP), producing a secret-shared vector containing the numerical value for the shortest path from the source to each vertex in G, referred to as the SSSP distance vector. This computation must not reveal any information about G beyond its total number of vertices and edges. In addition to computing distances, the protocol can securely compute a secret-shared predecessor for each vertex. A key requirement is that both the distance and predecessor vectors must be computed and retained in secret-shared form in order to serve as reusable subroutines in other secure computations. This contrasts with prior approaches in which the distance vector is revealed in the clear during execution.

The secure Dijkstra algorithm described herein requires evaluation of SISO-PRF in a constant number of rounds. Although constant-round MPC can implement such functions under standard cryptographic assumptions (e.g., one-way functions), the protocol in this disclosure does not require full-fledged SISO-PRF functionality. Instead, it utilizes a restricted variant of SISO-PRF where inputs are integers in the range [1, V]. Such limited SISO-PRFs can be constructed in three (or more) server settings without additional cryptographic assumptions. However, these constructions typically require a logarithmic number of rounds due to their reliance on recursive positionmap structures, and therefore may not satisfy round-efficiency constraints.

Theorem 3. (Secure Dijkstra) Let k: be a security parameter and G(V, E) be a directed weighted graph with non-negative edge weights, where all weights and vertex labels fit within a single RAM memory word. Assume the existence of an honest-but-curious SECURE SHUFFLE protocol for c servers with linear work and O(1) rounds for c servers, resilient to any collusion of at most u<c servers. Further assume that a c-server MPC protocol exists for ABB operations, including SISOPRF, tolerating at most u<c colluding servers. Then, given as input a secret-sharing of a start vertex and a secret-sharing of G, there exists a c-server honest-but-curious SSSP protocol, resilient to up to u collusions, that computes the output using O((V+E)log V) secure operations and O(V·log V·log log log V) rounds, where all secure operations are bounded by a fixed polynomial in k.

A comparison of Theorem 3 to prior approaches for secure SSSP is provided in Table 1.1. To construct a secure Dijkstra algorithm, it is necessary to implement a secure variant of the priority queue, a core component of Dijkstra's algorithm. While prior works have addressed secure priority queues in the client-server ORAM model, these models assume a trusted client, which is not applicable in the MPC setting. Simulating the client within an MPC environment presents unique challenges.

The protocol builds upon a priority queue construction by Jafargholi et al., originally designed for client-server environments. That construction achieves O(log n) overhead, whereas other approaches (e.g., based on worst-case Fibonacci heaps) impose stricter memory or round-complexity constraints. For instance, follow-up constructions require client memory that scales with log (1/δ) for negligible failure probability δ, which is undesirable when simulating the client in MPC.

### Secure Single Source Shortest Path Schemes

TABLE 1
Comparison of the disclosed method to previous work, counting the number
of Arithmetic Black Box (ABB) operations. ABB operations include
secure addition, multiplication, and comparison; in the two-server
case, they may also include secure public-key operations such as
encryption, decryption, and homomorphic addition.
Secure Single Source Shortest Path Schemes

| Secure SSSP | Secure Operations | Round Complexity |
|---|---|---|
| Aly et al. (2013) | O(V³) | O(V² logV) |
| Keller et al. (2014) | O(Vlog³V + E log⁴V) | O(V log³V + E log⁴V) |
| Liu et al. (2015) | O((V + E) log²V) | O((V + E) log²V) |
| Aly et al. (2022) | O(V²logV) | O(V²) |
| Yang et al. (2023) | O((V + E) log⁴V log logV) | O(1) |
| Naive Solution using DORAM | $O ( \frac{( V log V + E ) log V}{log log V} )$ | O((V logV + E) logV) |
| Present disclosure | O((V + E) logV) | O(V · logV · log log logV) |

Theorem 4. (Secure OPQ) Assume the existence of honest-but-curious SECURE SHUFFLE protocol with linear work and O(1) rounds for c servers, resilient against any collusion of at most u<c servers. Further assume the existence of a c-server MPC protocol for ABB operations, including SISO-PRF, tolerating at most u<c colluding servers. Assume that all elements and priorities fit into a single RAM memory word of OPQ. Then, there exists c-server honest-but-curious OPQ protocol tolerating at most u<c collisions, supporting n elements with the amortized cost of O(log n) secure operations and O(log n·log log log n) rounds for each of EXTRACT-MIN, INSERT, and PARALLEL-DECREASE-KEY OPQ-procedures, where all secure operations are bounded by a fixed polynomial in k number of steps.

An alternative to the OPQ construction is to use a pointer-based worst-case Fibonacci heap together with MPC-ORAM compilation. However, such approaches yield worse performance, e.g., O((V log V+E)log V) operations, which exceeds the cost of the method described herein. Additionally, ORAM-based methods often suffer from inefficiencies in round complexity.

It is also noted that traditional Fibonacci heaps are not secure under timing side channels, even when subroutines are ORAM-protected. Because Fibonacci heaps achieve expected O(1) runtime for certain operations (e.g., decrease-key), timing behavior may vary based on input graph structure, potentially leaking information. In contrast, the disclosed method performs each subroutine with a fixed amount of work that does not depend on graph topology, thus avoiding such leakage.

### 1.2 Applications of Secure SSSP

Data-oblivious SSSP algorithms have several practical applications, including those listed below. Data-oblivious SSSP algorithms have several practical applications, some of which are listed below. In addition, the disclosed graph representation may be applicable to other oblivious graph algorithms, as it hides the degree of the vertices yet maintains the efficiency of adjacency-graph representation.
Privacy-Preserving Navigation Systems: In a navigation system, the shortest path information between locations might be sensitive for some users. Data-oblivious algorithms can ensure that the shortest path computation does not reveal any private information about the user's starting point, destination, or frequently visited locations.
Secure Graph Processing: In distributed graph processing, where multiple servers collaboratively analyze graphs without revealing sensitive information, data-oblivious SSSP algorithms can ensure that no party can infer the private attributes or structure of the graph.
Computational Biology: Problems such as edit distance computation and sequence alignment may be reduced to secure SSSP as a building block. These protocols enable secure analysis of genomic data without disclosing individual sequences.
Social network analysis: Secure SSSP enables privacy-preserving computations on sensitive social graphs (e.g., friendship or follower graphs) without revealing underlying connections or network structure.

Additional applications include outsourcing mobile computations to untrusted cloud servers and the development of privacy-preserving knowledge graphs. In such settings, the disclosed graph representations and SSSP algorithms allow computation over siloed or sensitive ontologies while maintaining confidentiality.

### 2 Preliminaries

Two samplable families of distributions {Xₙ} and {Yₙ} are computationally indistinguishable {Xₙ}≠{Yₙ} if for all constants c, and for all probabilistic poly-time adversaries [symbol] , and for all sufficiently large n, |Pr[x←Xₙ: [symbol] (x)=1]−P[y←Yₙ: [symbol] (y)=1]|<1/nc. A Random Access Memory (RAM) algorithm ALG is said to be oblivious if, for any two inputs of the same length, ALG takes the same number of steps and the distribution of RAM locations accessed is computationally indistinguishable.

Let k: d denote the computational security parameter (e.g., the size of the key for block-cipher, such as AES.) Each server is modeled as a RAM machine, where a single RAM word can be read or written and perform CPU operations in one step. Each word of RAM is of size O(k), and thus cryptographic keys, vertex labels, and edge weights can fit within one (or a small constant number of) RAM words.

Lower-case letters represent variables and parameters, except for V and E, which refer to both the vertex and edge sets of graph G and also their respective cardinalities. Arrays are denoted with capital letters. The i-th element of array Y is denoted Yᵢ.

Definition 2 (Secret-Sharing). Let s denote the number of servers, and let U represent the set of maximally corruptible subsets of {0, . . . , s−1}. Let Share be a randomized function mapping X→Xₛ, and let Reconstruct be a deterministic function mapping Xₛ→X. The pair (Share, Reconstruct) defines a U-secure secret-sharing scheme if, for all x∈X, Reconstruct(Share(x))=a with probability 1, and for all u∈U and all xₐ, a_{b}∈X, the distributions of Share(xₐ)u and Share(x_{b})u are identical, where Shar (·)u is the view of any U servers.

The notation [symbol] x [symbol] denotes a secret-sharing of the value a. A secret-sharing [symbol] x [symbol] is said to be a fresh secret-sharing of a: if its random distribution is independent of all previous distributions. For an array A, the notation [symbol] A [symbol] refers to the entry-wise secret-sharing of each element in A. The dimension of A (i.e., its length or shape) is assumed to be publicly known.

The setting considered involves two, three, or a constant number of servers holding secret-shared representations of a graph's adjacency list and a start vertex. Only the total number of vertices V and edges E is assumed to be public. The topology of the graph (e.g., vertex degrees or maximum degree) remains hidden. At the end of the computation, the distance vector and shortest-path structure should remain secret-shared.

Secure multi-party computation is expressed using an ideal Arithmetic Black Box functionality, denoted [symbol] _{ABB}, which enables secure computation over a finite field [symbol] via predefined operations.

2.1 Arithmetic Black Box functionalities

The functionalities of [symbol] _{ABB} include the following operations, all performed over a publicly known finite field [symbol] :
[symbol] z [symbol] ← [symbol] _{ABB}.add ( [symbol] x [symbol] , [symbol] y [symbol] ): Produces a fresh secret-sharing of z=x+y from secret-shared inputs [symbol] x [symbol] and [symbol] y [symbol] . This operation is assumed to be non-interactive. This operation is referred to herein as “silent” addition.
[symbol] z [symbol] ← [symbol] _{FABB}.multiply( [symbol] x [symbol] , [symbol] y [symbol] ): Produces a fresh secret-sharing of ==x. y.
[symbol] z [symbol] ← [symbol] _{FABB}.exp( [symbol] x [symbol] , [symbol] y [symbol] ): Computes a fresh secret-sharing of ==xy.
[symbol] z [symbol] ← [symbol] _{FABB}.min( [symbol] x [symbol] , [symbol] y [symbol] ): Produces a fresh secret-sharing of ==min (x, y).
[symbol] z [symbol] ← [symbol] _{FABB}.max( [symbol] x [symbol] , [symbol] y [symbol] ): Produces a fresh secret-sharing of ==max (x, y).
[symbol] z [symbol] ← [symbol] _{FABB}.compare( [symbol] x [symbol] , [symbol] y [symbol] ): Outputs a secret-shared boolean value z, where z is True if x<y, and False otherwise. When comparing alphanumeric strings, the comparison is lexicographic.
[symbol] z [symbol] ← [symbol] _{FABB}.equality( [symbol] x [symbol] , [symbol] y [symbol] ): Produces a secret-shared boolean z indicating whether 2 =y.
[symbol] z [symbol] ← [symbol] _{FABB}.bit-decomposition( [symbol] x [symbol] ): Converts a secret-shared field element [symbol] x [symbol] into a secret-sharing of individual bits of the bit decomposition of x.
[symbol] z [symbol] ←SISO-PRF( [symbol] s [symbol] , [symbol] x [symbol] ): Shared-Input, Shared-Output Pseudo-Random Function (SISOPRF) takes secret shared key [symbol] s [symbol] , a secret shared input [symbol] x [symbol] , and computes a fresh secret shared output [symbol] z [symbol] , where z=PRFₛ(x).
   As SISO-PRF is the most expensive ABB function, the present disclosure does not use it during the secure graph conversion algorithm. For the secure Dijkstra algorithm, SISO-PRF is invoked once for every d edges, where d is approximately twice the average degree.

Since all algorithms in the present disclosure are constructed from compositions of ABB operations and are proven oblivious at the level of ABB functionality, the standalone composition theorem applies for the security of the overall construction.

### 2.2 Building Blocks

Silent PrefixSum The disclosed system repeatedly uses (as a building block) the SILENT PREFIXSUM algorithm. Given a secret-sharing of an array of n field elements in GF(q), [symbol] x₁, . . . , xₙ [symbol] , compute

$$[ {y}_{1} , … , {y}_{1} ] ← SILENT PREFIXSUM ( [ {x}_{1} , … , {x}_{n} ] )$$

where each [symbol] yᵢ [symbol] is a fresh sharing of

$${\sum }_{1}^{i} {x}_{i} .$$

Specifically, if x₁, . . . , x_{q} are secret-shared, and the underlying secret-sharing scheme supports non-interactive addition of the secret-shared values, the servers can compute the secret-sharing of an array y₁, . . . , y_{q} silently-without any interaction with each other. It is noted that the full generality of prior general-purpose secure computation techniques is not required for for SILENT PREFIXSUM, since each server can locally compute a fresh share of each yᵢ.

Compositional Secret-sharing of Permutations A permutation π∈Sₙ on n elements to be secret-shared among c≥2 servers P₁, P₂, . . . , P_{c} if every server holds permutation πᵢ on n elements, such that π=π₁∘π₁∘ . . . ∘π_{c}, where ∘ is composition operator. [symbol] π [symbol] denotes such a secret-sharing. A uniform random permutation can be easily sampled silently:

$$π ← \text{SAMPLE-FRESH-PERMUTATION}$$

by all c servers, with each server Pᵢ just picking a fresh uniform random permutation πᵢ. Prior constructions show how to store such compositional permutations, apply them with linear work and constant number of rounds on any n-size secret-shared array, and how to evaluate π⁻¹ on secret-shared arrays of size n by applying

$${π}_{c}^{- 1} ∘ {π}_{( c - 1 )}^{- 1} ∘ , … , ∘ {π}_{1}^{- 1} .$$

Secure Shuffle Given a secret-shared array [symbol] A [symbol] =([ [symbol] x₁ [symbol] , . . . , [symbol] x₂ [symbol] ]) where each item has d bits, and a secret-sharing of a permutation [symbol] π [symbol] securely compute a secret-shared array [symbol] Â [symbol] of n elements:

$$A ← \text{SECURE-SHUFFLE} ( A , π )$$

where ∀i, 1≤i≤n, [symbol] Â_{π(i)} [symbol] is a fresh copy of [A]. Given [7] , these protocols also support securely computing [symbol] π⁻¹ [symbol] silently (i.e. without any communication). Two-party secure shuffle with linear work and constant rounds is known based on additively homomorphic encryption, while three-party (or a constant-party) secure shuffle can be constructed unconditionally.

Oblivious k-Compaction: Given a public parameter k<n, and two secret-shared arrays, a boolean array of n bits [symbol] B [symbol] =[ [symbol] b₀ [symbol] , . . . , [symbol] b₍ₙ₋₁₎ [symbol] ] where exactly k bits are 1, and an array of length n: [symbol] A [symbol] =[ [symbol] a₀ [symbol] , . . . , [symbol] b₍ₙ₋₁₎ [symbol] ]] where each ai is d bits, compute a fresh secret-sharing of array [symbol] C [symbol] =[ [symbol] c₀ [symbol] , . . . , [symbol] c₍ₙ₋₁₎ [symbol] ] which extracts k elements from [symbol] A [symbol] for which bᵢ=1, not necessarily in the same order:

$$C ← OBLIVIOUS k - COMPACT ( k , B , A )$$

That is, ∀i for which bᵢ=1, ∃!j such that C[j] is a fresh copy of A[i]. Let array [symbol] BA [symbol] denote pairing of entries of [symbol] A [symbol] with entries of [symbol] B [symbol] , where i'th entry of [symbol] BA [symbol] is [symbol] (bᵢ, aᵢ) [symbol] . Oblivious k-compaction is done as follows:
1. [symbol] π [symbol] ←SAMPLE-FRESH-PERMUTATION
2. [symbol] A [symbol] =[( [symbol] b′₀ [symbol] , [symbol] a′₀ [symbol] ), . . . , [symbol] (b′₍ₙ₋₁₎ [symbol] , [symbol] a′₍ₙ₋₁₎) [symbol] ]←SECURE-SHUFFLE( [symbol] BA [symbol] , [symbol] π [symbol] )
3. Open all b′ᵢ in [symbol] D [symbol] and compute [symbol] C [symbol] as subset of all a′ᵢ s.t. b′ᵢ=1.

Oblivious Use-Once-KVS The disclosed implementation of Dijkstra includes a new primitive called USE-ONCE KEY-VALUE STORE (ONCE-KVS for short), an oblivious data structure to retrieve, once for each key, a large payload indexed by short distinct keys. The construction improves upon existing key-value store approaches in efficiency, subject to a single-use restriction on each key.

Specifically, the primitive accepts a list of distinct keys, each associated with a large payload. It builds a new data structure where the build time takes only a constant number of rounds and is linear time and linear communication. However, retrieval time is faster than prior works: it is a single call to SISO-PRF, independent of the size of the payload, and returns a pointer to a fresh secret-sharing of a payload that does not reveal which key that payload is associated with. To reiterate, the restriction is that every key lookup can be used only once. The following describes this primitive and its implementation:

The system is given two arrays of the same length: a secret-shared array of keys [symbol] K [symbol] =[ [symbol] k₀ [symbol] , . . . , [symbol] k₍ₙ₋₁) [symbol] ] where each kᵢ is a secret-sharing of unique (typically short) key kᵢ, and an array of secret-shared payloads [symbol] P [symbol] =[ [symbol] p₀ [symbol] , . . . , [symbol] pₙ₋₁ [symbol] ] of length q bits each. The present disclosure uses this primitive for secure Dijkstra, where each payload will be an array of d edges. Therefore the payload will not be individual bits but rather an array of d tuples, where each tuple is a secret sharing of an edge (or a⊥ of the same bit-length as edge representation) together with its weight as well as other information. However, this does not change the semantics of a large payload \vec{pᵢ} in USE-ONCE KEY-VALUE STORE.

USE-ONCE KEY-VALUE STORE supports two operations:
KVS.INITIALIZE( [symbol] k₁ [symbol] [symbol] \vec{p₁} [symbol] ), ( [symbol] k₂ [symbol] [symbol] \vec{p₂} [symbol] ), . . . ( [symbol] kₙ [symbol] [symbol] \vec{pₙ} [symbol] )).
( [symbol] \vec{pᵢ} [symbol] )←KVS.READ ( [symbol] kᵢ [symbol] ) This operation outputs the secret shared payload of q bits. Each key xᵢ can only be retrieved once.

KVS.INITIALIZE:
1. Generate a secret-shared seed [symbol] s [symbol] for SISO-PRF
2. For 1<i<n, compute [symbol] tagᵢ [symbol] +SISO-PRF( [symbol] s [symbol] , [symbol] kᵢ [symbol] )
3. [symbol] π [symbol] ←SAMPLE-FRESH-PERMUTATION
4. [symbol] A [symbol] ←SECURE-S_{HUFFLE}[( [symbol] tag₁ [symbol] [symbol] \vec{pᵢ} [symbol] ), . . . , ( [symbol] tagₙ [symbol] \vec{pᵢ} [symbol] , [x])
5. [symbol] B [symbol] ←reconstruct all tags in [symbol] A [symbol] and build a lookup table indexed by tags.
6. The array [symbol] B [symbol] consists of n pairs of the form (tagᵢ, [symbol] \vec{pᵢ} [symbol] ) where tagᵢ is in the clear and can be used to look up and retrieve secret-shared [symbol] \vec{pᵢ} [symbol] .

KVS.READ( [symbol] kᵢ [symbol] )
1. [symbol] tagᵢ [symbol] ←SISO-PRF( [symbol] s [symbol] , [symbol] kᵢ [symbol] )
2. tagᵢ←open [symbol] tagᵢ [symbol]
3. [symbol] \vec{pᵢ}←Lookup tagᵢ in [symbol] B [symbol] and retrieve payload that matches [symbol] tagᵢ

[symbol]

Theorem 5. (Oblivious Use-Once KVS) Assume the existence of honest-but-curious SECURE SHUFFLE protocol with linear work and O(1) rounds for c servers, resilient against any collusion of at most u<c servers. Further, assume that there exists a c-server MPC protocol for ABB operations, including SISO-PRF, tolerating at most u<c colluding servers. Two arrays of equal length are given as input: a secret-shared array of keys [symbol] K [symbol] =[ [symbol] k₀ [symbol] , . . . , [symbol] kₙ₋₁ [symbol] ] where each kᵢ is a secret-sharing of unique (typically short) key kᵢ, and an array of secret-shared payloads [symbol] P [symbol] =[ [symbol] p₀ [symbol] , . . . , [symbol] pₙ₋₁ [symbol] ] of length q bits each. There exists an USE-ONCE OBLIVIOUS KEY-VALUE STORE (Use-Once OKVS) with the following properties:
1. Initializations takes O(n) secure operations. Specifically, it takes n calls to SISO-PRF, and one secure shuffle of an array of size n elements each of size q+k, where k is the security parameter, which is also the length of the SISO-PRF output.
2. Each read takes O(1) operations. Specifically, one execution of SISO-PRF.

Oblivious Sort The disclosed system takes as input two arrays of the same length: a secret-shared array of keys [symbol] K [symbol] =[ [symbol] k₀ [symbol] , . . . , [symbol] kₙ₋₁ [symbol] ] where each kᵢ is a secret-sharing of a key kᵢ, (not necessarily unique) and an array of secret-shared values [symbol] W [symbol] =[ [symbol] w₀ [symbol] , . . . , [symbol] wₙ₋₁ [symbol] ]. Individual keys kᵢ and individual values wᵢ are bounded by a fixed O(1) number of words of RAM memory in length. The OBLIVIOUS SORT algorithm is provided with a secure comparison function IS-LESS-THEN that outputs a boolean value β:

$$β ← \text{IS-LESS-THEN} ( ( {k}_{i} , {w}_{i} ) ( {k}_{j} , {w}_{j} ) )$$

which returns a secret-sharing of a boolean β=1 only if (kᵢ, wᵢ)<(kᵢ, wᵢaccording to predefined implicit ordering, specified when the sort is invoked. The running time is O(n log n) secure comparison operations and ((log n) rounds. The communication complexity is the communication complexity of a single secure comparison times O(n log n). As SECURE SHUFFLE is assumed, the sorting can be done efficiently and does not need AKS sorting network. The present disclosure will sort lists of size O(V+E) where each item is a constant number of words of memory and, therefore, will take O((V+E)log V) secure operations and O(log V) rounds.

Running Dijkstra: Privacy-Preserving Data-Structures

To support Dijkstra, several data structures are required. One such data structure is the USE-ONCE KEY-VALUE STORE table, which enables retrieval of a normalized adjacency list containing exactly d edges for each (potentially replicated) vertex. The main efficiency of the disclosed protocol comes from the fact that edges (broken up into chunks of size d) are not inside DORAM but rather are stored inside USE-ONCE KEY-VALUE STORE as payloads p; and hence do not incur multiplicative overhead. That is, USE-ONCE KEY-VALUE STORE stores, for each vertex, its adjacency list, broken up into chunks of size d. Dijkstra's “relax” operation is performed for the adjacency list of d edges in parallel since all d elements in the adjacency list are either distinct or ⊥.

A DORAM maintains a distance vector with n entries. A secure priority queue supporting parallel decrease-key operations is also employed. The secure priority queue is further outlined in the following:

Oblivious Priority Queue with Parallel Decrease Key Dijkstra requires a min-heap Priority Queue supporting three operations: Build Min-Heap with V items; execute Decrease-Key E times, and Extract-Min V times. For the purpose of computing Dijkstra's algorithm securely, all of these operations must be done securely. The present disclosure uses (a modification of) privacy-preserving Oblivious Heap of Jafargholi at. Adapting the prior construction requires solving several road blocks, outlined below.
Prior work establishes the result in the ORAM client-server model, rather than in the MPC model with two or more servers and no client. In that setting, the client possesses O(log n)-word local memory and can download and sort lists of size O(log n) without incurring secure computation costs. In the MPC model, no such client exists, and sorting of non-constant size lists must be performed securely.
Prior work describes a data structure that supports oblivious extract-min and decrease-key operations with O(log n) overhead. To reduce round complexity, the disclosed system performs d decrease-key operations in parallel. The d-NORMALIZED REPLICATED ADJACENCY LIST requires only Exclusive Write Exclusive Read (EWER) parallelism, as the system processes (i.e., relaxes) a single d-normalized adjacency list in parallel. This achieves amortized O(log n) work per operation and amortized O(log n log log log n) rounds across all d such operations jointly.

In the MPC model, amortized work per operation will remain O(log n), where n is the total number of items. Section 5, shows that w decrease-key operations can be executed in parallel with O(w log n) work and O(log log log n) round complexity, using the following functionalities:
PQ.INITIALIZE(( [symbol] k₁ [symbol] , [symbol] p₁ [symbol] ), . . . , ( [symbol] k_{w} [symbol] , [symbol] p_{w} [symbol] )).
   Initialization takes a secret shared list of items (k₁, p₁) . . . (k_{w}, p_{w}), of keys and their priorities and executes PQ.INSERT( [symbol] kᵢ [symbol] , [symbol] pᵢ [symbol] ) for all items in the list, one at a time. For a list of size w, this takes O(w log n) work and O(w·log log log n) rounds.
PQ.INSERT( [symbol] k [symbol] , [symbol] p [symbol] ).
   Inserts item (k, p) into the Priority queue, at the root, while maintaining heap order. This operation takes O(log n) work and O(1) rounds.
PQ.PARALLEL-DECREASE-KEY(( [symbol] k₁ [symbol] , [symbol] p₁ [symbol] ), . . . , ( [symbol] k_{w} [symbol] , [symbol] p_{w} [symbol] )).
   This operation inserts a copy of items (k₁, p₁) . . . (k_{w}, p_{w}), with updated priorities. This takes O(w log n) work and O(log w log log log n) rounds.
( [symbol] k [symbol] , [symbol] p [symbol] )←PQ.EXTRACT-MIN.
   Outputs secret-shared item (k, p) which has the lightest priority p within the PQ. This takes O(log n) work and O(1) rounds.

Further implementation details are provided in Section 5.

Shared Distance Vector An array of vertex distances is initialized with 0 for the source and inf for all other entries. This array is stored in DORAM of size V and updated during each decreasekey/extract-min sequence.

DORAM DORAM-SETUP(k, d, n, [symbol] B [symbol] ): Given public parameters k, d, and n, and a secret-shared array [symbol] B [symbol] =[ [symbol] (a₀, α₀) [symbol] , . . . , [symbol] (a₍ₙ₋₁₎, α₍ₙ₋₁₎) [symbol] ] where each aᵢ is k bits long and each αᵢ is d bits long, define a (virtual, exponential-size) array A containing 2^{k} (virtual) secret-shared elements of size d each. All locations aᵢ are initialized to contain [symbol] αᵢ [symbol] whereas all other locations are ⊥, supporting the following Access( [symbol] op [symbol] , [symbol] i [symbol] , [symbol] y [symbol] ):
1. If (op=read) return a fresh [symbol] Aᵢ [symbol] ;
2. If (op 32 write) set Aᵢ=y.

The present disclosure uses a DORAM distributed data structure. It maintains a virtual memory that can hold up to n words stored in arbitrary locations, addressable by word-size arbitrary “address” value. DORAM allows read/write access into this virtual memory with O(log n) secure operations for each individual read/write.

### Parallel DORAM

DORAM has been extensively analyzed in a parallel setting, where multiple read and write operations can be executed with O(log n) computational overhead per operation and can be performed in parallel using O(log n) rounds. Prior work has analyzed ORAM in the client-server model, where oblivious shuffles typically require tight compaction and low-depth circuit constructions for building cuckoo hash tables. However, the most efficient known methods for tight compaction still incur large hidden constants in the asymptotic notation. Although such approaches yield O(log n) overhead in theory, the constant factors remain prohibitive in practice.

In the MPC setting, prior constructions mitigate this overhead by allowing one of the servers to construct a cuckoo hash table in the clear using tags. In this setting, tight compaction is not required, provided that the protocol supports a secure shuffle primitive. The disclosed construction adopts this approach. The present disclosure makes use of the following functionalities:
PARALLEL-DORAM.INITIALIZE(( [symbol] addr₁ [symbol] , [symbol] x₁ [symbol] ), . . . , ( [symbol] addrₙ [symbol] , [symbol] xₙ [symbol] )). Initialize takes as input a list of secret shared address-value pairs (addr₁, x₁) . . . (addrₙ, xₙ), and constructs a virtual address that holds this n values at specified addresses This takes O(n log n) secure operations and O(n log n) words of memory per server and O(n log n) rounds. Addresses a need not be consecutive and can be any arbitrary virtual address that fits into a single word.
[symbol] z₁ [symbol] . . . [symbol] z_{q} [symbol] ←PARALLEL-DORAM.DISJOINT.READ( [symbol] a₁ [symbol] , . . . , [symbol] a_{w} [symbol] ) reads value zᵢ at virtual address aᵢ for 1≥i ≥w, where w<n, and if all aᵢ are distinct, it returns in a secret-shared form values [symbol] z₁ [symbol] , . . . , [symbol] z_{q} [symbol] . If aᵢ are not all disjoint, obliviousness is not guaranteed. If some aᵢ was not previously written to, [symbol] z₁ [symbol] is defined and returned as ⊥. Reading takes O(w log n) secure operations and O(log n) rounds and can be executed repeatedly without leaking any partial information.
PARALLEL-DORAM.DISJOINT.WRITE(( [symbol] a₁ [symbol] , [symbol] y₁ [symbol] ), . . . ( [symbol] a_{w} [symbol] [symbol] y_{w} [symbol] )) writes secret shared value yᵢ to secret shared virtual address aᵢ, under the assumption that all aᵢ are distinct for all 1≤i≤w. aᵢ can be an arbitrary address (that fits into a word of memory) within the PARALLEL DORAM virtual memory. If address aᵢ already holds some value, it is overwritten by y₁. This takes O(w log n) secure operations and O(log n) rounds.

### 3 Graph Conversions for MPC

The following lemma holds without requiring any cryptographic assumptions:

Lemma 6. Let G be any graph with n vertices and m edges, and let d←2┌m/n┐. Then, there exists a d-normalized replicated adjacency list representation of G with exactly 2n replicated vertices.

Proof. A standard secret-shared adjacency list representation of G(V, E) serves as the input to the following transformation:
1. Each vertex v with degree δ(v)≤d is assigned an adjacency list padded to length d by adding dummy elements (⊥). There could be at most n such vertices. If there are fewer vertices, ⊥ vertices are added until there are exactly n adjacency lists all of length d. There are now n vertices (real and ⊥), each with an adjacency list of length d.
2. There could be at most n/2 vertices with degree δ(a) >d as the expected degree is E[(δ(n)]=m/n. Applying Markov inequality with d=2┌m/n┐ yields:

$$ℙ [ δ ( n ) \geq d ] \leq \frac{𝔼 [ δ ( n ) ]}{d} \leq \frac{1}{2}$$

For each vertex of size δ(v)>d, the adjacency list is partitioned into full blocks that are divisible by d and a “remainder” segment:
Remainder segments containing fewer than d edges are padded with I entries to form complete blocks of size d. The number of such blocks is at most n/2.
Regarding α∈ [symbol] ⁺ “chunks” of adjacency lists of length exactly d, there are at most im edges, and therefore, α≤m/d≤n/2. If a≤n/2, additional dummy blocks are appended to reach exactly n/2 such blocks, by way of condition 4 of definition 1.

This transformation results in n replicated vertices from step (1) and two groups of n/2 vertices from step (2), completing the proof.

The above proof manipulated edges but not vertices. So, a column for vertex names is added. The total size of the array will then be 2V×(d+1). Accordingly, d is redefined as d=2┌E/V┐+1 .

The input to the normalization algorithm is a secret-shared adjacency list denoted [symbol] AL [symbol] , of length q=V+E. It is assumed that vertex identifiers range from 1 to V and that the adjacency lists are ordered by vertex index.

Edge weights are disregarded during d-normalization, as they do not influence the transformation. If edges have distinct weights, each edge must contain is weight, and vertex representations are padded such that all entries remain of uniform length and structure.

The array [symbol] AL [symbol] is structured as a concatenated list of vertices and their adjacency lists. No boundary markers are included between vertices. The only public metadata known to the servers is the total number of vertices V and edges E in the graph G(V, E).

As an example, a graph G(V, E) with three nodes may be defined as follows: node 1 has directed edges to nodes 2 and 3; node 2 has an edge to node 3; and node 3 has no outgoing edges. The standard adjacency list representation of G is:
[(1, (2, 3)), (2, (3)), (3, ( )]

[symbol] AL [symbol] the adjacency list will be represented as secret-sharing of the following ordered list

$$〚 AL 〛 = ( ( 〚 1 〛 , 〚 1 〛 ) , ( 〚 0 〛 , 〚 2 〛 ) , ( 〚 0 〛 , 〚 3 〛 ) , ( 〚 1 〛 , 〚 2 〛 ) , ( 〚 0 〛 , 〚 3 〛 ) , ( 〚 1 〛 , 〚 3 〛 ) )$$

where the first coordinate of each pair is a boolean variable [symbol] bᵢ [symbol] =1 if it is a vertex, and [symbol] bᵢ [symbol] =0 if it is an edge. Formally, [symbol] AL [symbol] representation of G is a list of q ordered pairs ( [symbol] bᵢ [symbol] , [symbol] aᵢ [symbol] ) where b;

is a boolean variable and aᵢ is a vertex name ∈{1,2, . . . , V}. Additionally, all vertex names are padded to have the same length. Thus, all secret-shared pairs of the form (1, *)∈AL are vertices, while all pairs of the form (0, *)∈AL are edges.

Since servers know the total number of vertices V and the total number of edges E, servers can calculate d 32 ┌2E/V┐+1. The disclosed normalization method securely transforms the input into a d-normalized replicated adjacency list [symbol] A [symbol] , defined as a two-dimensional array of size 2V×d. Each row consists of d edges ( [symbol] cᵢ [symbol] _{,} [symbol] ₐᵢ [symbol] ) where cᵢ, aᵢ∈55 {1, . . . , 2V}∪{⊥}} For valid (non-⊥) entries, each (cᵢ, aᵢ) must correspond to an edge in E. Within a row, all cᵢ values must be equal. Additionally, rows sharing the same cᵢ value must appear contiguously in [symbol] A [symbol] .

The disclosed algorithm performs this normalization obliviously using [symbol] AL [symbol] as input.

### 3.1 Secure d-Normalization Algorithm

The present disclosure assumes that the graph G(V, E) includes vertex labels that are integers ranging from 1 to V, and that the adjacency list has these vertices in sorted, increasing order. The present disclosure provides a procedure to convert a graph where vertex names are arbitrary alphanumeric strings into the assumed sorted form in Section 3.3. The disclosed d-normalization algorithm in a series of steps, each of which can be computed either silently or in a constant number of communication rounds.

The input is an ordered secret-shared list [symbol] AL [symbol] consisting of q=V+E ordered tuples (bᵢ, aᵢ). The output is a two-dimensional array [symbol] A[i, j] [symbol] where 1≤i≤2V and 0≤j≤d. Each row of [symbol] A [symbol] consists of a vertex name [symbol] cᵢ [symbol] followed by d entries ( [symbol] cᵢ [symbol] , [symbol] aᵢ [symbol] ). cᵢ∈{{1, . . . , 2V}∪{⊥}} the identifier of the source vertex for the corresponding edge, and aᵢ∈{{1, . . . , 2V}∪{⊥}} represents the destination vertex. Within any given row, all [symbol] cᵢ [symbol] values are identical. Rows begin with index 1, while columns begin with index 0. This is because column 0 of [symbol] A [symbol] stores the vertex identifier (either vertex label or ⊥). Each data element, referred to as a tuple for descriptive purposes, is extended to include the following seven secret-shared entries, where [symbol] (bᵢ, aᵢ) [symbol] is in the tuple in [symbol] AL [symbol] :

$$( {b}_{i} , {a}_{i} , {c}_{i} , {r}_{i} , {addr}_{i} , {fe}_{i} , {le}_{i} )$$

with the following definitions:
Position 1: bᵢ∈{0, 1} where bᵢ is a boolean variable indicating if this tuple is a representation of a vertex, in which case bᵢ=1, or an edge, in which case bᵢ=0
Position 2: aᵢ∈{1, . . . , V} where aᵢ's is a vertex name which is an integer from 1 to V. To re-iterate, in this algorithm, it is assumed that in [symbol] AL [symbol] , for all tuples where bᵢ=1, aᵢ appears in strict increasing order from 1 to V.
Position 3: cᵢ∈{1, . . . , V} where cᵢ is the name of the vertex to which the i'th edge belongs to. For each vertex, cᵢ=aᵢ.
Position 4: rᵢ∈{1, . . . , 2V} where rᵢ is a row in [symbol] A [symbol] where tuple i will be written to. Jumping ahead, the present disclosure will divide [symbol] AL [symbol] into [q/d] equal-length blocks, padding the last block with⊥'s if needed. Each distinct adjacency list of [symbol] AL [symbol] within each block gets its own row, which is then padded as necessary with⊥'s to be of length exactly d.
Position 5: addrᵢ∈{1, . . . , d}. In each block, tuples are numbered 1 to d. Tuple i gets addrᵢ.
Position 6: feᵢ∈{0, 1} where feᵢ is a boolean variable indicating whether this tuple is the first edge of a distinct adjacency list in that block.
Position 7: leᵢ∈{0, 1} where leᵢ is a boolean variable indicating whether this tuple is the last edge of a distinct adjacency list of that block.

These fields are conceptually introduced throughout the algorithm description for clarity. However, in implementation, all fields are allocated simultaneously. Additionally auxiliary arrays such as Continuation and PRELIM-1 and PRELIM-2 are defined to support intermediate computations during row assignment.

The disclosed algorithm does not include additional variables that each tuple could have, such as weights of the edges, for clarity. If edge weights are included, each tuple will have an entry for an edge weight. For indistinguishability of tuples, all tuples should be extended to contain fields for weights, including placeholder values such as ⊥ for non-applicable cases.

The normalization parameter d is defined as 2┌E/V┐+1. Therefore, writing d+1 indicates adding 2 to the average degree.

The following section describes the steps of the d-normalization algorithm in detail:

Input: [symbol] AL [symbol] =[( [symbol] a₁ [symbol] , [symbol] b₁ [symbol] ), . . . , ( [symbol] a_{q} [symbol] , [symbol] b_{q} [symbol] )] where all vertices are named from 1 to V and vertex names appear in sorted order from smallest to largest.
Output: [symbol] A [symbol] , a two dimensional array of size 2V×(d+1). Each row consists of a vertex name [symbol] cᵢ [symbol] followed by d edges ( [symbol] cᵢ [symbol] , [symbol] aᵢ [symbol] ). cᵢ∈{{1, . . . , 2V}∪{⊥}}, aᵢ∈{{1, . . . , 2V}∪{⊥}} where each row of [symbol] A [symbol] has the same ci across all its pairs. Furthermore, if some cᵢ appears in more than one row, all of these rows are adjacent to one-another. Additionally, the output includes a secret-shared bit-vector of size 2V called [symbol] Continuation [symbol] . Each position i∈{1, . . . , 2V} of [symbol] Continuation [symbol] corresponds to row rᵢ in [symbol] A [symbol] , such that if cᵢ in row rᵢ and c₍ᵢ₊₁₎ in row rᵢ₊₁ are equal, then [symbol] Continuation [i [symbol] = [symbol] 1 [symbol] . Otherwise, [symbol] Continuation [i] [symbol] = [symbol] 0 [symbol] .

### d-Normalization Algorithm

1. Block partition: Partition [symbol] AL [symbol] into consecutive blocks of d tuples each. Let γ=[q/d] blocks, so γ is the number of blocks. Pad the last block with ( [symbol] 0 [symbol] , [symbol] ⊥ [symbol] )'s as needed so that each block is of the same length and consists of tuples of the same length. In order not to complicate the notation, re-define q←[q/d]·d.

2. Adding variable cᵢ: Let [symbol] c [symbol] , . . . , [symbol] c_{q} [symbol] ←SILENT PREFIXSUM( [symbol] b [symbol] , . . . , [symbol] b [symbol] ]). Consider any edge entry (bᵢ=0, aᵢ, cᵢ). Note cᵢ is the name of the vertex to whose adjacency list this edge belongs. To each tuple in [symbol] AL [symbol] add a third element cᵢ, so each tuple in [symbol] AL [symbol] consists of:

$$( {b}_{i} , {a}_{i} , {c}_{i} )$$

3. Block variable: For each block j, 1≤j≤γ define a boolean variable [symbol] contⱼ [symbol] to be equal to 1 if the first entry of block j is an edge. Otherwise [symbol] contⱼ [symbol] is 0. That is, look at bᵢ in the first tuple of each block. Note that cont₁=0 always.
4. Computing Rows: Define secret-shared array [symbol] PRELIM-1 [symbol] of length q+γ, where contᵢ is inserted in front of each block i:
   4.1 [symbol] PRELIM-1 [symbol] = [symbol] 0, b₁, b₂, . . . , b_{d}, cont₂, b_{(d+1)}, . . . , b_{2d}, cont₃, b_{2d+1} . . . [symbol]
   4.2 [symbol] PRELIM-2 [symbol] {SILENT PREFIXSUM( [symbol] PRELIM-1 [symbol] )
   4.3 Compute a secret-shared vector

$$ROW = {r}_{1} , … , {r}_{q}$$

of length q by deleting γ positions in the PRELIM-2 vector that corresponded to the positions of conti variables that were inserted into [PRELIM-1]. Extend each tuple in [symbol] AL [symbol] to be of the form:

$$( {b}_{i} , {a}_{i} , {c}_{i} , {r}_{i} )$$

where tuple number i gets the i'th element of [ROW].
5. Computing Columns: Within each block there are exactly d consecutive tuples. Number them (silently) from 1 to d and add this count to each tuple. [symbol] AL [symbol] now becomes:

$$( {b}_{i} , {a}_{i} , {c}_{i} , {r}_{i} , {addr}_{i} )$$

6. “First edge” (fe): Define a boolean variable [symbol] feᵢ [symbol] for each tuple.

$$6.1 For all i ∈ \{ 2 , … , q - 1 \} in parallel do :$$

$${fe}_{i} ← ( ( {b}_{i} = 0 ) ∧ ( ( {addr}_{i} = 1 ) ∨ ( {b}_{( i - 1 )} = 1 ) ) ) ∨ ( ( {b}_{i} = 1 ) ∧ ( ( {b}_{i + 1} = 1 ) ∨ ( {addr}_{i} = d ) ) )$$

$$6.2 {fe}_{1} ← ( {b}_{2} = 1 )$$

$$6.3 {fe}_{q} ← ( {b}_{q} = 1 ) ∨ ( {b}_{q} = 0 ) ∧ ( {b}_{q - 1} = 1 ) )$$

A “first edge” is either the first element in the block or proceeds a vertex. Additionally, vertices with no outgoing edges or vertices at the end of a block are counted as a first edge. The tuple now becomes:

$$( {b}_{i} , {a}_{i} , {c}_{i} , {r}_{i} , {addr}_{i} , {fe}_{i} )$$

7. “Last edge” (le): Define a boolean variable [symbol] leᵢ [symbol] for each tuple.
   7.1 For all i∈{2, . . . , q-1} in parallel do: [symbol] leᵢ [symbol] ←(( [symbol] bᵢ [symbol] =0)∧( [symbol] addrᵢ [symbol] =d)∨( [symbol] b₍₊₁₎ [symbol] =1)∨( [symbol] bᵢ [symbol] =1)∧( [symbol] b₍₊₁₎ [symbol] =1)∨( [symbol] addrᵢ [symbol] =d)))
   7.2 [symbol] leᵢ [symbol] ←( [symbol] b₂ [symbol] =1)
   7.3 [symbol] leᵢ [symbol] ←1

A “last edge” is either the last in the block or precedes a vertex. Additionally, vertices with no outgoing edges are last edges. The tuple now becomes:

$$( {b}_{i} , {a}_{i} , {c}_{i} , {r}_{i} , {addr}_{i} , {fe}_{i} , {le}_{i} )$$

8. Create fake fe and le:

$$8.1 Create arrays 〚 F 1 〛 and 〚 F 2 〛 , each of size 2 V tuples ⊳ each tuple has 7 entries \\ 8.2 For all t ∈ \{ 1 , … , 2 V \} in parallel do : \\ If t \leq 〚 {r}_{q} 〛 : put 〚 ( ⊥ , ⊥ , ⊥ , ⊥ , ⊥ , 0 , 0 ) 〛 into 〚 F 1 〛 at position t . ⊳ to be ignored in 9.4 \\ Else : ( t > 〚 {r}_{q} 〛 ) put 〚 ( ⊥ , ⊥ , ⊥ , t , 1 , 1 , 0 ) 〛 into 〚 F 1 〛 at position t ⊳ \vert {fe}_{i} = 1 \vert = 2 V \\ 8.3 For all t ∈ \{ 1 , … 2 V \} in parallel do : \\ If t \leq 〚 {r}_{q} 〛 : write 〚 ( ⊥ , ⊥ , ⊥ , ⊥ , ⊥ , 0 , 0 ) 〛 into 〚 F 2 〛 at position t . ⊳ to be ignored in 10.4 \\ Else : ( t > 〚 {r}_{q} 〛 ) Write 〚 ( ⊥ , ⊥ , ⊥ , t , 2 , 0 , 1 ) 〛 into 〚 F 2 〛 at position t . ⊳ Creating fake rows$$

9. Total-First:

$$9.1 π ← SAMPLE - FRESH - PERMUTATION ⊳ π ∈ {S}_{q + 2 V}$$

$$9.2 F 3 ← SECURE - SHUFFLE ( AL ⋃ F 1 ) , π )$$

$$9.3 L 6 ← the 6 th component of each typle in F 3 ⊳ extracting {fe}_{i} boolean array$$

$$9.4 〚 F 4 \text{} 〛 ← OBLIVIOUS 2 V - COMPACT ( 2 V , 〚 L 6 〛 , 〚 F 3 〛 ) ⊳ F 4 is of size 2 V$$

$$9.5 F \text{-first} [ x , y ] is a 2 V \times d \text{array. Initalize it as follows} :$$

$$9.5 \text{.1} For 1 \leq x \leq 2 V :$$

$$9.5 \text{.2} Let 〚 ( {b}_{i} , {a}_{i} , {c}_{i} , {r}_{i} , {addr}_{i} , {fe}_{i} , {le}_{i} ) 〛 ← F 4 [ x ]$$

$$9.5 \text{.3} For 1 \leq y \leq d : ⊳ Fill row with {⊥}^{′} s prior to first edge appearance$$

$$F \text{-first} [ x , y ] ← \{ \begin{matrix}If y < {addr}_{i} & then create tuple 〚 ( ⊥ , ⊥ , {c}_{i} , {r}_{i} , y , ⊥ , ⊥ ) 〛 \\ Else y \geq {addr}_{i} & then create tuple 〚 ( ⊥ , ⊥ , ⊥ , ⊥ , ⊥ , ⊥ , ⊥ ) 〛\end{matrix}$$

10. Total-Last:

$$10.1 〚 π 〛 ← SAMPLE - FRESH - PERMUTATION ⊳ πϵ {S}_{q + 2 V}$$

$$10.2 〚 F 5 〛 ← SECURE - SHUFFLE ( 〚 AL 〛 ⋃ 〚 F 2 〛 ) , 〚 π 〛 )$$

$$10.3 〚 L 7 〛 ← the 7 th component of each tuple in 〚 F 5 〛 ⊳ extracting {le}_{i} boolean array$$

$$10.4 〚 F 6 \text{} 〛 ← OBLIVIOUS 2 V - COMPACT ( 2 V , 〚 L 7 〛 , 〚 F 5 〛 ) ⊳ F 6 is of size 2 V$$

$$10.5 F - last [ x , y ] is a 2 V \times d array . Initialize it as follows :$$

$$10.5 \text{.1} For 1 \leq x \leq 2 V in parallel do :$$

$$10.5 \text{.2} Let 〚 ( {b}_{i} , {a}_{i} , {c}_{i} , {r}_{i} , {addr}_{i} , {fe}_{i} , {le}_{i} ) 〛 ← F 6 [ x ]$$

$$10.5 \text{.3} For 1 \leq y \leq d \text{in parallet do:} ⊳ Fill row with {⊥}^{′} s after the last edge appearance$$

$$F \text{-last} [ x , y ] ← \{ \begin{matrix}If y < {addr}_{i} & then create tuple 〚 ( ⊥ , ⊥ , {c}_{i} , {r}_{i} , y , ⊥ , ⊥ ) 〛 \\ Else y \geq {addr}_{i} & then create tuple 〚 ( ⊥ , ⊥ , ⊥ , ⊥ , ⊥ , ⊥ , ⊥ ) 〛\end{matrix}$$

11. Preparing [symbol] A [symbol] :

$$11.1 〚 π 〛 ← SAMPLE - FRESH - PERMUTATION ⊳ πϵ {S}_{q + 4 V \cdot ( d + 1 )}$$

$$11.2 〚 A 1 〛 ← SECURE - SHUFFLE ( 〚 AL 〛 ⋃ 〚 F \text{-first} 〛 ⋃ 〚 F \text{-last} 〛 ⋃ 〚 F 1 〛 ⋃ 〚 F 2 〛 ) , 〚 \text{} π 〛 ) ⊳ \text{Treat arrays as} 1 \text{-dimensional}$$

$$11.3 〚 A 2 〛 \text{is a boolean vector of length} q + 4 V ( d + 1 ) where ,$$

$$\text{For each tuple} 1 \leq i \leq ( q + 4 V ( d + 1 ) ) \text{in parallel do:}$$

$$〚 ( {b}_{i} , {a}_{i} , {c}_{i} , {r}_{i} , {addr}_{i} , {fe}_{i} , {le}_{i} ) 〛 ← A 1 [ i ]$$

$$A 2 [ i ] ← \{ \begin{matrix}〚 0 〛 & If {r}_{i} = ⊥ ⋁ ( {b}_{i} = 1 ⋀ {fe}_{i} = 1 ⋀ {le}_{i} \neq 1 ) \\ 〚 1 〛 & Otherwise\end{matrix}$$

Note that the number of 1's in [symbol] A2 [symbol] is exactly 2V·d.
11.4 [symbol] A3 [symbol] κOBLIVIOUS(2V·d)-COMPACT(2V·d, [symbol] A2 [symbol] , [symbol] A1 [symbol] )
11.5 For 1≤i≤2Vd in parallel do:

$$( 〚 {b}_{i} 〛 , 〚 {a}_{i} 〛 , 〚 {c}_{i} 〛 , 〚 {r}_{i} 〛 , 〚 {addr}_{i} 〛 , 〚 {fe}_{i} 〛 , 〚 {le}_{i} 〛 ) 〛 ← A 3 [ i ]$$

Open the fourth and the fifth value of each tuple (i.e. (rᵢ, addrᵢ)), and put into (rᵢ, addrᵢ) address of A the following secret-shared values:

$$A [ {r}_{i} , {addr}_{i} ] ← ( 〚 {c}_{i} 〛 , 〚 {a}_{i} 〛 )$$

Note that if there are edge weights they would also be secret shared as part of the tuple.
12. Binary Continuation Marker: Initialize a secret-shared bit vector of size 2V called [symbol] Continuation [symbol] . Each position i∈{1, . . . , 2V} of [symbol] Continuation [symbol] will correspond to row rᵢ in [symbol] A [symbol] .

$$12.1 For 1 \leq i \leq 2 V - 1 in parallel do :$$

$$12.2 ( 〚 {c}_{i} 〛 , 〚 ( {a}_{i} 〛 ) ← A [ i , d ]$$

$$12.3 ( 〚 {c}_{i + 1} 〛 , 〚 ( {a}_{i + 1} 〛 ) ← A [ i + 1 , 1 ]$$

$$12.4 Continuation [ i ] ← \{ \begin{matrix}〚 1 〛 , & if ( 〚 {c}_{i} 〛 = 〚 {c}_{i + 1} 〛 \neq 〚 ⊥ 〛 \\ 〚 0 〛 , & if ( 〚 {c}_{i} 〛 \neq 〚 {c}_{i + 1} 〛\end{matrix}$$

$$12.5 Continuation [ 2 V ] ← 〚 0 〛$$

Looking ahead, these binary continuation markers will be used in the present disclosure in the implementation of Dijkstra's algorithm to see if the adjacency list in row rᵢ continues in row rᵢ₊₁.
13. Adding Headers
   13.1 For all i∈{1, . . . ,2V} do:
   13.1.1 Let ( [symbol] cᵢ [symbol] , [symbol] aᵢ [symbol] )←A [i, 1]
   13.1.2 A[i, 0]← [symbol] cᵢ

[symbol]

### 3.2 Analysis of d-Normalization Algorithm

The d-normalization algorithm securely maps entries from a secret-shared adjacency list [symbol] AL [symbol] into a new secret-shared array [symbol] A [symbol] structured as 2V rows and d columns. Each row's first column contains a vertex identifier v_{i∈{}1 . . . [}, while the remaining d columns contain either corresponding edges or placeholder symbols denoted ⊥. These placeholders are not necessarily contiguous; their arrangement may include interleaved and valid edges. The disclosed method computes, for each item in [symbol] AL [symbol] , the target location within [symbol] A [symbol] . Since |A|>|AL|, an additional mechanism is required to populate unfilled location in [symbol] A [symbol] with placeholders (⊥symbols) with unique addresses for each empty location, ensuring each location contains exactly one item. Once unique ⊥s are generated for each empty location, the genuine and placeholder items are aggregated and shuffled using a secure shuffle protocol. After shuffling, their destination addresses are revealed, and all items are placed into their designated locations in the clear.

The following section analyzes each step of the algorithm in detail.

In Step 1, the secret-shared list [symbol] AL [symbol] is partitioned into blocks of length d, padding the last block with ⊥'s in case q is not divisible by d. This is done silently. The algorithm redefines q=┌q/d┐·d.

Step 2, associates each edge with its corresponding vertex. This takes O(q) work and is done silently, i.e., it does not require any communication.

Steps 3 and 4, mark the blocks where edges continue from the previous block. This takes O(1) rounds, and the work is proportional to the number of blocks. Presently each tuple has an indicator random variable rᵢ for all entries of [symbol] AL [symbol] , which indicates which row of A each item should go into.

In Step 5, tuples within each block are assigned sequential indices from 1 to d, without interaction. This can be accomplished since [symbol] AL [symbol] has blocks of size d, and this is exactly the number of columns in [symbol] A [symbol] . This supports column-level placement within each row of [symbol] A [symbol] such that edge entries retain their relative positions. Specifically, if there is a vertex in the middle of the block with edges a, b, c in positions 12, 13, 14 of that block, they will go into the same row of A in columns 12, 13, 14 with columns 1 through 11 of that row filled with L and columns 15 to d of that column also filled with ⊥. Placeholder generation is formally handled in Steps 9 and 10 via address assignment, shuffling, then revealing addresses. Step 5 takes O(1) rounds and O(q) work, since it can be done in parallel for all entries in all tuples.

Steps 6 and 7 mark in [symbol] AL [symbol] all the first and the last edges of each adjacency list, broken up into blocks, so for each adjacency list in each block, there is the first and last edge. As stated above, when [symbol] AL [symbol] is divided into blocks, some adjacency list may start in the middle of a block. The edges of this adjacency list will go into some rows in exactly the same positions as they appear in this block. Therefore, row is padded before and after this adjacency list with Ls. To pad the row, the first and the last entry of this adjacency list must be marked. This is exactly what Steps 6 and 7 do. Because all triples of adjacent tuples can be looked at in parallel, each triple can be decided in O(1) rounds and constant work. This means that the total rounds are constant and the work is linear in q.

Array A is defined to have d columns and 2V rows. The number of rows that remain unused after populating entries from [symbol] rAL [symbol] is computed using the last element of a vector [symbol] ROW [symbol] , denoted [symbol] r_{q} [symbol] , previously generated in Step 4.3. The number of unused rows is [symbol] Fake [symbol] =2V− [symbol] r [symbol] . Step 8 uses [symbol] rFake [symbol] to obliviously create additional [symbol] Fake [symbol] -many first edges and [symbol] Fake [symbol] -many last edges to pad the number of both fe and le to 2V. These are added to arrays F1 and F2, from which the present disclosure later (steps 9.4 and 10.4) extracts exactly 2V of the non-ignore first edges. Step 8.4 assigns each fake first and last edge to an empty row into positions 1 and 2, respectively. This is so that the subroutine that computes bots following the last edge will add bots to fill these empty rows. This is done in parallel for all created tuples, meaning this takes O(1) rounds and O(E) work.

Steps 9 and 10 create secret shared arrays F-first and F-last, each of size 2Vd, which are filled with ⊥s, some with valid addresses and some with L as their address. Later, these ‘ignore’ elements with no valid address will be ignored in step 11.3. All of these steps together take O(1) rounds and O(q) work.

Step 11, first shuffles and then open all the addresses. All entries for each location of A are brought to their designated position in the clear. This takes O(q) work and O(1) rounds, as sorting by revealed addresses can be done without interaction.

In step 12 creates the Binary Continuation Marker, a boolean variable for each row that tells whether the same vertex adjacency list continues to the next row. This is done in parallel for all rows and takes O(V) work and O(1) rounds.

All above step have not placed any elements in column 0. In step 13, vertex labels are written to this column by copying cᵢ from column 1 in the same row. All rows are done in parallel. Thus, Step 13 takes linear O(V) work and O(1) rounds.

In total, the d-normalization algorithm takes O(1) rounds and O(V+E) work. The d-normalization algorithm has omitted edge weights in order not to complicate the presentation any further. Edge weights should be included as part of each tuple as another secret-shared entry, with a secretsharing of⊥'s for vertices. No modifications are made to this data.

### 3.3 Oblivious Graph Renaming Algorithm

Given a secret-shared adjacency list [symbol] AL [symbol] with arbitrary alphanumeric names of vertices of equal length, the present system shows how to obliviously convert all vertex labels to integers from 1 to V that appear in sorted order.

For any graph G(V, E), servers are given secret-shared adjacency list [symbol] AL [symbol] of length q =V+E. [symbol] AL [symbol] consists of q tuples ( [symbol] bᵢ [symbol] , [symbol] aᵢ [symbol] ). Here, bᵢ is a boolean variable that indicates if a tuple is a vertex or an edge, where [symbol] bᵢ=1 [symbol] denotes the vertex and [symbol] bᵢ=0 [symbol] is an edge; and aᵢ is the alphanumeric vertex label.

For example, consider a graph where vertex Bob points to vertices Alice and Eve, Eve points to Alice, and Bob points to nobody. The standard adjacency list representation would be:
[(Bob, (Alice, Eve), (Eve, (Alice)), (Bob, ( )].
   The [symbol] AL [symbol] would be 6 tuples:

$$[ ( 〚 1 〛 , 〚 Bob 〛 ) , ( 〚 0 〛 , 〚 Alice 〛 ) , ( 〚 0 〛 , 〚 Eve 〛 ) , ( 〚 1 〛 , 〚 Eve 〛 ) , ( 〚 0 〛 , 〚 Alice 〛 ) , ( 〚 1 〛 , 〚 Bob 〛 ) ] .$$

where each tuple is exactly of the same length, and alphanumeric names are padded to be exactly word-size.

Each tuple is extended to include the following five entries:

$$A = ( {b}_{i} , {a}_{i} , {c}_{i} , {addr}_{i} , {z}_{i} )$$

Position 1: bᵢ∈{0, 1} where bᵢ is a boolean variable indicating if this tuple is a representation of a vertex, in which case bᵢ=1, or an edge, in which case bᵢ=0.
Position 2: aᵢ, an alphanumeric name that fits into the word size. All names should have the same length, padded as needed.
Position 3: cᵢ∈{1, . . . , V} where, if bᵢ=1 then cᵢ is the integer renaming of this vertex, and if bᵢ =0 then cᵢ is the integer vertex name to which this edge belongs to.
Position 4: addrᵢ{1, . . . , q} where addr; is the index of the ith tuple in [symbol] AL [symbol] in its original order. After oblivious shuffling, this address will later be revealed to sort the adjacency list into its original order.
Position 5: zᵢ∈{1, . . . , V} where for bᵢ=1, zᵢ=cᵢ and for bᵢ=0, zᵢ represents the vertex to which the edge points to. In other words, for all tuples zᵢ is the new integer vertex name which faithfully keeps the graph topology.

The graph renaming algorithm has the following I/O specification:

Input: [symbol] AL [symbol] =( [symbol] b₁ [symbol] , [symbol] aᵢ [symbol] ), . . . , ( [symbol] 1₁ [symbol] , [symbol] a₁ [symbol] )
Output: [A]=(( [symbol] bᵢ [symbol] , [symbol] aᵢ [symbol] , [symbol] zᵢ [symbol] ). Here, each zᵢ is the new integer vertex name∈{1, . . . , V}, and aᵢ is the alphanumeric name that is kept. The oblivious graph renaming algorithm guarantees that all vertices appear in the strict increasing order from 1 to V.

### Oblivious Graph Renaming Algorithm

1. Numbering Vertices and Edge Attribution:

$$[ 〚 {c}_{1} 〛 , … , 〚 {c}_{1} 〛 ] ← SILENT PREFIXSUM ( [ 〚 {b}_{1} 〛 , … , 〚 {b}_{q} 〛 ] )$$

Modify [AL] to add cᵢ to each corresponding tuple. [symbol] AL [symbol] now consists of q tuples of the form (bᵢ, aᵢ, cᵢ). If bᵢ=1, the tuple (bᵢ, aᵢ, cᵢ) is a vertex. Observe that SILENT PREFIXSUM computes cᵢ in the tuple (1, aᵢ, cᵢto be vertex numbering of corresponding vertices in [symbol] AL [symbol] in increasing order from 1 to V. If bᵢ=0, this is a tuple corresponding to an edge, where cᵢ∈{1, . . . , V}. Observe that cᵢ of this edge indicates which vertex cᵢ in the vertex numbering this edge belongs to.
2. Adding address i to each tuple: Since [symbol] AL [symbol] is an ordered list of q tuples, assign to each tuple its position in the list, from 1 to q, in increasing order. Denote this position addrᵢ of the tuple number 1≤i≤q, so tuple number i becomes ( [symbol] bᵢ [symbol] , [symbol] aᵢ [symbol] , [symbol] cᵢ [symbol] , [symbol] addrᵢ [symbol] )
3. Oblivious Sort The algorithm now invokes Oblivious Sort (see section 2.2): [symbol] AL [symbol] ←OBLIVIOUS SORT [symbol] AL [symbol] with the following comparison predicate:

$$IS - LESS - THEN ( ( {b}_{i} , {a}_{i ,} {c}_{i} , {addr}_{i} ) ( {b}_{j} , {a}_{j} , {c}_{j} , {addr}_{j} ) ) == \{ \begin{matrix}1 , & if ( {a}_{i} ≺ {a}_{j} ) ∨ ( ( {a}_{i} = {a}_{j} ) ∧ ( {b}_{i} < {b}_{j} ) ) \\ 0 , & otherwise .\end{matrix}$$

where aᵢ<aⱼ is TRUE if string aᵢ is alphabetically smaller then string aⱼ.
4. Renaming Edges

The algorithm adds variable zᵢ to each tuple (bᵢ, aᵢ, cᵢ, addrᵢ)∈ A. zᵢ is defined:

$${z}_{i} = \{ \begin{matrix}{c}_{i} , & if ( {b}_{i} = 1 ) \\ {c}_{j} & if ( {b}_{i} = 1 ) ∧ ∃ j s . t . ( {a}_{i} = {a}_{j} ) ∧ ( {b}_{j} = 1 )\end{matrix}$$

Observe that A is sorted by ai, where the vertices are ai where b =1. Further, observe that A has q tuples, out of each E are edges (i.e. bᵢ=0) and V are vertices (i.e. bᵢ =1). Define procedure:

EXTEND(i, j) where 1≤i<j≤q:

$$∀ k ∈ \{ i , ... , j \} if ( {a}_{i} = {a}_{j} ) ∧ ( {z}_{i} \neq ⊥ ) then {z}_{k} ← {z}_{i} else {z}_{k} ← {z}_{k}$$

All (i, j) pairs are public and are fixed in advance. In corner cases, if EXTEND(i, j) is called with i<q but j>q, the call automatically becomes EXTEND(i, q). Define procedure:

PARALLEL NAME EXTENSION Subroutine:

```
4.1 For all 1 ≤ i ≤ q in parallel do: if bᵢ = 1 then zᵢ ← cᵢ else zᵢ ← ⊥
4.2 For s from 1 to ┌log q┐ do:
      4.2.1 For all $1 \leq h \leq ⌈ \frac{q}{{2}^{s}} ⌉ in parallel do :$
        4.2.2 EXTEND (i, j) for i = 2^{s} (h − 1) + 1, j = 2^{s}h
        4.2.3 EXTEND (i, j) for i = 2^{s} (h − 1) + 2^{s-1} + 1, j = 2^{s}h + 2^{s-1}
4.3 For s from ┌log q┐ down to 1 do:
      4.3.1. For all $1 \leq h \leq ⌈ \frac{q}{{2}^{s}} ⌉ in parallel do :$
        4.3.2 EXTEND (i, j) for i = 2^{s} (h − 1) + 1, j = 2^{s}h
        4.3.3 EXTEND (i, j) for i = 2^{s} (h − 1) + 2^{s-1} + 1, j = 2^{s}h +2^{s-1}
4.4  $4.4 For all 1 \leq h \leq ⌈ \frac{q}{2} ⌉ in parallel do :$
      4.4.1 EXTEND (2(h − 1) + 1, 2h)
      4.4.2 EXTEND (2(h − 1) + 2, 2h + 1)
```

5. Secure Shuffle [symbol] A [symbol] consists of q tuples of the form ( [symbol] bᵢ [symbol] , [symbol] aᵢ [symbol] , [symbol] cᵢ [symbol] , [symbol] addrᵢ [symbol] , [symbol] zᵢ [symbol] ) where ∀i, zᵢ≠⊥. Shuffle [symbol] A [symbol] :

$$1. 〚 π 〛 ← SAMPLE - FRESH - PERMUTATION ⊳ π ∈ {S}_{q} \\ 2. 〚 B 〛 ← SECURE - SHUFFLE ( 〚 A 〛 , 〚 π 〛 )$$

6. Final Cleanup
   1. ∀i, 1≤i≤q, open addrᵢ∈( [symbol] bᵢ [symbol] , [symbol] aᵢ [symbol] , [symbol] cᵢ [symbol] , [symbol] zᵢ [symbol] [symbol] addrᵢ [symbol] )
   2. [symbol] C [symbol] ←sort in the clear all q tuples of [symbol] B [symbol] by (opened) addrᵢ.

### 3.4 Analysis of Graph Renaming Algorithm

Steps 1 and 2 can be done silently or in parallel for each tuple, taking O(1) rounds and O(q) work. Step 3 sorts all tuples in [symbol] AL [symbol] by alphanumeric names with priority to vertices. The result of this step is all tuples with the same alphanumeric name will be adjacent to each other, and the vertex with this name will precede the edges with this name. This takes O(log V) rounds to sort and O(q log V) work.

After Step 4 is complete, all tuples in [symbol] A [symbol] satisfy zᵢ≠⊥. To prove this, the following abstraction is considered: an oriented line graph with q nodes, going left to right, an oriented line graph with q nodes arranged from left to right, indexed from 1 to q such that node 1 is the leftmost node. Exactly n of the nodes are colored with distinct colors, n<q, where the leftmost node is always colored and q−n are initially uncolored. There is no other restriction where colored nodes appear on the line. In addition, every node on the line has an alphanumeric name, not necessarily distinct, but where all colored nodes do have distinct names. The uncolored nodes have the same name as their closest node on the left which is colored. A local coloring rule is: if the node has some color c and its immediate right-hand neighbor is uncolored, color it with the same c. The objective is to propagate colors across the line in an oblivious and parallelizable manner.

A naive algorithm would be to do a linear scan on the line going left to right and coloring all the nodes as you go. The present disclosure makes following observation: consider any interval on the line from i to j. If a node in the position i is already colored, and node j has the same alphanumeric name as node i, it is safe to immediately color the entire interval from i to j with the color of node i. This process is denoted as extend (i, j). Multiple non-overlapping intervals may run extend at the same time. For efficient oblivious computation, the algorithm applies extend on intervals of geometrically increasing length, where for each interval length, extend is applied twice: for all consecutive intervals of that length, and all consecutive intervals shifted to the right by half its length (the present disclosure denotes this as a “brick” pattern). The algorithm applies extend in a smaller interval at the end of the line if the full interval does not fit.

Define a “gap” as the largest interval that can be colored at once, before any extend calls−the interval from i to j, where position i is a colored node and position j+1 is the next colored node to the right of it. The gap does not change after its nodes begin getting colored. The objective is to prove that every gap is colored in step 4. For any one gap, define step s as having “failed” for this gap if the number of nodes colored in this gap after step s−1 and after step s is the same number.

Lemma 7. Consider any gap of length h in the interval from i to j. Initially, only node i is colored. After step 4.2, nodes from i to

$$i + ⌈ \frac{h}{2} ⌉$$

are colored.

Proof. Observe that after s=1 is executed in step 4.2, i+1 is colored. After s=2 is executed for step 4.2, observe that either interval (i, i+4) or (i, i+5) is colored, depending on whether i was odd or even. Assume s non-failing steps. Note that intervals of steps i+1 start at every index 1 mod 2^{s}.If step s+1 fails, both the interval starting at i and i+2^{s}have failed. That means that the distance between i+2^{s+1} and j is strictly less than 2^{s}. This means that after step s, more than half of the nodes in the gap are colored.

Lemma 8. Consider any gap of length h in the interval from i to j. After step 4.4, all nodes of the gap are colored.

Proof. Lemma 7 showed that after step 4.2, nodes i to

$$i + ⌈ \frac{h}{2} ⌉$$

are colored. If in step 4.2 s=k: failed, then the number of uncolored nodes in this gap is less than 24. Any number can be summed with powers of 2 by writing this number in a binary representation. As extend is applied in geometrically decreasing intervals from s=┌log q┐ to s=1 , any interval that does not fail will cut the remaining uncolored nodes down by half. After completing s=1 , there are either 0 or 1 remaining uncolored nodes. Repeating s=1 again at the end, all nodes are colored.

Since the growth factor on intervals is powers of 2, step 4 takes a total of O(q log V) work and O(log V) rounds. Step 5 shuffles [A]. Step 6 reveals the addresses and move all elements to the addresses (row, column) that they previously secret-shared, completing the oblivious conversion to an adjacency list with vertex names. This conversion took, in total, O((V+E)log V) work and O(log V) rounds.

### 4 An Optimization

In the disclosed d-normalization algorithm, it is assumed that vertices have integer labels {1, . . . , V} and are in increasing sorted order. Section 3 shows how to obliviously rename a graph with arbitrary alphanumeric vertex names into such a numeric graph naming.

This section introduces a “weak” d-normalized adjacency list. Towards this end, a row is defined as a sequence of d+1 entries consisting of vertex labels or ⊥'s. The first entry of each row is called a “header”. If a row has header u, the entire d+1 sequence is referred to as “u's” row. If a row starts with L, it is referred to as a “headless” row. In contrast a row that does not start with L is termed a “non-headless” row.

Definition 3 (Weak d-Normalized Replicated Adjacency List). For any graph G where vertices have alphanumeric names that fit within O(1) words, a WEAK d-NORMALIZED REPLICATED ADJACENCY LIST is defined as an ordered adjacency list representation of G where each vertex u E G appears only once as a header, and for all edges (u, vᵢ), vᵢ appears either in a row where u is a header, or immediately following u's row with headless rows.

The main idea of the weak d-normalized adjacency list is very similar to the standard (not weak) variant: given an adjacency list with arbitrary degrees, output a constant times larger adjacency list where all degrees are normalized to exactly d. The key difference is that all “spill-over” edgesi.e., all but d edges of some vertex with degree greater than d-are not marked with their vertex name in subsequent rows.

For any graph G(V, E), a weak d-normalized adjacency has exactly V non-headless rows. Spill over edges (u, vᵢ) E G are placed in headless rows immediately following u's row. As the rows are ordered, the weak d-normalization algorithm appends an integer i∈{1, . . . 2V} to the header of each row. So, each header becomes an alphanumeric name or ⊥ followed by an integer. Thus, if some vertex named α has more than d edges, given header ( [symbol] a [symbol] , [symbol] j [symbol] ), the spill over rows for a are labeled ( [symbol] ⊥ [symbol] , [symbol] j+1 [symbol] ), ( [symbol] ⊥ [symbol] , [symbol] j+2 [symbol] ), . . .

The algorithm to compute the weak d-normalized representation is provided below:

### 4.1 Weak d-Normalization

Theorem 9. (Secure Weak d-Normalization) For c servers, assume the existence of honest-butcurious SECURE SHUFFLE protocol with linear work and O(1) rounds, resilient against any collusion of at most u<c servers. Further, assume that there exists a c-server MPC protocol for ABB operations, tolerating at most u<c colluding servers. Assume that c servers are given a secret-shared adjacency list [symbol] A [symbol] for any graph G(V, E). Then, there exists an honest-but-curious secure algorithm, tolerating at most u collusions, to obliviously convert [symbol] A [symbol] into a weak ┌2E/V┐-normalized replicated adjacency list of size 4(V+E). The conversion takes O(1) rounds and O(V+E) secure operations.

The algorithm takes as input an ordered secret-shared adjacency list [symbol] AL [symbol] consisting of q =V+E tuples (bᵢ, aₒ). It outputs a two-dimensional array [symbol] A[i [symbol] where 1≤i≤2V and 0≤j≤d. Each row of [symbol] A [symbol] consists of d+1 entries ( [symbol] cᵢ [symbol] , [symbol] aᵢ [symbol] ) consisting of vertex name [symbol] c [symbol] followed by d entries ( [symbol] cᵢ [symbol] , [symbol] aᵢ [symbol] ). cᵢ∈{{1, . . . , 2V}∪{⊥}} represents the name of the vertex which the edge starts from and aᵢ∈{{1, . . . , 2V}∪{⊥}} represents the name of the vertex to which the edge points to. In each row of [symbol] A [symbol] , all cᵢ's are equal.

### Weak d-Normalization Algorithm

1. Block partition: Partition [symbol] AL [symbol] into consecutive blocks of d tuples each. Let γ=[q/d] blocks, so γ is the number of blocks. Pad the last block with ( [symbol] 0 [symbol] , [symbol] ⊥ [symbol] )'s as needed so that each block is of the same length and consists of tuples of the same length. In order not to complicate the notation, re-define q←┌q/d┌·d.
2. Adding variable cᵢ:

$$2.1 {c}_{i} ← \{ \begin{matrix}{a}_{i} i f {b}_{i} = 1 \\ ⊥ i f {b}_{i} = 0\end{matrix}$$

2.2 For all i∈{2, . . . q} in parallel do:

cᵢ←cᵢ₋₁

All edges that don't follow a vertex have cᵢ=⊥. To each tuple in [symbol] AL [symbol] , add a third element cᵢ, so each tuple in [symbol] AL [symbol] consists of:

$$( 〚 {b}_{i} 〛 , 〚 {a}_{i} 〛 , 〚 {c}_{i} 〛 )$$

3. Block variable: For each block j, 1≤j≤γ define a boolean variable [symbol] contⱼ [symbol] to be equal to 1 if the first entry of block j is an edge. Otherwise [symbol] contⱼ [symbol] is 0. That is, look at bᵢ in the first tuple of each block. Note that cont₁=0always.
4. Computing Rows: Define secret-shared array [PRELIM-1] of length q+γ, where contᵢ is inserted in front of each block i:

$$4.1 PRELIM - 1 = 0 , {b}_{1} , {b}_{2} , ... , {b}_{d} , {cont}_{2} , {b}_{( d + 1 )} , ... , {b}_{2 d} , {cont}_{3} , {b}_{2 d + 1} ...$$

$$4.2 PRELIM - 2 ← SILENT PREFIXSUM ( PRELIM - 1 )$$

$$4.3 Compute a secret - shared vector$$

$$ROW = {r}_{1} , ... , {r}_{q}$$

of length q by deleting γ positions in the PRELIM-2 vector that corresponded to the positions of contᵢ variables that were inserted into [symbol] PRELIM-1 [symbol] . Extend each tuple in

[symbol] AL [symbol] to be of the form:

$$〚 ( {b}_{i} , {a}_{i} , {c}_{i} , {r}_{i} ) 〛$$

where tuple number i gets the i'th element of [symbol] ROW [symbol] .
5. Computing Columns: Within each block there are exactly d consecutive tuples. Number them (silently) from 1 to d and add this count to each tuple. [symbol] AL [symbol] now becomes:

$$〚 ( {b}_{i} , {a}_{i} , {c}_{i} , {r}_{i} , a d d {r}_{i} ) 〛$$

6. “First edge” (fe): Define a boolean variable [symbol] feᵢ [symbol] for each tuple.

$$6.1 For all i ∈ \{ 2 , ... , q - 1 \} in parallel do :$$

$${fe}_{i} ← ( ( {b}_{i} = 0 ) ∧ ( ( {addr}_{i} = 1 ) ∨ ( {b}_{( i - 1 )} = 1 ) ) ) ∨ ( ( {b}_{i} = 1 ) ∧ ( ( {b}_{i + 1} = 1 ) ∨ ( {addr}_{i} = d ) ) )$$

$$6.2 {fe}_{1} ← ( {b}_{2} = 1 )$$

$$6.3 {fe}_{q} ← ( {b}_{q} = 1 ) ∨ ( ( {b}_{q} = 0 ) ∧ {b}_{q - 1} = 1 ) )$$

A “first edge” is either the first element in the block or proceeds a vertex. Additionally, vertices with no outgoing edges or vertices at the end of a block are counted as a first edge. The tuple now becomes:

$$〚 ( {b}_{i} , {a}_{i} , {c}_{i} , {r}_{i} , {addr}_{i} , {fe}_{i} ) 〛$$

7. “Last edge” (le): Define a boolean variable [leᵢ ] for each tuple.

$$7.1 For all i ∈ \{ 2 , ... , q - 1 \} in parallel do :$$

$${le}_{i} ← ( ( {b}_{i} = 0 ) ∧ ( ( {addr}_{i} = d ) ∨ ( {b}_{( i + 1 )} = 1 ) ) ) ∨ ( ( {b}_{i} = 1 ) ∧ ( ( {b}_{i + 1} = 1 ) ∨ ( {addr}_{i} = d ) ) )$$

$$7.2 {le}_{1} ← ( {b}_{2} = 1 )$$

$$7.3 {le}_{q} ← 1$$

A “last edge” is either the last in the block or precedes a vertex. Additionally, vertices with no outgoing edges are last edges. The tuple now becomes:

$$〚 ( {b}_{i} , {a}_{i} , {c}_{i} , {r}_{i} , {addr}_{i} , {fe}_{i} , l {e}_{i} ) 〛$$

8. Create fake fe and le:

$$8.1 Create arrays 〚 F 1 〛 and 〚 F 2 〛 , each of size 2 V tuples ⊳ each tuple has 7 entries \\ 8.2 For all t ∈ \{ 1 , … , 2 V \} in parallel do : \\ If t \leq 〚 {r}_{q} 〛 : put 〚 ( ⊥ , ⊥ , ⊥ , ⊥ , ⊥ , 0 , 0 ) 〛 into 〚 F 1 〛 at position t . ⊳ to be ignored in 9.4 \\ Else : ( t > 〚 {r}_{q} 〛 ) put 〚 ( ⊥ , ⊥ , ⊥ , t , 1 , 1 , 0 ) 〛 into 〚 F 1 〛 at position t ⊳ \vert {fe}_{i} = 1 \vert = 2 V \\ 8.3 For all t ∈ \{ 1 , … 2 V \} in parallel do : \\ If t \leq 〚 {r}_{q} 〛 : write 〚 ( ⊥ , ⊥ , ⊥ , ⊥ , ⊥ , 0 , 0 ) 〛 into 〚 F 2 〛 at position t . ⊳ to be ignored in 10.4 \\ Else : ( t > 〚 {r}_{q} 〛 ) Write 〚 ( ⊥ , ⊥ , ⊥ , t , 2 , 0 , 1 ) 〛 into 〚 F 2 〛 at position t . ⊳ Creating fake rows$$

9. Total-First:

$$\begin{matrix}\begin{matrix}9.1 & π ← SAMPLE - FRESH - PERMUTATION & ⊳ π ∈ {S}_{q + 2 V} \\ 9.2 & F 3 ← SECURE - SHUFFLE ( AL ⋃ F 1 ) , π ) & \\ 9.3 & L 6 ← the 6 th component of each tuple in F 3 & ⊳ extracting {fe}_{i} boolean array \\ 9.4 & F 4 ← OBLIVIOUS 2 V - COMPACT ( 2 V , L 6 , F 3 ) & ⊳ F 4 is of size 2 V \\ 9.5 & F - first [ x , y ] is a 2 V \times d array . Initialize it as follows : & \\ 9.5 \text{.1} & For 1 \leq x \leq 2 V : & \\ 9.5 \text{.2} & \begin{matrix}Let & ( {b}_{i} , {a}_{i} , {c}_{i} , {r}_{i} , {addr}_{i} , {fe}_{i} , {le}_{i} ) ← F 4 [ x ]\end{matrix} & \end{matrix} \\ \begin{matrix}9.5 \text{.3} & \begin{matrix}For 1 \leq y \leq d : & ⊳ Fill row with ⊥ ’ s prior to first edge appearance\end{matrix} \\ & F - First [ x , y ] ← \{ \begin{matrix}\begin{matrix}If & y < {addr}_{i}\end{matrix} & then create tuple ( ⊥ , ⊥ , {c}_{i} , {r}_{i} , y , ⊥ , ⊥ ) \\ Else y \geq {addr}_{i} & then create tuple ( ⊥ , ⊥ , ⊥ , ⊥ , ⊥ , ⊥ , ⊥ )\end{matrix}\end{matrix}\end{matrix}$$

10. Total-Last:

$$10.1 〚 π 〛 ← SAMPLE - FRESH - PERMUTATION ⊳ π ∈ {S}_{q + 2 V} \\ 10.2 〚 F 5 〛 ← SECURE - SHUFFLE ( 〚 AL 〛 ⋃ 〚 F 2 〛 , 〚 π 〛 ) \\ 10.3 〚 L 7 〛 ← the 7 th component of each tuple in 〚 F 5 〛 ⊳ extracting {le}_{i} boolean array \\ 10.4 〚 F 6 〛 ← OBLIVIOUS 2 V - COMPACT ( 2 V , 〚 L 7 〛 , 〚 F 5 〛 ) ⊳ F 6 is of size 2 V \\ 10.5 F - last [ z , y ] is a 2 V \times d array . Initialize it as follows : \\ 10.5 \text{.1} For 1 \leq x \leq 2 V in parallel do : \\ 10.5 \text{.2} Let 〚 ( {b}_{i} , {a}_{i} , {c}_{i} , {r}_{i} , {addr}_{i} , {fe}_{i} , {le}_{i} ) 〛 ← F 6 [ x ] \\ 10.5 \text{.3} For 1 \leq y \leq d in parallel do : ⊳ Fill row with {⊥}^{’} s after the last edge appearance \\ F - last [ x , y ] ← \{ \begin{matrix}If y > {addr}_{i} & then create tuple 〚 ( ⊥ , ⊥ , {c}_{i} , {r}_{i} , y , ⊥ , ⊥ ) 〛 \\ Else y \leq {addr}_{i} & then create tuple 〚 ( ⊥ , ⊥ , ⊥ , ⊥ , ⊥ , ⊥ , ⊥ ) 〛\end{matrix}$$

11. Preparing [symbol] A [symbol] :

$$11.1 \qquad \begin{matrix}π ← SAMPLE - FRESH - PERMUTATION & ⊳\end{matrix} π ∈ {S}_{q + 4 V \cdot ( d + 1 )}$$

$$\begin{matrix}11.2 & \begin{matrix}A 1 ← SECURE - SHUFFLE ( AL ⋃ F - first ⋃ F - last ⋃ F 1 ⋃ F 2 , π ) & ⊳ Treat\end{matrix} \\ & arrays as 1 - dimensional\end{matrix}$$

$$\begin{matrix}11.3 & A 2 is a boolean vector of length q + 4 V ( d + 1 ) where , \\ & For each tuple 1 \leq i \leq ( q + 4 V ( d + 1 ) in parallel do : \\ & ( {b}_{i} , {a}_{i} , {c}_{i} , {r}_{i} , {addr}_{i} , {fe}_{i} , {le}_{i} ) ← A 1 [ i ] \\ & A 2 [ i ] ← \{ \begin{matrix}0 & If {r}_{i} = ⊥ ∨ ( {b}_{i} = 1 ∧ {fe}_{i} \neq 1 ∧ {le}_{i} \neq 1 ) \\ 1 & Otherwise\end{matrix} \\ & Note that the number of 1 ’ s in A 2 is exactly 2 V \cdot d .\end{matrix}$$

$$11.4 \qquad A 3 ← OBLIVIOUS ( 2 V \cdot d ) - COMPACT ( 2 V \cdot d , A 2 , A 1 )$$

$$\begin{matrix}11.5 & For 1 \leq i \leq 2 V d in parallel do : \\ & ( {b}_{i} , {a}_{i} , {c}_{i} , {r}_{i} , {addr}_{i} , {fe}_{i} , {le}_{i} ) ← A 3 [ i ]\end{matrix}$$

Open the fourth and the fifth value of each tuple (i.e. (rᵢ, addrᵢ)), and put into (rᵢ, addrᵢ) address of A the following secret-shared values:

$$A ( {r}_{i} , {addr}_{i} ) ← ( 〚 {c}_{i} 〛 , 〚 {a}_{i} 〛 )$$

12. Binary Continuation Marker: Initialize a secret-shared bit vector of size 2V called [symbol] Continuation [symbol] .

Each position i∈{1, . . . , 2V} of [symbol] Continuation [symbol] will correspond to row rᵢ in [symbol] A [symbol] .

$$\begin{matrix}\begin{matrix}\begin{matrix}12.1 & For 1 \leq i \leq 2 V - 1 in parallel do :\end{matrix} \\ \begin{matrix}12.2 & ( {c}_{i} , {a}_{i} ) ← A [ i , d ]\end{matrix} \\ \begin{matrix}12.3 & ( {c}_{i + 1} , {a}_{i + 1} ) ← A [ i + 1 , 1 ]\end{matrix}\end{matrix} \\ \begin{matrix}12.4 & Continuation [ i ] ← \{ \begin{matrix}1 , & if ( {c}_{i} = {c}_{i + 1} \neq ⊥ ) \\ 0 , & if ( {c}_{i} \neq {c}_{i + 1} )\end{matrix}\end{matrix} \\ \begin{matrix}12.5 & Continuation [ 2 V ] ← 0\end{matrix}\end{matrix}$$

Looking ahead, these binary continuation markers will be used in the present disclosure's secure implementation of Dijkstra's algorithm to see if the adjacency list in row rᵢ continues in row rᵢ₊₁.
13. Adding Headers

$$13.1 For all i ∈ \{ 1 , … , 2 V \} do : \\ 13.1 \text{.1} Let ( 〚 {c}_{i} 〛 , 〚 {a}_{i} 〛 ) ← A [ i , 1 ] \\ 13.1 \text{.2} A [ i , 0 ] ← ( 〚 {c}_{i} 〛 , i )$$

### 4.2 Analysis of Weak d-Normalization

Observe that the d-normalization and weak d-normalization algorithms differ only in steps 2 and 13.

Step 2 of weak d-normalization gives each edge which directly follows a vertex the name of that vertex. All other edges get ⊥. This takes O(1) rounds and O(V+E) work. Step 13 adds a tuple consisting of vertex name, row index to each row.

Thus, the whole weak d-normalization algorithm takes O(1) rounds and O(V+E) work. Sections 6, 7 demonstrate that weak d-normalized adjacency lists work for secure Dijkstra and MST.

### 5 Oblivious Priority Queue with Parallel Decrease Key

The disclosed approach extends the prior work of Jafargholi et al. on Oblivious Priority Queue design. The prior work constructs a full binary tree with n items, where each node of the tree is a buffer that can fit B =O(log n) items, and where each item is a (key, priority)-pair, both assumed to fit into a single word of RAM.

The prior work combines hierarchical ORAM and Path-ORAM. Specifically, items are assigned to a random root-to-leaf path in the tree (and never re-assigned) and traverse this path during operations. The path is determined by the output of a O(log n)-wise independent hash function. Note that this means the prefix of the hash output on key v from index 0 to j gives the address of v at level j. Therefore, each item “knows” which node it belongs to at any given level. To avoid overflow or underflow of any buffer, the prior work defines two procedures:
1. PUSHDOWN(i): Consider contents of all vertices at level i. Each node sends all of its items to its two children at level i+1. Each item moves according to its PRF evaluated on the item's key.
2. PULLUP(i): Consider contents of all vertices at level i. Each node of level i gets the lightest B/2 elements from both of its children at level i+1.

The tree is updated during Priority Queue operations as follows. It keeps a counter of the number of operations performed (e.g., decrease-key, extract-min). Just like hierarchical ORAM, every 2ⁱ operations, the tree executes PUSHDOWN(0) . . . ,PUSHDOWN(i), PULLUP(i) . . . PULLUP(0) in that order. The present disclosure refers to this operation as maintenance procedure. If i surpasses the number of levels in the tree, the tree will simply push down to the maximum level. This is done by pushing down and pulling up from i*, where i+=min{i, largest level}.

The prior work is in the client-server model, so the client can download any non-leaf vertex and its two children and sort contents of these lists locally “for free” to choose the lightest elements to take to the parent. However, as the present disclosure focuses on the three-or constant-server model, the disclosed algorithm does not have “for free” sorting operations and has to “pay” for all operations. In prior works, sorting occurs by the client only during PULLUP operation. Specifically, the contents of the two children are sorted by the ORAM client in the clear (once downloaded into the client's memory), and the lightest items are sent to the parent of these two children. This is done for the entire level of the trec.

To support parallel decrease-key functionality and match the current model, the OPQ construction is modified as follows.

It is inductively assumed that each node is already sorted from heaviest to lightest priority. When any node and its children are examined, the two sorted lists are merged using a secure linear-time merging algorithm. Then, the lightest B/2 elements are selected in the sorted list to move to the parent. During PULLUP(i), the selected B/2 lightest items are moved from level i+1 to level i in parallel. To keep the remaining “heavier” items that did not move up in the correct sorted order, observe that the items were sorted from heaviest to lightest. Only proper suffix of each list for both children could move up (without omissions). Furthermore, the algorithm can mark which items are moving up. Therefore, each item knows if it moved up or not, and can be (in parallel) replaced by ⊥.

The round and work-complexity of the modified PULLUP(i) is as follows: By the complexities of linear-time merging from prior works at the time of writing, for w items, merging the lists will take O(w) work and O(log log w) rounds. Moving the items will also take O(w) work and O(1) rounds since all items are moved in parallel. This means the total is O(w) work and O(log log w) rounds. Given that the buffer size at any node is O(log n), PULLUP(i) for every node at level i takes linear (therefore O(log n)) work and O(log log log n) rounds. Since the algorithm performs PULLUP(i) in parallel for all nodes of level i, PULLUP(i) will take O(log log log n) rounds and would take O(2ⁱ·log n) work. This is the same work complexity as in the prior construction of the OPQ, and therefore the prior proofs of correctness for amortization analysis apply.

PUSHDOWN keeps the inductive hypothesis and is modified as follows: To keep each node holding its items in sorted order from heaviest to lightest, the present OPQ construction must execute PUSHDOWN in a similar way to PULLUP: when examining node v and its two children, the present construction uses linear-time secure merge to merge the three lists. This results in a large sorted list and two empty children, between which the list is to be distributed, each item according to its O(log n)-wise independent hash function. For each item, output of the hash function is computed once during the initial build and once for every decrease-key operation. The output of this computation is stored together with the value of the item. The O(log n)-wise independent hash function is represented as a random polynomial of degree O(log n) where all coefficients are secret-shared. Therefore, evaluating such a polynomial takes O(log n) secure operations, namely exponentiations, multiplications, and additions.

Specifically, once the function is evaluated, the present construction stores it in a secret-shared form, and it moves together with the item. For each item, the i'th bit of the stored hash function is extracted. This indicates if this value has to go left or right. This can be done in parallel for all items inside the bit-decomposition black-box operator. Now, all items that go to the left are marked with secret-sharing of [0] and all items that go to the right are marked with a secret-sharing of [1]. The present construction can then take a Silent Prefix-Sum of this vector. This reveals to which address each right-bound item must be written to. The same process is repeated for the left-bound items.

Then, all items are obliviously shuffled and all items are put in place in the correct place and order. All items will move in parallel, and therefore the present construction executes PUSHDOWN of the entire level in parallel, meaning that in total, a PUSHDOWN will take O(log log log n) rounds, and O(2ⁱ log n) work for level i.

So far, the proof has assumed inductively that each node is already sorted, and describes how the tree remains sorted when items are moved between levels. The present disclosure now describes how all vertices will remain sorted even when items are inserted or removed. Prior OPQ constructions have four procedures that will either add or remove an item from the data structure: Insert, Decrease-Key, Extract-Min, and Delete. Note that the Insert procedure simply calls Decrease-Key.
Initialization of Priority Queue with n items: As in prior constructions, to initialize the Priority Queue, insert all elements at the root, one at a time. If n items are inserted, also run n maintenance steps. The maintenance schedule is followed as in described above and in prior works (i.e., the scheduled PUSHDOWN and PULLUP procedures).
Insert n elements: Element are inserted one at a time. Observe that the root node has space for at most O(log n) items; by induction, these items are already sorted. Therefore, only the new item has to be inserted in the sorted order. This can be done as a secure merge of a single item and a sorted list, using linear-time secure merge with linear work in the node size. That establishes the base case of the induction. Run maintenance steps as well.
Parallel Decrease-Key of u items: Before the present construction executes parallel decreasekey of w items, it executes PUSHDOWN(0) . . . . PUSHDOWN(γ), for γ=log(w). This means level γ and all levels above it are completely empty. The present disclosure refers to this step as “PushDown-manual” maintenance.
After this is done, to Decrease-key w items, the present construction inserst w items at level γ, which has we vertices. The buffer size B in each node is twice as large as in prior works. Observe that the total number of vertices in a binary tree of depth γ has 2w−1 vertices. Furthermore, prior works prove that none of the vertices will overflow after w sequential insertions. Therefore, in the present construction, with w vertices but with each node's buffer twice as big, there is 2w buffer space in total with uniform distribution, and therefore the proof from prior works still holds to prove the same claim.
One unresolved matter is that when the present construction inserts items at level γ, the items that fall into the same node must be sorted.
For each item i, the present construction computes in parallel which node id id(i) at level γ item i must go into, by considering γ-prefix the item's key O(log n)-wise hash function. Compute a hash function once requires O(log n) secure operation. The output of this computation is attached to the item, so that it doesn't have to be computed again. That hash function value will travel together with the item and will need not be recomputed.

This gives the address of that item at level γ. For any item i, consider a pair of the address id(i) and item's priority pᵢ, and obliviously reverse-sort all w items by concatenation of address and priority id(i)|p(i), where “|” is the concatenation operator. This way, when the items are sorted, all items belonging to the same node will be adjacent, and appear in order from heaviest to lightest priority.

However, writing all of these items to the correct vertices in parallel in O(1) rounds takes additional work to prevent collisions of items that are going to the same node. This is accomplished as follows:
After w items are sorted by id(i)|p(i), the present construction holds (a secret shared) list of (that sorted order) w items. This list is numbered with consecutive integers β_{w}, . . . , β₁. This is a sorted list from w down to 1.

Some items are also marked with a secret-shared predicate “lead.” Lead items are defined as the heaviest items for each node. This is done by comparing each item (under MPC) to its predecessor in the sorted order and checking if the predecessor belongs to a different node. The first item in the sorted order is always the lead item.
All vertices have buffer size B=O(log n) and are empty. Obliviously put item i into buffer id(i) at buffer location (βᵢ mod B). Observe that since items that belong to the same id(i) are already sorted from heavy to light, they will have consecutive numbering βⱼ, βⱼ₊₁, . . . Since items are placed into the buffer at the location βⱼ mod B, all items will be placed into the buffer in consecutive order but with some (circular) shift. This placement can be done by obliviously shuffling all locations of all vertices together, and then putting items in the clear into shuffled locations, and then “un-shuffling.” Observe that all w items are placed into correct buffers without collisions, but they may be shifted inside each buffer. The final step is to adjust the shift in each buffer so that the heaviest item is placed in location 1 of each buffer.
For each buffer, the following value is computed: for the “lead” item, compute its current location in the buffer and secret-share this value. This defines the amount δ that the contents of the buffer must be shifted by. For all non-lead items, secret-share [[0]]. Then, silently add (using Silent Prefix-Sum) all values for each node. This gives a single secret-shared “shift-by” value. Now, in parallel for all vertices, compute their current location and shift-by location. Obviously shuffle all the items and put them in the correct locations.
Next, the present construction executes PULLUP(γ), . . . PULLUP(0), which the present disclosure denotes as PullUp-manual maintenance. The present disclosure refers to the PushDownmanual maintenance and PullUp-manual maintenance jointly as manual maintenance. Finally, perform w steps of “traditional” maintenance, by increasing the counter of operations by w and performing all the maintenance operations. Observe that PUSHDOWN(0), . . . . PUSHDOWN(γ) PULLUP(γ), . . . , PULLUP(0) is executed during w steps of maintenance, so the manual maintenance is ½ of the maintenance routine. This means, in total, the present construction did 1.5 times the work of maintenance. That is just a constant that goes out in big-O notation. Therefore, the amortized analysis of prior works still applies.
Extract-Min: Extract-Min is identical to its design in prior works: Assuming the root is sorted in order from heaviest to lightest priority, taking the lightest priority element up takes O(log n) work and O(1) rounds. Specifically, for every item, check if the item next to it to the right is ⊥. If so, this is the last item. The order does not need to be changed, since the only last element was removed.
An item is deleted in the same way as in prior works: inserting an item with matching label and +∞ priority, and having it “kill” all its siblings as it travels down the tree during the regular maintenance cycles.

The amortization analysis of prior works applies to the present construction.

### 5.1 Complexity Analysis

Each O(log n)-wise independent hash function evaluation takes O(log n) secure operations. It is done once for each insert and each decrease key operation. Additionally, parallel decrease key has the same running time as the one decrease key. Therefore, the amortized cost per operation is O(log n).

Any PushDown(i) or PullUp(i) for any level i costs O(log log log n) rounds. Each Extract-Min and Insert costs O(1) rounds. Every w Parallel Decrease-Key operation takes the following two steps: (a) O(log n) rounds to insert and sort the w keys into level log w in parallel. (b) perform manual maintenance, which takes O(log w·log log log n) rounds. Scheduled maintenance amortizes the rounds in the same way as the work. This means the amortized cost of maintenance is O(log n log log log n). r denotes the number of times w-parallel decrease-key is called. (For the present disclosure's secure implementation of Dijkstra's algorithm, r=2n.) Because w≤n, the cost of manual and non-manual maintenance is combined. Putting it all together, the cost in all rounds becomes O(r·log n·log log log n).

### 6 Secure Dijkstra and its Analysis

Given the preceding constructions, the overall algorithm proceeds as follows. Let G be a graph provided in a secret-shared adjacency list representation. If the vertex identifiers in G are alphanumeric or unordered, the first step is to transform these into ordered integer vertex names using the renaming algorithm described in Section 3.3. This produces a secret-shared adjacency list where vertices are labeled with integers in the range 1 to V, and the list is ordered accordingly.

Next, the d-normalization algorithm (Section 3.1) is applied to the sorted adjacency list. The result is a d-length adjacency list for each vertex, which is stored in a secret-shared USE-ONCE KEY-VALUE STORE data structure. The USE-ONCE KEY-VALUE STORE structure provides efficient retrieval with additive overhead. In the context of Dijkstra's algorithm, each vertex is accessed exactly once, which implies that each corresponding block in USE-ONCE KEY-VALUE STORE is accessed only once. This property yields computational savings.

Efficiency arises from the ability to process d edges in parallel for each vertex without additional overhead, while concealing whether additional edges exist for the current vertex or whether the process has moved to a different vertex.

The following secret-shared data structures are maintained:
A secret-shared USE-ONCE KEY-VALUE STORE structure with 2V entries storing the dnormalized adjacency list;
secret-shared DORAM array of length 2V that maintains distances to all vertices. As in regular Dijkstra, initially, all distances are set to +∞. The secret-shared start vertex is set to have distance 0 inside DORAM, which does not reveal what the start vertex is;
The OPQ as described in Section 5 with 2V entries, where distance is the priority.

### 6.1 Edge Relaxation for a Single Block

Each block consists of d weighted edges. The PARALLEL EDGE RELAXATION subroutine for vertex vhd i begins by reading in DORAM the current estimate of distance h of vi.

For the d destination vertices referenced by vhd i in the current edge block, parallel DORAM reads are performed to retrieve their respective distances. Placeholder values I are treated as valid entries during the read process to maintain obliviousness. This parallel read incurs at most

Algorithm 1 Parallel Edge Relaxation

```
Input:
    • [symbol]    eᵢ [symbol]    = ( [symbol]   k₁ [symbol]   , [symbol]    x₁ [symbol]   ), . . . , ( [symbol]   k_{d} [symbol]   , [symbol]    x_{d} [symbol]   )
    • current distance [symbol]    h [symbol]    of the node being explored
PARALLEL RELAX( [symbol]   eᵢ [symbol]   ):
  1. [symbol]    a₁ [symbol]    . . . [symbol]    a_{d} [symbol]    ←
  PARALLEL-DORAM.DISJOINT.READ( [symbol]   k₁ [symbol]   , . . . , [symbol]    k_{d} [symbol]   )
  2. [symbol]    b₁ [symbol]    . . . [symbol]    b_{d} [symbol]    ← RELAX( [symbol]   x₁ [symbol]   , [symbol]    h [symbol]   , [symbol]    a₁ [symbol]   ), . . . ,
  RELAX( [symbol]   x_{d} [symbol]   , [symbol]    h [symbol]   , [symbol]    a_{d} [symbol]   )
  3. PARALLEL-DORAM.DISJOINT.WRITE(( [symbol]   k₁ [symbol]   , [symbol]    b₁ [symbol]   )), . . .
  ( [symbol]   k_{d} [symbol]   , [symbol]    b_{d} [symbol]   ))
  4. PQ.PARALLEL-DECREASE-KEY(( [symbol]   k₁ [symbol]   , [symbol]    b₁ [symbol]   ), . . . ,
  ( [symbol]   k_{d} [symbol]   , [symbol]    b_{d} [symbol]   ))
  5. return [symbol]    Continue? [symbol]
RELAX( [symbol]   x [symbol]   , [symbol]    h [symbol]   , [symbol]    a [symbol]   ):
  1. return [symbol]    _{ABB}.min{ [symbol]   x + h [symbol]   , [symbol]    a [symbol]   }
```

O(log V) rounds and O(d log V) work. The retrieved distances are denoted as (a₁, . . . a_{d}). Each edge is relaxed by computing the minimum of aᵢ and h+x, where a is the edge weight from vᵢ to the corresponding destination vertex. The resulting relaxed values are (b₁, . . . , b_{d}). This step requires O(d) secure operations and completes in constant rounds.

A parallel DORAM write is then performed to update all d destination vertex distances with the newly computed minimum values. This write requires O(d log V) work and O(log V) rounds. In parallel, d decrease-key operations are performed on the Oblivious Priority Queue. These operations collectively incur O(d log n) work and O(log V·log log log V) rounds.

At the end of the subroutine, a secret-shared continuation marker is returned to indicate whether additional d-blocks for the same vertex vᵢ remain to be processed. This operation takes constant rounds. In total, a single d block Edge Relaxation subroutine takes O(dlog V) work and O(log d log log log V) rounds. Since d<n, the cumulative cost across all vertices yields O(V log V) work and O(log V log log log V) rounds.

### 6.2 Secure Dijkstra

In the Secure Oblivious Dijkstra algorithm, execution begins by converting the input graph into a d-normalized replicated adjacency list format. The associated Key-Value Store (KVS) is initialized concurrently. This initialization step requires O(E+V log V) work and O(log V) rounds.

Following this, a Parallel DORAM structure is instantiated for maintaining tentative distances.

Algorithm 2 Secure Oblivious Dijkstra

Input: [symbol] G [symbol] = secret-shared adjacency list with n vertices (k₁...kₙ), m edges, and [symbol] s [symbol] as start
node.
SECURE-DIJKSTRA( [symbol] G [symbol] ):

| | | |
|---|---|---|
| 1. | CHANGE-GRAPH-REPRESENTATION( [symbol] G [symbol] ) | [symbol] Includes initializing KVS |

| | |
|---|---|
| 2. | PARALLEL-DORAM.INITIALIZE(( [symbol] k₁ [symbol] , [symbol] ∞ [symbol] ), . . . , ( [symbol] kₙ [symbol] , [symbol] ∞ [symbol] )) |
| 3. | PQ.INITIALIZE(( [symbol] k₁ [symbol] , [symbol] ∞ [symbol] ), . . . , ( [symbol] k_{w} [symbol] , [symbol] ∞ [symbol] )) |
| 4. | DORAM.WRITE( [symbol] s [symbol] , [symbol] 0 [symbol] ) |
| 5. | PQ.DECREASE-KEY( [symbol] s [symbol] , [symbol] 0 [symbol] ) |
| 6. | Z,166 x_{q} [symbol] ← [symbol] s [symbol] |
| 7. | for num from 1 to 2n do |
| 8. | ( [symbol] \vec{eᵢ} [symbol] ) ← KVS.READ( [symbol] x_{q} [symbol] ) |
| 9. | RELAX(( [symbol] \vec{eᵢ} [symbol] )) |
| 10. | if [symbol] Continue? [symbol] then |
| 11. | Pretend to EXTRACT-MIN |
| 12. | x_{q} ← x_{q+1} |
| 13. | else |
| 14. | x_{q} ← EXTRACT-MIN |
| 15. | end if |

Final output distance vector is now stored in DORAM.

This requires O(V log V) work and O(V log V) rounds. The Parallel Oblivious Priority Queue is also initialized with 2V entries, using vertex distances as priority keys. The initialization of the priority queue incurs OV log V) work and O(V log log log V) rounds.

The main algorithmic loop is then executed 2V times, corresponding to the 2V entries in the d-normalized replicated adjacency list. At each iteration q, the algorithm accesses the vertex identifier [symbol] x_{q} [symbol] of the current node under exploration. The initial vertex x₁ is set equal to the secret-shared source vertex s.

At each iteration, the algorithm performs a KVS read on [symbol] x_{q} [symbol] to obtain the associated d-edge block. This step requires O(d) work and O(1) rounds. The PARALLEL EDGE RELAXATION subroutine is then executed on the block. Following edge relaxation, an Extract-Min operation (or a no-op, depending on the continuation flag returned by the subroutine) is performed. Both branches of the conditional are indistinguishable and incur identical computational cost: O(log V) work and O(1) rounds.

Since the main loop is executed 2V times, the loop takes O(V·d log V) work and O(V log V log log log V) rounds. Because

$$d = 2 \frac{E}{V} ,$$

the total work from the loop is O(E log V). Putting it all together, the total cost is of the disclosed Secure Dijkstra method is O((E+V)log V) work and O(V log V log log log V) rounds.

The most efficient instantiation of the disclosed Dijkstra method would be a three-party honestbut-curious setting without collusion.

### 6.3 Using Weak d-Normalized Adjacency List

In the disclosed construction, each vertex is selected either through the Oblivious Priority Queue (OPQ) or as a continuation of its predecessor in the weak d-normalized adjacency list. A headless row—i.e., a row beginning with a ⊥ symbol—cannot be directly selected via the OPQ, as ⊥ does not appear in the priority queue. Therefore, selection of a headless row occurs only as a continuation following a non-headless row.

Each non-headless row contains a header of the form ( [symbol] α [symbol] , j), where α is a vertex name. If the continuation marker [symbol] Continue [symbol] is set to 1, it is inferred that additional edges for α are present in the next row. In this case, the following row will have the header ( [symbol] ⊥ [symbol] , j+1). If edges for vertex α continue further, subsequent rows will be labeled ( [symbol] ⊥ [symbol] , j+2), and so on.

Each set of d edges is extracted from the use-once KVS by computing the tag name of each vertex. The tag is computed simply by taking SISO-PRF of the vertex name. For the weak dnormalized adjacency list, the SISO-PRF of the header is computed to extract the row. As the present disclosure can compute headers for continuation row, it can extract all rows.

Furthermore, extraction of continuation rows is possible only after the originating vertex name has been resolved. This ensures that all rows-headless or otherwise-can be securely extracted without violating obliviousness or introducing information leakage.

Accordingly, the weak d-normalized adjacency list can be used in the disclosed secure Dijkstra protocol without affecting correctness or security guarantees.

### 7 MST

The techniques disclosed herein also enable secure computation of a Minimum Spanning Tree (MST). In particular, the weak d-normalized adjacency list format can be utilized to securely implement Prim's algorithm. The structural similarity between Prim's algorithm and Dijkstra's algorithm allows for a direct transformation with two modifications.

First, unlike Dijkstra's algorithm, Prim's algorithm does not require a specified start vertex.

Instead, an arbitrary vertex may be selected as the initial node. This choice does not affect the correctness or security of the algorithm. Second, when processing edges, Prim's algorithm selects the minimum-weight edge that connects a vertex in the explored set to one outside the set, as opposed to selecting edges originating only from a fixed start vertex.

These two modifications are compatible with the disclosed secure Dijkstra protocol (with modifications detailed in the protocols below) and do not alter the asymptotic round or work complexity of the overall construction.

Algorithm 3 Parallel Edge Processing

```
Input:
    • [symbol]    eᵢ [symbol]    = ( [symbol]   k₁ [symbol]   , [symbol]    x₁ [symbol]   ), . . . , ( [symbol]   k_{d} [symbol]   , [symbol]    x_{d} [symbol]   )
    • current distance [symbol]    h [symbol]    of the node being explored
PARALLEL RELAX( [symbol]   eᵢ [symbol]   ):
  1. [symbol]    a₁ [symbol]    . . . [symbol]    a_{d} [symbol]    ←
  PARALLEL-DORAM.DISJOINT.READ( [symbol]   k₁ [symbol]   , . . . , [symbol]    k_{d} [symbol]   )
  2. [symbol]    b₁ [symbol]    . . . [symbol]    b_{d} [symbol]    ← [symbol]    _{ABB}.min{ [symbol]   x₁ [symbol]   , [symbol]    a₁ [symbol]   }, . . . , [symbol]
  _{ABB}.min{ [symbol]   x_{d} [symbol]   , [symbol]    a_{d} [symbol]   }
  3. PARALLEL-DORAM.DISJOINT.WRITE(( [symbol]   k₁ [symbol]   , [symbol]    b₁ [symbol]   ), . . .
  ( [symbol]   k_{d} [symbol]   , [symbol]    b_{d} [symbol]   ))
  4. PQ.PARALLEL-DECREASE-KEY(( [symbol]   k₁ [symbol]   , [symbol]    b₁ [symbol]   ), . . . ,
  ( [symbol]   k_{d} [symbol]   , [symbol]    b_{d} [symbol]   ))
  5. return [symbol]    Continue? [symbol]
```

Algorithm 4 Oblivious Prim's Algorithm

Input: [symbol] G [symbol] = secret-shared adjacency list with n vertices (k₁...kₙ), m edges
SECURE-PRIM( [symbol] G [symbol] ):

| 1. | Pick start node [symbol] s [symbol] at random from [symbol] G [symbol] | |
|---|---|---|
| 2. | CHANGE-GRAPH-REPRESENTATION( [symbol] G [symbol] ) | [symbol] Includes initializing KVS |

| | |
|---|---|
| 3. | PARALLEL-DORAM.INITIALIZE(( [symbol] k₁ [symbol] , [symbol] ∞ [symbol] ), . . . , ( [symbol] kₙ [symbol] , [symbol] ∞ [symbol] )) |
| 4. | PQ.INITIALIZE(( [symbol] k₁ [symbol] , [symbol] ∞ [symbol] ), . . . , ( [symbol] kₙ [symbol] , [symbol] ∞ [symbol] )) |
| 5. | DORAM.WRITE( [symbol] s [symbol] , [symbol] 0 [symbol] ) |
| 6. | PQ.DECREASE-KEY( [symbol] s [symbol] , [symbol] 0 [symbol] ) |
| 7. | Z,185 x_{q} [symbol] ← [symbol] s [symbol] |
| 8. | for num from 1 to 2n do |
| 9. | ( [symbol] \vec{eᵢ} [symbol] ) ← KVS.READ( [symbol] x_{q} [symbol] ) |
| 10. | RELAX(( [symbol] \vec{eᵢ} [symbol] )) |
| 11. | if [symbol] Continue? [symbol] then |
| 12. | Pretend to EXTRACT-MIN |
| 13. | x_{q} ← x_{q+1} |
| 14. | else |
| 15. | x_{q} ← EXTRACT-MIN |
| 16. | end if |

Final output distance vector is now stored in DORAM.

The secure Prim's algorithm, instantiated using these components (see Algorithms 3 and 4), achieves a total complexity of O((V+E)log V) work and O(V log V log log log V) rounds.

### 7.1 Using Weak d-Normalized Adjacency List

The logic of using the weak d-normalized adjacency list follows exactly as it did with secure Dijkstra. The modifications made to go from secure Dijkstra to Prim's algorithm do not change the way that the weak d-normalized adjacency list is used.

### 8 Conclusions and Further Work

The disclosed d-NORMALIZED REPLICATED ADJACENCY LIST construction enables a transformation from standard secret-shared adjacency lists into MPC-friendly format using O(1) rounds and O(V+E) secure operations. A separate graph renaming procedure is also presented, which converts an adjacency list with alphanumeric vertex identifiers into an ordered integer-labeled format using ((log V) rounds and O((V+E)log V) secure operations. The resulting vertex identifiers range from 1 to W, and the ordering is preserved in the output representation.

Both of these algorithms are modular and and may be applicable in other secure graph processing settings. The secure Dijkstra algorithm introduced herein performs in O((V+E)log V) secure operations and requires O(V·log V·log log log V) communication rounds. The algorithm is fully oblivious and, therefore, compatible with constant-round secure computation protocols. In particular, the algorithm is amenable to implementation using Yao's Garbled Circuits framework, with invocations of Garbled RAM used selectively to implement DORAM access.

The general techniques disclosed are expected to generalize to other secure graph algorithms and may be adapted to address a broader class of privacy-preserving network computations.

### System Implementations

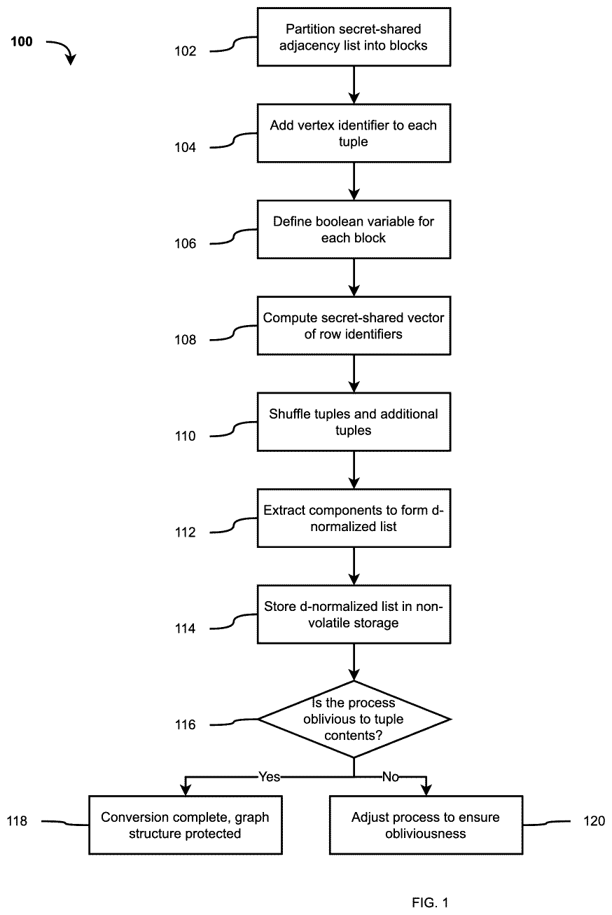

FIG. 1 illustrates a flowchart depicting a method 100 for processing a secret-shared adjacency list. The method 100 may handle both directed and undirected, weighted and unweighted graphs.

The method 100 begins with a step 102, where the secret-shared adjacency list may be partitioned into blocks. In some cases, these blocks may be consecutive blocks of d tuples each. The process continues to a step 104, where a vertex identifier may be added to each tuple in the secret-shared adjacency list.

In a step 106, the method 100 defines a boolean variable for each block. These boolean variables may indicate whether the first entry in each block is an edge or a vertex. Following this, a step 108 involves computing a secret-shared vector of row identifiers for each tuple.

The method 100 proceeds to a step 110, where tuples and additional tuples may be shuffled. This shuffling operation may help ensure the obliviousness of the process to tuple contents. In a step 112, components are extracted from the shuffled tuples to form a d-normalized list.

A step 114 involves storing the d-normalized list in non-volatile storage. The process then flows to a decision point at a step 116, which determines whether the process is oblivious to tuple contents. From this decision point, the method 100 follows one of two paths.

If the process is determined to be oblivious, the method 100 moves to a step 118, where the conversion may be considered complete and the graph structure protected. If the process is not oblivious, the method 100 proceeds to a step 120, where adjustments may be made to ensure obliviousness.

The method 100 incorporates various data processing and protection mechanisms, including partitioning, identifier addition, shuffling, and storage operations. These steps work together to transform the secret-shared adjacency list into a d-normalized list while maintaining security and privacy throughout the process.

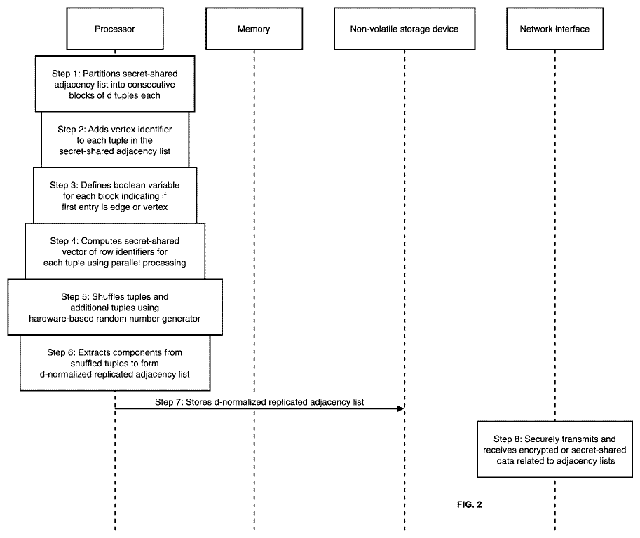

The secure graph processing method utilizes various hardware components to execute its operations while maintaining data privacy and security. FIG. 2 illustrates the key hardware elements involved in this process.

A processor serves as the central component for executing the computational steps of the method. The processor performs operations such as partitioning the secret-shared adjacency list into consecutive blocks of d tuples, adding vertex identifiers to each tuple, and defining boolean variables for each block. In some cases, the processor may leverage parallel processing capabilities to enhance performance, particularly when computing the secret-shared vector of row identifiers for each tuple.

Memory components work in conjunction with the processor to store intermediate results and facilitate data manipulation throughout the process. The memory may hold the partitioned blocks, vertex identifiers, and boolean variables during the computation stages.

A non-volatile storage device plays a crucial role in persistently storing the final d-normalized replicated adjacency list. This storage ensures that the processed graph data remains available for future use or analysis while maintaining its secure format.

The method incorporates a hardware-based random number generator to enhance the security of the shuffling process. This component provides cryptographically secure random numbers used in shuffling tuples and additional tuples, helping to obfuscate the original structure of the graph.

A network interface enables secure transmission and reception of encrypted or secret-shared data related to adjacency lists. This component facilitates communication with external systems or other parties involved in the secure multi-party computation, ensuring that data remains protected during transfer.

The hardware components interact in a coordinated manner to maintain security throughout the graph processing workflow. For example, the processor may retrieve data from memory, perform computations, and then store results back in memory or the non-volatile storage device. The random number generator feeds secure random values to the processor for use in the shuffling step. The network interface may receive encrypted or secret-shared input data and transmit encrypted or secret-shared results, with the processor handling encryption and decryption operations as needed.

By leveraging these specialized hardware components, the method achieves both computational efficiency and strong security guarantees in processing sensitive graph data.

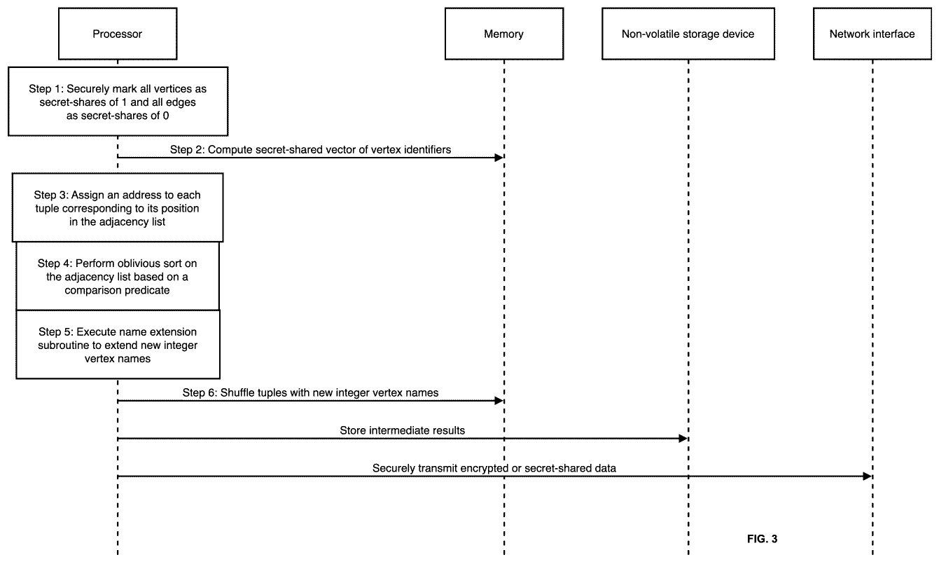

The secure graph processing system implements a sequence of operations to transform and protect graph data while maintaining privacy and security. FIG. 3 illustrates a detailed sequence diagram showing the interactions between key hardware components: a Processor, Memory, Nonvolatile storage device, and Network interface.

The process begins with the Processor executing several sequential steps to prepare the graph data for secure processing. In the first step, the Processor securely marks all vertices as secretshares of 1 and all edges as secret-shares of 0. This initial marking establishes a foundation for distinguishing between vertices and edges in subsequent operations while maintaining data privacy. Following the initial marking, the system computes a secret-shared vector of vertex identifiers. This computation may involve assigning unique identifiers to each vertex in the graph while preserving the confidentiality of the graph structure. The resulting vector of vertex identifiers is then transmitted to Memory for temporary storage and quick access during subsequent processing steps.

The Processor then executes a series of operations to further transform and secure the graph data. In one step, the system assigns addresses to each tuple corresponding to its position in the adjacency list. This addressing scheme may facilitate efficient data retrieval and manipulation while maintaining the privacy of the graph structure.

Next, the Processor performs an oblivious sort on the adjacency list based on a comparison predicate. Oblivious sorting algorithms may be employed to rearrange the data without revealing information about the original order or content of the tuples. This sorting operation may help in organizing the graph data for subsequent processing steps while preserving data confidentiality.

Following the oblivious sort, the system executes a name extension subroutine to extend new integer vertex names. This step may involve assigning additional identifiers or metadata to vertices, potentially enhancing the graph representation while maintaining privacy guarantees.

After these processing steps, the system proceeds to shuffle the tuples with the newly assigned integer vertex names. The shuffling operation may employ cryptographic techniques to randomize the order of the tuples, further obfuscating the original graph structure. The shuffled data is then transmitted to Memory for temporary storage.

Throughout these operations, the system may store intermediate results in the Non-volatile storage device. This storage step may serve as a checkpoint or backup mechanism, allowing for data persistence and recovery in case of system interruptions.

The final operation in the sequence involves the secure transmission of encrypted data from the Processor to the Network interface. This step may enable the sharing or distribution of processed graph data while maintaining end-to-end encryption and preserving the confidentiality of the graph structure.

By implementing this sequence of operations, the secure graph processing system may achieve a balance between data utility and privacy protection. The system transforms the original graph data through multiple stages of secure computation, obfuscation, and encryption, ultimately producing a protected representation of the graph that may be suitable for various analytical tasks while safeguarding sensitive information.

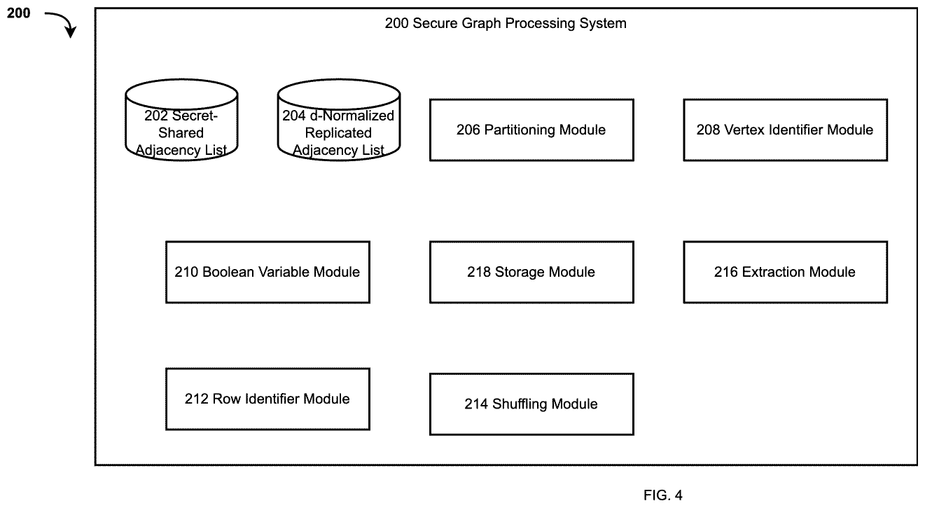

FIG. 4 illustrates a secure graph processing system 200 for transforming a secret-shared adjacency list 202 into a d-normalized replicated adjacency list 204. The secure graph processing system 200 may include multiple modules that work together to process graph data while maintaining privacy and security.

A partitioning module 206 may receive the secret-shared adjacency list 202 as input. In some cases, the partitioning module 206 may divide the secret-shared adjacency list 202 into blocks of a predetermined size. This partitioning may help organize the data for efficient processing and maintain uniform block sizes to prevent information leakage.

A vertex identifier module 208 may add vertex identifiers to each tuple in the partitioned data. These vertex identifiers may distinguish between different types of graph entities while preserving their anonymity through secret sharing techniques.

In some cases, a boolean variable module 210 may define boolean variables for each block. These boolean variables may indicate whether the first entry in a block is an edge or a vertex, providing additional structure to the processed data.

A row identifier module 212 may compute a secret-shared vector of row identifiers for each tuple. This step may help maintain the relational structure of the graph data while preserving privacy.

The secure graph processing system 200 may include a shuffling module 214. In some cases, the shuffling module 214 may perform oblivious shuffling operations on the tuples and any additional tuples. This shuffling process may ensure that the order of relationships in the graph remains hidden during analysis.

An extraction module 216 may extract components from the shuffled data to form the dnormalized replicated adjacency list 204. This extraction process may reorganize the data into a format optimized for secure graph algorithms while preserving privacy.

A storage module 218 may store the resulting d-normalized replicated adjacency list 204 in non-volatile storage. This storage step may ensure that the processed data is persistently available for further secure graph computations.

The modules within the secure graph processing system 200 may work together in a sequential manner, with each module performing specific functions to transform the secret-shared adjacency list 202 into the d-normalized replicated adjacency list 204. This modular architecture may allow for flexibility in implementing different secure graph processing algorithms while maintaining strong privacy guarantees through oblivious processing techniques.

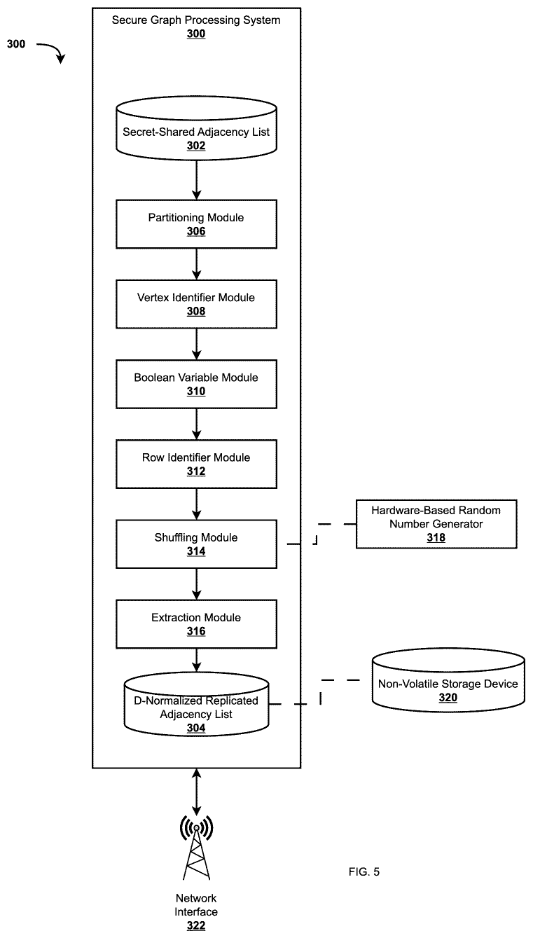

FIG. 5 illustrates an enhanced secure graph processing system 300. The secure graph processing system 300 may include a secret shared adjacency list 302 and a normalized replicated adjacency list 304. In some cases, the secure graph processing system 300 may comprise multiple processing modules arranged in a sequential flow to transform the secret shared adjacency list 302 into the normalized replicated adjacency list 304.

The secure graph processing system 300 may include a partitioning module 306 that receives input from the secret shared adjacency list 302. In some implementations, the partitioning module 306 may divide the secret shared adjacency list 302 into blocks of a predetermined size.

A vertex identifier module 308 may process the data after the partitioning module 306. The vertex identifier module 308 may assign unique identifiers to vertices in the graph structure. Following the vertex identifier module 308, a boolean variable module 310 may process the data. The boolean variable module 310 may define boolean variables for each block to indicate specific properties or conditions.

The data flow may continue through a row identifier module 312. The row identifier module 312 may compute a secret-shared vector of row identifiers for each tuple in the graph structure. After the row identifier module 312, a shuffling module 314 may process the data.

The shuffling module 314 may connect to a hardware-based random number generator 318 via a communication link. In some cases, the hardware-based random number generator 318 may provide cryptographically secure random numbers to enhance the shuffling process. The integration of the hardware-based random number generator 318 may improve the security and unpredictability of the shuffling operation.

An extraction module 316 may process the data after the shuffling module 314. The extraction module 316 may extract components from the shuffled data to form the normalized replicated adjacency list 304. The normalized replicated adjacency list 304 may connect to a non-volatile storage device 320 via a communication link.

The non-volatile storage device 320 may provide persistent storage for the normalized replicated adjacency list 304. In some implementations, the use of non-volatile storage may enhance data durability and allow for efficient retrieval of processed graph data in subsequent operations.

At the bottom of the secure graph processing system 300, a network interface 322 may enable communication with external systems or devices. The network interface 322 may connect to the secure graph processing system 300 through a bidirectional communication link. In some cases, the network interface 322 may facilitate secure transmission and reception of graph data or processing results.

The integration of the hardware-based random number generator 318 and the non-volatile storage device 320 with the processing modules may enhance both the security and efficiency of the graph processing operations. The hardware-based random number generator 318 may provide high-quality randomness for cryptographic operations, while the non-volatile storage device 320 may ensure data persistence and rapid access to processed graph structures.

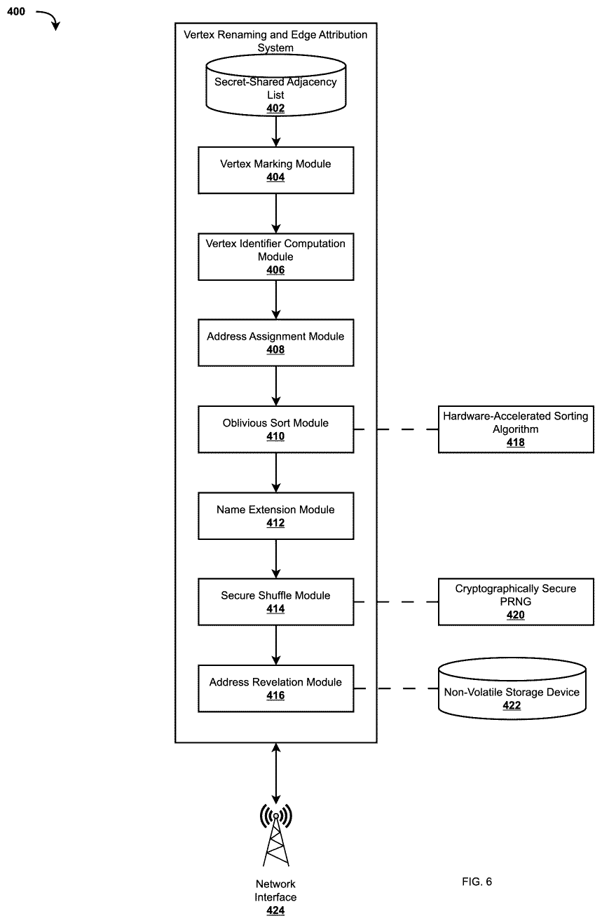

FIG. 6 illustrates a method 400 for vertex renaming and edge attribution in a secure graph processing system. The method 400 begins with a secret shared list 402 representing an adjacency list of a graph structure.

In some cases, a step 404 may involve marking vertices in the secret shared list 402. The vertex marking process may differentiate between vertices and edges in the graph structure. A step 406 may compute vertex identifiers based on the marked vertices. These vertex identifiers may provide unique labels for each vertex in the graph.

A step 408 may assign addresses to elements in the secret shared list 402. These addresses may correspond to positions of vertices and edges within the adjacency list representation. In some cases, a step 410 may perform an oblivious sort on the elements of the secret shared list 402. The oblivious sort may rearrange the elements without revealing information about their relative ordering or original positions.

A sorting algorithm 418 may be utilized to accelerate the oblivious sort operation. The sorting algorithm 418 may be implemented in hardware to improve processing speed while maintaining the security properties of the oblivious sort.

A step 412 may extend new integer names for vertices in the graph. This name extension process may create a consistent naming scheme across the entire graph structure. In some cases, a step 414 may perform a secure shuffle of the graph elements. The secure shuffle may further obfuscate the relationships between vertices and edges.

A random number generator 420 may provide cryptographically secure random values for use in the secure shuffle operation. The random number generator 420 may ensure the unpredictability and uniformity of the shuffling process.

A step 416 may reveal addresses of the shuffled and renamed graph elements. In some cases, the revealed addresses may be stored in a storage device 422. The storage device 422 may be a non-volatile storage medium that retains the processed graph data for future use or analysis.

A network interface 424 may facilitate communication of the processed graph data with other components of a distributed system or external analysis tools. The network interface 424 may enable secure transmission of the vertex-renamed and edge-attributed graph structure while preserving the privacy guarantees established by the method 400.

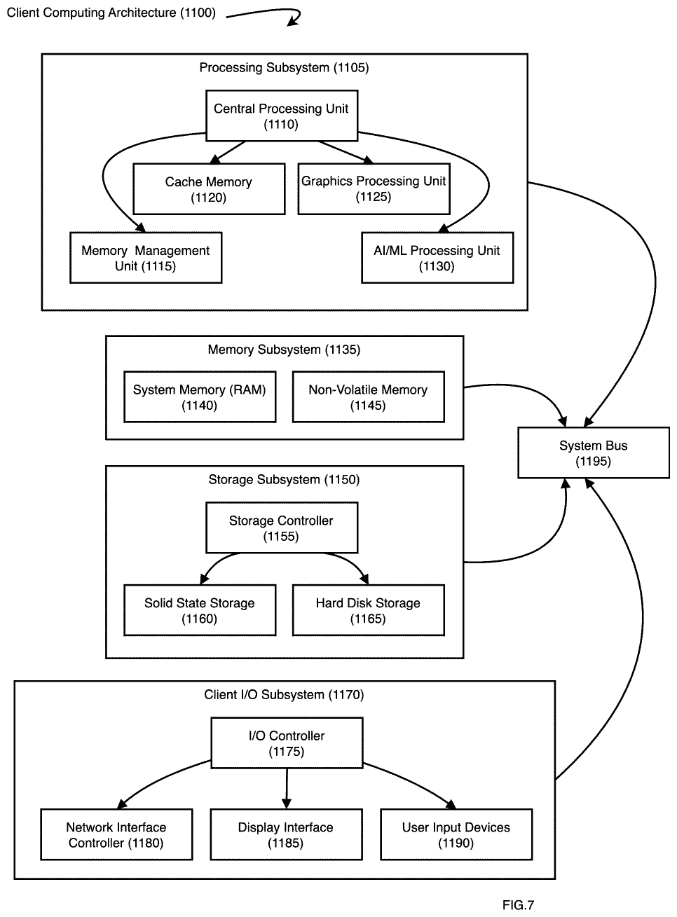

FIG. 7 illustrates a Client Computing Architecture 1100 that may be used to implement secure graph processing operations. The Client Computing Architecture 1100 includes several interconnected subsystems that work together to perform various computational tasks.

A Processing Subsystem 1105 forms the core of the Client Computing Architecture 1100. The Processing Subsystem 1105 may include a Central Processing Unit 1110 that executes instructions and performs calculations. In some cases, the Central Processing Unit 1110 may be assisted by a Memory Management Unit 1115, which manages the flow of data between the processor and memory. A Cache Memory 1120 may be included to provide fast access to frequently used data and instructions.

The Processing Subsystem 1105 may also incorporate specialized processing units. A Graphics Processing Unit 1125 may handle rendering of visual data and accelerate certain types of computations. An AI/ML Processing Unit 1130 may be included to optimize artificial intelligence and machine learning tasks, which may be particularly useful for advanced graph analysis algorithms.

A Memory Subsystem 1135 provides storage for active data and program code. The Memory Subsystem 1135 may include System Memory (RAM) 1140 for fast, volatile storage of data that is currently in use. Non-Volatile Memory 1145 may also be included to store data that needs to persist when power is removed.

For longer-term data storage, the Client Computing Architecture 1100 may include a Storage Subsystem 1150. A Storage Controller 1155 may manage data access and storage operations. The Storage Subsystem 1150 may incorporate Solid State Storage 1160 for fast, random access to data, as well as Hard Disk Storage 1165 for higher capacity storage.

To interact with external devices and users, the Client Computing Architecture 1100 may include a Client I/O Subsystem 1170. An I/O Controller 1175 may coordinate various input and output operations. A Network Interface Controller 1180 may enable communication with other devices and networks, which may be crucial for distributed graph processing tasks. A Display Interface 1185 may manage output to visual displays, while User Input Devices 1190 may allow for user interaction and control.

All of these subsystems may be interconnected through a System Bus 1195. The System Bus 1195 may facilitate data transfer between the various components, allowing them to work together seamlessly.

In the context of secure graph processing, the Client Computing Architecture 1100 may utilize its components in specific ways. For example, the Central Processing Unit 1110 and AI/ML Processing Unit 1130 may work together to execute complex graph algorithms while maintaining data privacy. The Memory Subsystem 1135 and Storage Subsystem 1150 may store and manage secret-shared graph data, ensuring that sensitive information remains protected. The Network Interface Controller 1180 may facilitate secure communication with other parties involved in multi-party computation protocols.

The Graphics Processing Unit 1125 may be leveraged for parallel processing tasks common in graph operations, such as matrix multiplications or graph traversals. The Client I/O Subsystem 1170 may provide a secure interface for users to interact with the graph processing system, inputting data or receiving results without compromising the confidentiality of the underlying graph structure.

By utilizing the various components of the Client Computing Architecture 1100, secure graph processing operations may be performed efficiently while maintaining the necessary security and privacy guarantees. The architecture's design allows for flexible allocation of resources to different aspects of graph processing, from data storage and computation to user interaction and network communication.

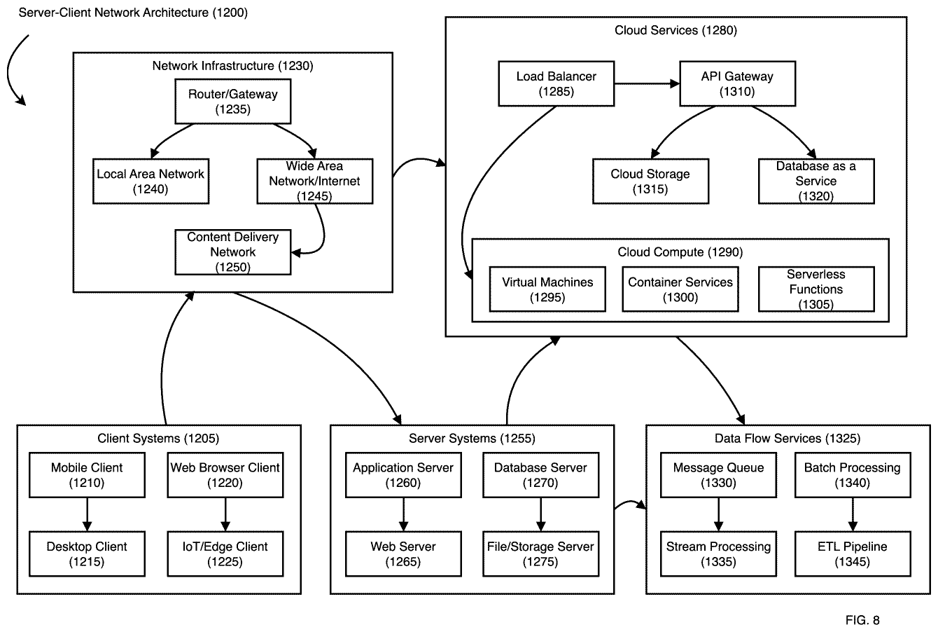

FIG. 8 illustrates a Server-Client Network Architecture 1200 that may support distributed secure graph processing across various network environments. The Server-Client Network Architecture 1200 includes Client Systems 1205, Network Infrastructure 1230, Server Systems 1255, and Cloud Services 1280.

The Client Systems 1205 may comprise multiple types of client devices. A Mobile Client 1210 may represent smartphones or tablets. A Desktop Client 1215 may include personal computers or workstations. A Web Browser Client 1220 may enable access through web-based interfaces. An IoT/Edge Client 1225 may encompass Internet of Things devices or edge computing nodes.

The Network Infrastructure 1230 facilitates communication between components. A Router/Gateway 1235 may connect to a Local Area Network 1240 for internal communications and a Wide Area Network/Internet 1245 for external connectivity. A Content Delivery Network 1250 may optimize data delivery across the Wide Area Network/Internet 1245.

Server Systems 1255 provide centralized processing and storage capabilities. An Application Server 1260 may host software applications. A Web Server 1265 may serve web content. A Database Server 1270 may manage structured data storage. A File/Storage Server 1275 may handle unstructured data and file storage.

Cloud Services 1280 extend computing resources and capabilities. A Load Balancer 1285 may distribute incoming network traffic across multiple servers. Cloud Compute 1290 resources may include Virtual Machines 1295, Container Services 1300, and Serverless Functions 1305. These components may enable flexible deployment of secure graph processing algorithms.

An API Gateway 1310 may manage access to Cloud Storage 1315 and Database as a Service 1320. Data Flow Services 1325 may include a Message Queue 1330 for asynchronous communication, Stream Processing 1335 for real-time data analysis, Batch Processing 1340 for large-scale computations, and an ETL Pipeline 1345 for data transformation and loading.

In some cases, the Server-Client Network Architecture 1200 may process a secret-shared adjacency list representing various entities and relationships. For financial applications, the secret-shared adjacency list may represent financial entities and their relationships. Nodes in the graph may correspond to companies or individuals, while edges may indicate loans, guarantees, or transactions.

In healthcare scenarios, the secret-shared adjacency list may represent patients, healthcare providers, or geographic regions. Edges in this context may indicate contacts, referrals, or transmission pathways, enabling privacy-preserving analysis of healthcare networks.

For supply chain applications, the secret-shared adjacency list may represent suppliers, manufacturers, and distributors. Edges may indicate dependencies, contracts, or material flows, allowing secure analysis of supply chain relationships without exposing sensitive business information. In cryptocurrency and blockchain applications, the secret-shared adjacency list may represent cryptocurrency addresses, users, or smart contracts. Edges may indicate transactions, contract interactions, or token transfers, enabling privacy-preserving analysis of blockchain networks.

The distributed nature of the Server-Client Network Architecture 1200 may allow for secure processing of these sensitive graph structures across various components. Client Systems 1205 may initiate requests or provide input data. Server Systems 1255 may perform centralized processing tasks. Cloud Services 1280 may enable scalable and flexible computation using Virtual Machines 1295, Container Services 1300, or Serverless Functions 1305.

Data Flow Services 1325 may facilitate the movement and processing of graph data. The Message Queue 1330 may enable asynchronous processing of graph operations. Stream Processing 1335 may allow for real-time analysis of dynamic graph structures. Batch Processing 1340 may handle large-scale graph computations. The ETL Pipeline 1345 may transform and load graph data from various sources while maintaining privacy guarantees.

By leveraging this distributed architecture, secure graph processing algorithms may be implemented across various network environments while preserving the confidentiality of the underlying graph structure and relationships.

The present disclosure relates to methods for efficient representation and processing of graphs in computer networks. More specifically, the disclosure provides methods for converting a secret-shared adjacency list of a graph into a d-normalized replicated adjacency list and renaming vertices and attributing edges in a secret-shared adjacency list of a graph. These methods may be particu- larly beneficial in the context of secure multi-party computation (MPC), where two or more parties jointly compute a function over their inputs while keeping those inputs private.

In some embodiments, the disclosed methods may involve assigning a distinct integer identifier to each vertex in the graph and using these identifiers to represent the graph structure where the same vertex may have multiple adjacency lists all of equal length. This approach, known as Normalized Adjacency Lists, may reduce the space complexity and improve the efficiency of secure graph algorithms. The identifiers may be contiguous integers ranging from 0 to n-1, where n is the total number of vertices in the graph. An array or a hash table may be used to map the original vertex labels or names to their corresponding identifiers.

In other embodiments, the methods may involve creating an array of size n, where each element represents a vertex in the graph. Each element of the array may be a linked list or a dynamic array that stores the identifiers of the neighboring vertices with the restriction that all arrays or linked lists are of fixed size independent of specific graph strcuture. For each vertex, the method may involve iterating through its adjacent vertices and adding their corresponding identifiers to the linked list several times or a dynamic array of fixed size associated with that vertex.

In yet other embodiments, the methods may involve representing each edge in the adjacency lists by the identifier of the destination vertex. If the graph is weighted, the weight may be stored along with the destination vertex identifier as a pair or a tuple.

The disclosed methods may provide several advantages. For instance, by using contiguous integer identifiers for vertices, the methods may eliminate the need to store the actual vertex labels or names, thereby reducing the space complexity. The methods may also improve cache utilization during graph traversal due to the contiguous memory layout of the adjacency lists. Furthermore, the use of integer identifiers may simplify the process of referencing vertices during graph algorithms, as integer comparisons can be performed, which are faster and more efficient than comparing vertex labels or names. The methods may also offer flexibility, as they can be used to represent both directed and undirected graphs, and can easily incorporate weighted edges by storing the weights along with the destination vertex identifiers.

In some aspects, the method for converting a secret-shared adjacency list of a graph into a dnormalized replicated adjacency list may involve initializing a secret-shared bit vector as a binary continuation marker for each row in the d-normalized replicated adjacency list. This binary continuation marker may serve as an indicator of whether the adjacency list of a vertex spans multiple rows in the d-normalized replicated adjacency list.

In some cases, the binary continuation marker may be initialized to a default value, such as zero, for each row in the d-normalized replicated adjacency list. The binary continuation marker for a particular row may be updated to a different value, such as one, if the adjacency list of a vertex spans to the next row. This update may be performed in a secure and oblivious manner, ensuring that no information about the graph's structure is revealed during the process.

In some embodiments, the binary continuation marker may be used to facilitate the efficient traversal of the d-normalized replicated adjacency list. For instance, during the execution of a graph algorithm, the binary continuation marker may be used to determine whether to continue traversing the adjacency list of a vertex to the next row or to move to the adjacency list of the next vertex. This may improve the efficiency of graph algorithms by reducing unnecessary traversals.

In other embodiments, the binary continuation marker may be used to facilitate the secure and efficient insertion or deletion of vertices or edges in the d-normalized replicated adjacency list. For example, when a new vertex or edge is inserted, the binary continuation marker may be updated accordingly to reflect the change in the adjacency list of the affected vertex. Similarly, when a vertex or edge is deleted, the binary continuation marker may be updated to reflect the change in the adjacency list of the affected vertex. These operations may be performed in a secure and oblivious manner, ensuring that no information about the graph's structure is revealed during the process.

In some aspects, the method may involve partitioning the secret-shared adjacency list into consecutive blocks of d tuples each, where d is proportional to the average degree of a graph. Each block may represent a portion of the adjacency list associated with a particular vertex in the graph.

The size of each block, denoted as d, may be chosen to be approximately twice the average degree of the vertices in the graph. This choice of block size may ensure that the majority of vertices in the graph have their adjacency lists fully contained within a single block, thereby facilitating efficient access and processing of the adjacency lists.

In some cases, the last block of the secret-shared adjacency list may contain fewer than d tuples, especially if the total number of tuples in the adjacency list is not a multiple of d. To maintain a uniform block size across the adjacency list, the method may involve padding the last block with dummy elements as needed to bring its size up to d. These dummy elements may be secret-shared representations of non-existent vertices or edges, ensuring that their presence does not reveal any information about the actual structure of the graph. The use of dummy elements in this manner may allow for a consistent and efficient processing of all blocks in the adjacency list, regardless of the actual degree distribution of the vertices in the graph.

In some aspects, the method may involve adding a vertex identifier to each tuple in the secret-shared adjacency list. This vertex identifier may serve to indicate whether the tuple represents a vertex or an edge in the graph. For instance, the vertex identifier may be a binary value, with one value (e.g., ‘1’) indicating that the tuple represents a vertex and another value (e.g., ‘0’) indicating that the tuple represents an edge. This binary vertex identifier may be added to each tuple in a secure and oblivious manner, ensuring that no information about the graph's structure is revealed during the process.

In some cases, the vertex identifier may also be used to identify the vertex to which an edge belongs. For example, for each tuple representing an edge, the vertex identifier may be set to the identifier of the vertex from which the edge originates. This may facilitate the efficient processing of the adjacency list, as it allows for the quick and secure identification of the vertices connected by each cdgc.

In other embodiments, the vertex identifier may be a multi-bit value that uniquely identifies each vertex in the graph. This multi-bit vertex identifier may be added to each tuple in the secret-shared adjacency list, allowing for the efficient and secure identification of vertices and the edges connecting them. The multi-bit vertex identifier may be generated in a secure and oblivious manner, ensuring that no information about the graph's structure is revealed during the process.

In yet other embodiments, the vertex identifier may be a secret-shared value that is computed based on the properties of the vertex or edge represented by the tuple. For example, the vertex identifier may be a hash value computed from the vertex label or name, or a function of the edge weight or other edge attributes. This secret-shared vertex identifier may be added to each tuple in the secret-shared adjacency list, providing a secure and efficient means of identifying vertices and edges in the graph.

In some aspects, the method may involve creating a boolean variable for each block in the secret-shared adjacency list to indicate whether the first entry of the block is an edge or a vertex. This boolean variable may be computed using a secure comparison operation that compares the first entry of the block with a predetermined edge indicator value. If the first entry matches the edge indicator value, the boolean variable may be set to a value indicating that the first entry is an edge. Otherwise, the boolean variable may be set to a value indicating that the first entry is a vertex. This process may be performed in a secure and oblivious manner, ensuring that no information about the structure of the graph is revealed during the process.

In some cases, the method may involve computing a secret-shared vector of row identifiers for each tuple in the secret-shared adjacency list. The row identifiers may serve to indicate the position of each tuple within its respective block in the adjacency list. The computation of the row identifiers may be performed using a secure prefix sum operation that aggregates the boolean variables associated with each tuple in the secret-shared adjacency list. This operation may generate a vector of row identifiers that are secret-shared and that can be used to facilitate the efficient and secure processing of the adjacency list.

In other embodiments, the method may involve using the computed row identifiers to facilitate the efficient and secure traversal of the d-normalized replicated adjacency list. For instance, during the execution of a graph algorithm, the row identifiers may be used to determine the position of each tuple within its respective block, thereby facilitating efficient access to the tuples. This may improve the efficiency of graph algorithms by reducing unnecessary traversals.

In yet other embodiments, the row identifiers may be used to facilitate the secure and efficient insertion or deletion of vertices or edges in the d-normalized replicated adjacency list. For example, when a new vertex or edge is inserted, the row identifiers may be updated accordingly to reflect the change in the adjacency list of the affected vertex. Similarly, when a vertex or edge is deleted, the row identifiers may be updated to reflect the change in the adjacency list of the affected vertex. These operations may be performed in a secure and oblivious manner, ensuring that no information about the graph's structure is revealed during the process.

In some aspects, the method may involve computing a secret-shared vector of row identifiers for each tuple in the secret-shared adjacency list. The row identifiers may serve to indicate the position of each tuple within its respective block in the adjacency list. The computation of the row identifiers may be performed using a secure prefix sum operation that aggregates the boolean variables associated with each tuple in the secret-shared adjacency list. This operation may generate a vector of row identifiers that are secret-shared and that can be used to facilitate the efficient and secure processing of the adjacency list.

In some cases, the method may involve assigning an address to each tuple in the secret-shared adjacency list. The address may correspond to the tuple's position in the list. This assignment may be performed in a secure and oblivious manner, ensuring that no information about the structure of the graph is revealed during the process. The assigned addresses may be used to facilitate the efficient and secure traversal of the adjacency list, as well as the efficient and secure insertion or deletion of vertices or edges in the adjacency list. For instance, when a new vertex or edge is inserted, the addresses may be updated accordingly to reflect the change in the adjacency list of the affected vertex. Similarly, when a vertex or edge is deleted, the addresses may be updated to reflect the change in the adjacency list of the affected vertex. These operations may be performed in a secure and oblivious manner, ensuring that no information about the graph's structure is revealed during the process.

In some aspects, the method may involve shuffling the tuples and additional tuples to mix them. This shuffling operation may be performed using a secure shuffle algorithm that randomly permutes the positions of tuples without revealing their original or final positions. The shuffled tuples may include both the original tuples from the secret-shared adjacency list and the additional tuples created to fill empty rows in the resulting two-dimensional array. The secure shuffle algorithm may be designed to ensure that the shuffle operation is unpredictable and secure, thereby maintaining the confidentiality of the graph's structure.

In some cases, the secure shuffle algorithm may be based on a fresh permutation sampled for each execution of the shuffle. This fresh permutation may be a random permutation of the positions of the tuples, gencrated using a secure random number generator. The use of a fresh permutation for each shuffle operation may ensure that the shuffle operation is not deterministic and cannot be predicted based on previous shuffle operations, thereby enhancing the security of the method.

In other embodiments, the secure shuffle algorithm may be designed to ensure that the shuffled tuples maintain the structure of the d-normalized replicated adjacency list. For instance, the secure shuffle algorithm may be designed to ensure that tuples representing vertices and edges of the same vertex remain adjacent in the shuffled list, and that tuples representing vertices precede tuples representing edges of the same vertex. This may facilitate the efficient processing of the d-normalized replicated adjacency list, as it allows for the quick and secure identification of the vertices connected by each edge.

In yet other embodiments, the secure shuffle algorithm may be designed to ensure that the shuffled tuples maintain the order of vertices and edges within each block of the d-normalized replicated adjacency list. This may facilitate the efficient traversal and processing of the adjacency list, as it allows for the quick and secure identification of the vertices and edges in each block.

In some aspects, the method may involve opening or de-committmment components from the shuffled tuples to form the d-normalized replicated adjacency list. This extraction process may be performed in a secure and oblivious manner, ensuring that no information about the structure of the graph is revealed during the process. The extracted components may include the vertex identifiers, edge identifiers, and the associated weights or other attributes of the vertices and edges.

In some cases, the extraction process may involve performing a secure selection operation on the shuffled tuples. This secure selection operation may be designed to retrieve tuples based on some components of each tuple being open after shuffling, without revealing the original positions of the tuples. The selected tuples may then be arranged in the d-normalized replicated adjacency list according to revealed information, maintaining the structure of the adjacency list.

In other embodiments, the extraction process may involve performing a secure comparison operation on the shuffled tuples. This secure comparison operation may be designed to compare the vertex identifiers and edge identifiers of the tuples, and to arrange the tuples in the d-normalized replicated adjacency list based on the results of the comparison. This may facilitate the efficient and secure processing of the adjacency list, as it allows for the quick and secure identification of the vertices and edges in the graph.

In yet other embodiments, the extraction process may involve performing a secure sorting operation on the shuffled tuples. This secure sorting operation may be designed to sort the tuples based on their vertex identifiers, edge identifiers, and the associated weights or other attributes. The sorted tuples may then be arranged in the d-normalized replicated adjacency list, maintaining the structure of the adjacency list and facilitating the efficient and secure processing of the graph.

In some aspects, the extraction process may be performed in parallel for all tuples in the shuffled list. This may improve the efficiency of the method by reducing the time and computational resources required to form the d-normalized replicated adjacency list. The parallel extraction process may be performed using a secure parallel processing algorithm that ensures the confidentiality of the graph's structure.

In some embodiments, the method may involve renaming vertices and attributing edges in a secret-shared adjacency list of a graph. This process may be executed in a manner that is oblivious to the contents of the tuples, ensuring that the renaming process does not reveal any information about the graph other than the total number of vertices and edges.

The renaming process may involve computing a secret-shared vector of vertex identifiers for each tuple in the secret-shared adjacency list. The vertex identifiers may serve to indicate whether the tuple represents a vertex or an edge in the graph. For instance, the vertex identifier may be a binary value, with one value (e.g., ‘1’) indicating that the tuple represents a vertex and another value (e.g., ‘0’) indicating that the tuple represents an edge. This binary vertex identifier may be added to each tuple in a secure and oblivious manner, ensuring that no information about the graph's structure is revealed during the process.

In some cases, the vertex identifier may also be used to identify the vertex to which an edge belongs. For example, for each tuple representing an edge, the vertex identifier may be set to the identifier of the vertex from which the edge originates. This may facilitate the efficient processing of the adjacency list, as it allows for the quick and secure identification of the vertices connected by each edge.

In other embodiments, the vertex identifier may be a multi-bit value that uniquely identifies each vertex in the graph. This multi-bit vertex identifier may be added to each tuple in the secret-shared adjacency list, allowing for the efficient and secure identification of vertices and the edges connecting them. The multi-bit vertex identifier may be generated in a secure and oblivious manner, ensuring that no information about the graph's structure is revealed during the process.

In yet other embodiments, the vertex identifier may be a secret-shared value that is computed based on the properties of the vertex or edge represented by the tuple. For example, the vertex identifier may be a hash value computed from the vertex label or name, or a function of the edge weight or other edge attributes. This secret-shared vertex identifier may be added to each tuple in the secret-shared adjacency list, providing a secure and efficient means of identifying vertices and edges in the graph.

In some aspects, the method may involve computing a secret-shared vector of vertex identifiers for each tuple in the secret-shared adjacency list. This computation may be performed using a silent prefix sum operation. The silent prefix sum operation may be a secure operation that computes the cumulative sum of the elements in a vector without revealing the individual elements. This operation may be particularly useful in the context of secure multi-party computation, where the goal is to compute a function over private inputs without revealing those inputs.

In some cases, the silent prefix sum operation may be performed on a vector of boolean variables associated with each tuple in the secret-shared adjacency list. These boolean variables may indicate whether the tuple represents a vertex or an edge in the graph. For instance, the boolean variable may be set to ‘1’ if the tuple represents a vertex and ‘0’ if the tuple represents an edge. The silent prefix sum operation may then compute the cumulative sum of these boolean variables, resulting in a vector of vertex identifiers that uniquely identify each vertex in the graph.

In other embodiments, the silent prefix sum operation may be performed in a parallel manner to improve the efficiency of the method. For example, the operation may be performed in parallel for each block of tuples in the secret-shared adjacency list. This parallel computation may reduce the computational complexity of the method, making it more suitable for large-scale graphs with a large number of vertices and edges.

In yet other embodiments, the silent prefix sum operation may be performed in a secure manner to ensure the confidentiality of the graph's structure. For instance, the operation may be performed using secure two-party or multi-party computation techniques that allow the parties to jointly compute the prefix sum without revealing their private inputs. This secure computation may ensure that no information about the graph's structure is revealed during the process, thereby maintaining the confidentiality of the graph.

In some aspects, the method may involve assigning an address to each tuple in the secret-shared adjacency list. The address may correspond to the tuple's position in the list. This assignment may be performed in a secure and oblivious manner, ensuring that no information about the structure of the graph is revealed during the process. The assigned addresses may be used to facilitate the efficient and secure traversal of the adjacency list, as well as the efficient and secure insertion or deletion of vertices or edges in the adjacency list. For instance, when a new vertex or edge is inserted, the addresses may be updated accordingly to reflect the change in the adjacency list of the affected vertex. Similarly, when a vertex or edge is deleted, the addresses may be updated to reflect the change in the adjacency list of the affected vertex. These operations may be performed in a secure and oblivious manner, ensuring that no information about the graph's structure is revealed during the process.

In some embodiments, the method may involve defining a boolean variable for each block in the secret-shared adjacency list to indicate whether the first entry of the block is an edge or a vertex. This boolean variable may be computed using a secure comparison operation that compares the first entry of the block with a predetermined edge indicator value. If the first entry matches the edge indicator value, the boolean variable may be set to a value indicating that the first entry is an edge. Otherwise, the boolean variable may be set to a value indicating that the first entry is a vertex. This process may be performed in a secure and oblivious manner, ensuring that no information about the structure of the graph is revealed during the process. The boolean variable for each block may be used to facilitate the efficient and secure processing of the adjacency list, as it allows for the quick and secure identification of the vertices and edges in each block.

In some aspects, the method may involve performing an oblivious sort on the secret-shared adjacency list based on a comparison predicate that sorts tuples alphabetically by vertex names and prioritizes vertices over edges. This sorting operation may be performed in a secure and oblivious manner, ensuring that no information about the structure of the graph is revealed during the process. The comparison predicate used for the sorting operation may be designed to compare the alphanumeric names of the vertices represented by the tuples, and to prioritize tuples representing vertices over tuples representing edges. This may facilitate the efficient and secure processing of the adjacency list, as it allows for the quick and secure identification of the vertices and edges in the graph.

In some cases, the oblivious sort operation may be performed using a secure sorting algorithm that compares tuples based on their vertex names and the type of the tuples (i.e., whether they represent a vertex or an edge). The secure sorting algorithm may be designed to ensure that tuples representing vertices are sorted before tuples representing edges, and that tuples representing vertices with the same name are sorted together. This may facilitate the efficient and secure processing of the adjacency list, as it allows for the quick and secure identification of the vertices and edges in the graph.

In other embodiments, the oblivious sort operation may be performed in parallel for all tuples in the secret-shared adjacency list. This parallel computation may reduce the computational complexity of the method, making it more suitable for large-scale graphs with a large number of vertices and edges. The parallel oblivious sort operation may be performed using secure multi-party computation techniques that allow the parties to jointly compute the sort operation without revealing their private inputs. This secure computation may ensure that no information about the graph's structure is revealed during the process, thereby maintaining the confidentiality of the graph.

In yet other embodiments, the oblivious sort operation may be performed in a secure manner to ensure the confidentiality of the graph's structure. For instance, the operation may be performed using secure multi-party computation techniques that allow the parties to jointly compute the sort operation without revealing their private inputs. This secure computation may ensure that no information about the graph's structure is revealed during the process, thereby maintaining the confidentiality of the graph.

In some aspects, the method may involve adding a new variable to each tuple in the sorted list to represent the new integer vertex name. This new variable may be a secret-shared value that is computed based on the properties of the vertex or edge represented by the tuple. For example, the new variable may be a hash value computed from the vertex label or name, or a function of the edge weight or other edge attributes. This secret-shared new variable may be added to each tuple in the secret-shared adjacency list, providing a secure and efficient means of identifying vertices and edges in the graph.

In some cases, the new variable may be a multi-bit value that uniquely identifies each vertex in the graph. This multi-bit new variable may be added to each tuple in the secret-shared adjacency list, allowing for the efficient and secure identification of vertices and the edges connecting them. The multi-bit new variable may be generated in a secure and oblivious manner, ensuring that no information about the graph's structure is revealed during the process.

In other embodiments, the new variable may be a binary value, with one value (e.g., ‘1’) indicating that the tuple represents a vertex and another value (e.g., ‘0’) indicating that the tuple represents an edge. This binary new variable may be added to each tuple in a secure and oblivious manner, ensuring that no information about the graph's structure is revealed during the process.

In yet other embodiments, the new variable may be a secret-shared value that is computed based on the properties of the vertex or edge represented by the tuple. For example, the new variable may be a hash value computed from the vertex label or name, or a function of the edge weight or other edge attributes. This secret-shared new variable may be added to each tuple in the secret-shared adjacency list, providing a secure and efficient means of identifying vertices and edges in the graph.

In some aspects, the method may involve executing a parallel name extension subroutine that extends the new integer vertex name across tuples with the same alphanumeric name. This sub- routine may be designed to process multiple tuples in parallel, thereby improving the efficiency of the method. The parallel name extension subroutine may be performed in a secure and oblivious manner, ensuring that no information about the graph's structure is revealed during the process.

In some cases, the parallel name extension subroutine may involve computing a secret-shared vector of new integer vertex names for each tuple in the secret-shared adjacency list. This vector may be computed based on the alphanumeric names of the vertices represented by the tuples and the new integer vertex names assigned to these vertices. The computation of the vector of new integer vertex names may be performed using a secure prefix sum operation that aggregates the new integer vertex names associated with each tuple in the secret-shared adjacency list. This operation may generate a vector of new integer vertex names that are secret-shared and that can be used to facilitate the efficient and secure processing of the adjacency list.

In other embodiments, the parallel name extension subroutine may involve updating the new integer vertex name of each tuple in the secret-shared adjacency list based on the computed vector of new integer vertex names. This update may be performed in a secure and oblivious manner, ensuring that no information about the graph's structure is revealed during the process. The updated new integer vertex names may be used to facilitate the efficient and secure traversal of the adjacency list, as well as the efficient and secure insertion or deletion of vertices or edges in the adjacency list.

In yet other embodiments, the parallel name extension subroutine may involve performing a secure shuffle operation on the tuples in the secret-shared adjacency list after the new integer vertex names have been updated. This shuffle operation may be designed to randomize the positions of tuples in the adjacency list, thereby further enhancing the security of the method. The shuffled tuples may maintain the structure of the adjacency list, facilitating the efficient and secure processing of the graph.

In some embodiments, the method may involve shuffling the tuples with the new integer vertex names using a secure shuffle algorithm. This shuffling operation may be performed in a secure and oblivious manner, ensuring that no information about the structure of the graph is revealed during the process. The shuffled tuples may include both the original tuples from the secret-shared adjacency list and the additional tuples created to fill empty rows in the resulting two-dimensional array. The secure shuffle algorithm may be designed to ensure that the shuffle operation is unpredictable and secure, thereby maintaining the confidentiality of the graph's structure.

In some cases, the secure shuffle algorithm may be based on a fresh permutation sampled for each execution of the shuffle. This fresh permutation may be a random permutation of the positions of the tuples, generated using a secure random number generator. The use of a fresh permutation for each shuffle operation may ensure that the shuffle operation is not deterministic and cannot be predicted based on previous shuffle operations, thereby enhancing the security of the method.

In other embodiments, the secure shuffle algorithm may be designed to ensure that the shuffled tuples maintain the structure of the d-normalized replicated adjacency list. For instance, the secure shuffle algorithm may be designed to ensure that tuples representing vertices and edges of the same vertex remain adjacent in the shuffled list, and that tuples representing vertices precede tuples representing edges of the same vertex. This may facilitate the efficient processing of the d-normalized replicated adjacency list, as it allows for the quick and secure identification of the vertices connected by each edge.

In yet other embodiments, the secure shuffle algorithm may be designed to ensure that the shuffled tuples maintain the order of vertices and edges within each block of the d-normalized replicated adjacency list. This may facilitate the efficient traversal and processing of the adjacency list, as it allows for the quick and secure identification of the vertices and edges in each block.

In some embodiments, the method may involve revealing the addresses of the shuffled tuples and sorting the tuples in the clear based on the revealed addresses to finalize the renaming of vertices and attribution of edges. This operation may be performed in a secure and oblivious manner, ensuring that no information about the structure of the graph is revealed during the process. The revealed addresses may correspond to the original positions of the tuples in the secret-shared adjacency list, allowing for the restoration of the original order of the tuples after the shuffling operation.

In some cases, the sorting operation may be performed using a secure sorting algorithm that compares the revealed addresses of the tuples and arranges the tuples in the d-normalized replicated adjacency list based on the results of the comparison. This may facilitate the efficient and secure processing of the adjacency list, as it allows for the quick and secure identification of the vertices and edges in the graph.

In other embodiments, the sorting operation may be performed in parallel for all tuples in the shuffled list. This parallel computation may reduce the computational complexity of the method, making it more suitable for large-scale graphs with a large number of vertices and edges. The parallel sorting operation may be performed using secure multi-party computation techniques that allow the parties to jointly compute the sort operation without revealing their private inputs. This secure computation may ensure that no information about the graph's structure is revealed during the process, thereby maintaining the confidentiality of the graph.

In yet other embodiments, the sorting operation may be performed in a secure manner to ensure the confidentiality of the graph's structure. For instance, the operation may be performed using se- cure multi-party computation techniques that allow the parties to jointly compute the sort operation without revealing their private inputs. This secure computation may ensure that no information about the graph's structure is revealed during the process, thereby maintaining the confidentiality of the graph.

In the context of the computerized systems described in the “list tech” document, the claimed methods for converting a secret-shared adjacency list into a d-normalized replicated adjacency list and renaming vertices and attributing edges in a secret-shared adjacency list can be implemented using a combination of database management, secure multi-party computation (MPC), and cryptographic techniques.

The computerized systems may include two or more servers and databases configured to store and manage the adjacency list of a graph representing a computer network. These systems can execute the steps of the claimed methods by performing the following operations:
1. Database Management: The systems can utilize relational databases to store the adjacency list and other related data structures. Database operations such as insertions, deletions, and queries can be performed to manage the vertices and edges of the graph. Normalized tables can be designed to minimize redundancy and ensure efficient access to the graph data.
2. Secure Multi-Party Computation (MPC): The systems can employ MPC protocols to perform computations on the secret-shared adjacency list without revealing the underlying data to any of the participating parties. Operations such as secure prefix sum, secure comparison, secure shuffle, and secure sorting can be executed within the MPC framework to maintain the confidentiality of the graph's structure.
3. Cryptographic Techniques: Cryptographic functions such as hash functions and pseudorandom number generators can be used to compute vertex identifiers, edge attributes, and to gencrate fresh permutations for shuffling operations. These cryptographic techniques ensure that the operations are secure and that the resulting data structures, such as the d-normalized replicated adjacency list, do not leak any sensitive information.
4. Parallel Processing: The systems can leverage parallel processing capabilities to execute operations on multiple tuples of the adjacency list simultaneously. This approach can reduce the computational complexity and improve the scalability of the methods, making them suitable for large-scale graphs with many vertices and edges.
5. Secure Renaming and Attribution: The systems can implement the renaming of vertices and attribution of edges by computing new integer vertex names and updating the adjacency list accordingly. This process can be done securely and obliviously, ensuring that the graph's topology remains confidential.

By integrating these components, the computerized systems can efficiently and securely implement the claimed methods, enabling the representation and processing of graphs in a manner that is both space-efficient and privacy-preserving. This implementation is particularly beneficial in scenarios where the graph data is sensitive, such as in networks with strict privacy requirements or where the graph represents confidential relationships between entities.

### Embodiments of Applications

The methods, systems, and non-transitory computer-readable media described herein may find application in various domains where secure graph processing is required while maintaining privacy of the underlying graph structure. The disclosed techniques for converting secret-shared adjacency lists into d-normalized replicated adjacency lists and renaming vertices may be particularly beneficial in scenarios involving sensitive network data, collaborative computation, and privacy-preserving analytics.

### Privacy-Preserving Navigation Systems

In some cases, the disclosed methods may be applied to navigation systems where route information and location data require protection. Navigation systems may utilize graph representations where vertices represent geographic locations and edges represent road segments or transportation links. The method for converting a secret-shared adjacency list of a graph into a d-normalized replicated adjacency list may enable secure computation of shortest paths without revealing specific locations or frequently traveled routes.

The partitioning of the secret-shared adjacency list into consecutive blocks of d tuples each may allow navigation systems to process route segments in uniform chunks while maintaining obliviousness to the actual road network topology. The vertex identifier added to each tuple may distinguish between location nodes and road connections without exposing the specific geographic coordinates or street names. The boolean variable defined for each block may indicate whether route segments continue from previous blocks, enabling efficient traversal of complex road networks.

In some aspects, the renaming of vertices and attributing edges in a secret-shared adjacency list may transform alphanumeric location identifiers into integer representations. The secure marking of all vertices as secret-shares of 1 and all edges as secret-shares of 0 may enable the system to distinguish between intersections and road segments. The oblivious sort performed on the secret-shared adjacency list based on a comparison predicate may organize location data alphabetically while prioritizing intersection nodes over connecting roads.

The name extension subroutine may extend new integer vertex names across tuples with the same geographic identifier, ensuring consistent mapping of location references throughout the navigation database. The shuffling of tuples with new integer vertex names using a secure shuffle algorithm may prevent correlation attacks that could reveal frequently accessed locations or travel patterns.

### Secure Graph Processing In Distributed Systems

The disclosed methods may be implemented in distributed computing environments where multiple parties collaborate on graph analysis without revealing their private data contributions. In some cases, the conversion of secret-shared adjacency lists into d-normalized replicated adjacency lists may enable efficient processing of large-scale networks across multiple servers while maintaining data confidentiality.

The computation of secret-shared vectors of row identifiers for each tuple may facilitate distributed storage and retrieval of graph components across multiple computing nodes. The secure prefix sum operation that aggregates boolean variables associated with each tuple may enable parallel processing of graph segments without requiring centralized coordination or data disclosure.

The boolean variables defined for each tuple to indicate first or last edges within blocks may support distributed algorithms that process graph neighborhoods in parallel. The creation of additional tuples to fill empty rows in the resulting two-dimensional array may ensure uniform data distribution across computing resources, preventing inference of graph structure from load balancing patterns.

In some aspects, the secure shuffle algorithm that randomly permutes tuple positions may prevent timing-based side-channel attacks in distributed environments. The secure selection operation that retrieves tuples based on shuffled positions may enable oblivious access patterns that do not reveal which graph components are being processed by specific computing nodes.

### Computational Biology Applications

The methods described herein may be applied to biological network analysis where genetic sequences, protein interactions, or metabolic pathways require privacy protection. In some cases, the d-normalized replicated adjacency list representation may enable secure computation of biological network properties without exposing sensitive genomic information.

The partitioning of biological interaction networks into consecutive blocks may allow researchers to analyze protein complexes or gene regulatory modules while maintaining confidentiality of specific molecular identities. The vertex identifiers may distinguish between biological entities such as genes, proteins, or metabolites and their interaction relationships.

The renaming of vertices from alphanumeric biological identifiers to integer representations may enable secure comparison of biological networks across different research institutions without revealing specific gene names or protein sequences. The prefix sum operation performed to compute vertex identifiers may assign distinct integer identifiers to biological entities in a manner that preserves network topology while protecting molecular identities.

The oblivious sort based on comparison predicates may organize biological data alphabetically by molecular names while maintaining the distinction between entities and their interactions. The parallel name extension subroutine may ensure consistent mapping of biological identifiers across different naming conventions or database formats.

### Social Network Analysis

In some cases, the disclosed methods may be applied to social network platforms where user privacy and relationship confidentiality are paramount. The conversion of social graphs into dnormalized replicated adjacency lists may enable analysis of network properties such as community structure or influence propagation without exposing individual user connections.

The secret-shared adjacency list representation may protect user identities while enabling computation of network metrics such as centrality measures or clustering coefficients. The partitioning into blocks of d tuples may allow processing of user neighborhoods without revealing specific friendship patterns or social connections.

The boolean variables indicating whether blocks contain user nodes or relationship edges may enable differentiation between social entities and their connections while maintaining privacy. The dummy elements added to blocks may prevent inference of user popularity or social activity levels from data structure patterns.

The renaming of vertices may transform user identifiers into anonymous integer representations while preserving the ability to compute social network algorithms. The secure shuffle algorithm may prevent correlation of user activities across different analysis sessions, protecting long-term privacy of social interactions.

### Financial Network Security

The methods may be implemented in financial systems where transaction networks and institutional relationships require protection from unauthorized disclosure. In some aspects, the d-normalized adjacency list representation may enable secure analysis of payment flows, credit relationships, or market connections without exposing sensitive financial information.

The partitioning of financial networks into uniform blocks may allow detection of suspicious transaction patterns or money laundering activities while protecting individual account details. The vertex identifiers may distinguish between financial institutions, accounts, or transaction types without revealing specific entity identities.

The secure computation of row identifiers may enable distributed processing of financial networks across multiple regulatory agencies or financial institutions while maintaining data confiden- tiality. The boolean variables for block boundaries may support analysis of transaction sequences or payment chains without exposing individual transaction details.

The renaming of financial entities from institutional identifiers to integer representations may enable cross-institutional analysis of systemic risks or market correlations. The oblivious sort may organize financial data while maintaining separation between institutions and their transaction relationships.

### Supply Chain Privacy

In some cases, the disclosed methods may be applied to supply chain networks where vendor relationships, logistics routes, and inventory flows require confidentiality protection. The conversion to d-normalized replicated adjacency lists may enable optimization of supply chain operations while protecting competitive business information.

The partitioning of supply chain graphs may allow analysis of logistics efficiency or bottleneck identification without revealing specific supplier relationships or trade secrets. The vertex identifiers may distinguish between suppliers, manufacturers, distributors, and transportation links while maintaining business confidentiality.

The secure processing of supply chain adjacency lists may enable collaborative optimization across multiple companies without exposing proprietary supplier networks or pricing information. The boolean variables may indicate continuation of supply chains across organizational boundaries while protecting individual business relationships.

The renaming of supply chain entities may enable benchmarking and performance comparison across different industries or geographic regions without revealing specific company identities or competitive advantages.

Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “network” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners.

It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (GPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as Field-Programmable Gate Arrays (FPGAs) for applications requiring specialized processing configurations, ApplicationSpecific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for distributed network applications, cloud-based and distributed processors, multicore and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a “processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrary-length plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, footers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term “storing” or “storage” as used in this specification may encompass both persistent and transient data retention. In some cases, the storage may be entirely ephemeral, lasting only for the duration of a specific operation or process. The use of these terms does not imply any particular time period for data retention or any level of permanence. Storage and storing may be as brief as a few microseconds or indefinitely long, depending on the specific implementation and requirements of the system.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing non-volatile retention of larger data volumes; and tertiary storage for archival purposes. The terminology extends to distributed storage architectures such as network-attached storage (NAS), storage area networks (SAN), directattached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain dataᵢ and non-volatile storage that preserves data without power. It also includes immutable storage that prevents modification of stored dataᵢ append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoSQL databases, NewSQL databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, availability, and scalability.

The database may be hosted on-premises, in the cloud, or in a hybrid environment, and may support various access methods including direct queries, API calls, or event-driven architectures. The term “database” further encompasses specialized data storage and management systems designed for particular domains or use cases. This includes blockchain and distributed ledger technologies used for secure, decentralized transaction records, edge databases optimized for resourceconstrained environments, vector databases for high-dimensional data, time-series databases for temporal data management, knowledge graphs for representing interconnected information, fedcrated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) displays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, color-shifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A method for converting a secret-shared adjacency list of a graph into a d-normalized replicated adjacency list, the method comprising:
on a computerized system comprising at least one processor, a memory, a non-volatile storage device, and a network interface connected via a system bus:
partitioning, by the at least one processor executing instructions stored in the memory, the secret-shared adjacency list into consecutive blocks of d tuples each, wherein each block is of the same length and consists of tuples of the same length, and padding the last block with dummy elements as needed;
adding, by the at least one processor, a vertex identifier to each tuple in the secret-shared adjacency list to indicate whether the tuple represents a vertex or an edge, and to identify the vertex to which an edge belongs;
defining, by the at least one processor, a boolean variable for each block to indicate whether the first entry of the block is an edge or a vertex;
computing, by the at least one processor, a secret-shared vector of row identifiers for each tuple;
shuffling, by the at least one processor, the tuples;
extracting, by the at least one processor, components from the shuffled tuples to form the dnormalized replicated adjacency list;
storing, by the at least one processor, the d-normalized replicated adjacency list in the non-volatile storage device;
wherein the method is executed in a manner that is oblivious to the contents of the tuples, ensuring that the conversion process does not reveal any information about the graph other than the total number of vertices and edges.

2. The method of claim 1, further comprising computing the secret-shared vector of row identifiers for each tuple in the secret-shared adjacency list by adding a prefix-sum on the vertex identifiers and the boolean variables for each block that check if the first entry is an edge or a vertex.

3. The method of claim 1, further comprising defining a boolean variable for each tuple to indicate whether the tuple is the first edge or the last edge within a block.

4. The method of claim 1, further comprising creating additional tuples to fill empty rows in a resulting two-dimensional array with dummy elements.

5. The method of claim 1, wherein the dummy elements added to the blocks are secret-shared representations of a non-existent vertex or edge, ensuring that the presence of the dummy elements does not reveal the actual structure of the graph.

6. The method of claim 1, wherein the boolean variable for each block indicating whether the first entry of the block is an edge or a vertex is computed using a secure comparison operation that compares the block's first entry with a predetermined edge indicator value.

7. The method of claim 1, wherein the secret-shared vector of row identifiers is computed using a secure prefix sum operation that aggregates the boolean variables associated with each tuple in the secret-shared adjacency list.

8. The method of claim 1, wherein the numbering of each tuple within each block from one to d is performed using a secure counting operation that assigns consecutive numbers to tuples within the same block without revealing their content.

9. The method of claim 1, wherein the boolean variable for each tuple indicating whether the tuple is the first edge or the last edge within a block is determined using secure logic operations that evaluate the adjacency of tuples within the block.

10. The method of claim 1, wherein the shuffling of the tuples is performed using a secure shuffle algorithm that randomly permutes the positions of the tuples without revealing their original or final positions.

11. The method of claim 1, wherein the components extracted from the shuffled tuples to form the d-normalized replicated adjacency list are selected using a secure selection operation that retrieves tuples based on their shuffled positions.

12. The method of claim 1, wherein a binary continuation marker for each row in the d-normalized replicated adjacency list is computed using a secure evaluation of adjacency between consecutive rows, indicating whether the adjacency list of a vertex spans multiple rows.

13. The method of claim 1, wherein the d-normalized replicated adjacency list is stored in a secure data structure that supports oblivious access to the adjacency lists of vertices, facilitating secure graph algorithms without revealing the graph's topology.

14. A method for renaming vertices and attributing edges in a secret-shared adjacency list of a graph, the method comprising:
on a computerized system comprising at least one processor, a memory, a non-volatile storage device, and a network interface connected via a system bus:
(a) securely marking, by the at least one processor executing instructions stored in the memory, all vertex as secret-shares of 1 and all edges as secret-shares of 0;
b) computing, by the at least one processor, a secret-shared vector of vertex identifiers for each tuple in the secret-shared adjacency list using a prefix sum operation, wherein each tuple represents either a vertex or an edge, and the vertex identifier indicates the vertex to which an edge belongs or the vertex numbering for vertices;
c) assigning, by the at least one processor, an address to each tuple in the secret-shared adjacency list, the address corresponding to the tuple's position in the list;
d) performing, by the at least one processor using a hardware-accelerated sorting algorithm, an oblivious sort on the secret-shared adjacency list based on a comparison predicate that sorts tuples alphabetically by vertex names and prioritizes vertices over edges;
e) after sorting by alphanumeric identities, executing, by the at least one processor, a name extension subroutine that extends the new integer vertex name across tuples with the same alphanumeric name;
f) shuffling, by the at least one processor, the tuples with the new integer vertex names using a secure shuffle algorithm; and
g) revealing, by the at least one processor, the assigned addresses computed in step (b) of the shuffled tuples and placing tuples in their original position from step (b) to finalize the renaming of vertices and attribution of edges;
wherein the method is executed in a manner that is oblivious to the contents of the tuples, ensuring that the renaming process does not reveal any information about the graph other than the total number of vertices and edges.

15. The method of claim 14, further comprising adding a new variable to each tuple in the sorted list to represent the new integer vertex name, wherein the new variable is determined based on whether the tuple represents a vertex or an edge and the existence of a corresponding vertex tuple with the same alphanumeric name.

16. The method of claim 14, wherein the prefix sum operation is performed to compute the vertex identifiers for each tuple in the secret-shared adjacency list, ensuring that each vertex is assigned a distinct integer identifier in increasing order.

17. The method of claim 14, wherein the assigning an address to each tuple in the secret-shared adjacency list comprises assigning an address that corresponds to the tuple's original position in the list, facilitating the restoration of the list's original order after sorting.

18. The method of claim 14, wherein the oblivious sort is performed based on a comparison predicate that sorts the tuples alphabetically by vertex names and prioritizes vertices over edges to maintain the adjacency list's structure.

19. The method of claim 14, wherein adding a new variable to each tuple in the sorted list comprises determining the new variable based on the tuple's representation of a vertex or an edge and the existence of a corresponding vertex tuple with the same alphanumeric name.

20. The method of claim 14, wherein the name extension subroutine is executed in parallel to extend the new integer vertex name across tuples with the same alphanumeric name, ensuring consistent renaming of vertices and attribution of edges.

21. The method of claim 14, wherein the shuffling of the tuples with the new integer vertex names comprises performing a secure shuffle to randomize their positions while preserving the renamed adjacency list's structure.

22. The method of claim 14, wherein revealing the assigned addresses of the shuffled tuples comprises revealing the addresses computed in step (c) and sorting the tuples based on the revealed addresses to finalize the renaming of vertices and attribution of edges.

23. The method of claim 14, wherein the secure shuffle algorithm uses a fresh permutation sampled for each execution of the shuffle, ensuring that the shuffle operation is unpredictable and secure.

24. The method of claim 14, further comprising storing the final sorted adjacency list with renamed vertices and attributed edges in a secure data structure that supports oblivious access, maintaining the confidentiality of the graph's topology.

25. The method of claim 14, wherein the method is executed without revealing any information about the graph's topology or the original alphanumeric names of the vertices.

26. A system for converting a secret-shared adjacency list of a graph into a d-normalized replicated adjacency list, the system comprising:
a plurality of processors;
a memory subsystem comprising high-speed cache memory and main memory;
a non-volatile storage device;
a network interface configured for secure communication;
a system bus interconnecting the plurality of processors, memory subsystem, non-volatile storage device, and network interface; and
a memory storing instructions that, when executed by the plurality of processors, cause the system to:
partition the secret-shared adjacency list into consecutive blocks of d tuples each, wherein each block is of the same length and consists of tuples of the same length, and padding the last block with dummy elements as needed;
add a vertex identifier to each tuple in the secret-shared adjacency list to indicate whether the tuple represents a vertex or an edge, and to identify the vertex to which an edge belongs;
define a boolean variable for each block to indicate whether the first entry of the block is an edge or a vertex;
compute a secret-shared vector of row identifiers for each tuple;
shuffle the tuples; and
extract components from the shuffled tuples to form the d-normalized replicated adjacency list;
wherein the system executes the method in a manner that is oblivious to the contents of the tuples, ensuring that the conversion process does not reveal any information about the graph other than the total number of vertices and edges.

27. The system of claim 26, wherein the memory further stores instructions that, when executed by the plurality of processors, cause the system to compute the secret-shared vector of row identifiers for each tuple in the secret-shared adjacency list by adding a prefix-sum on the vertex identifiers and the boolean variables for each block that check if the first entry of the block is an edge or a vertex.

28. The system of claim 26, wherein the memory further stores instructions that, when executed by the plurality of processors, cause the system to define a boolean variable for each tuple to indicate whether the tuple is the first edge or the last edge within a block.

29. A non-transitory computer-readable medium storing instructions that, when executed by a processor in a computerized system comprising multiple processors, a memory subsystem including cache memory and main memory, a non-volatile storage device, and a network interface connected via a system bus, cause the computerized system to perform a method for renaming vertices and attributing edges in a secret-shared adjacency list of a graph, the method comprising:
securely marking all vertex as secret-shares of 1 and all edges as secret-shares of 0;
computing a secret-shared vector of vertex identifiers for each tuple in the secret-shared adjacency list using a prefix sum operation, wherein each tuple represents either a vertex or an edge, and the vertex identifier indicates the vertex to which an edge belongs or the vertex numbering for vertices;
assigning an address to each tuple in the secret-shared adjacency list, the address corresponding to the tuple's position in the list;
performing, using a hardware-implemented sorting algorithm, an oblivious sort on the secret-shared adjacency list based on a comparison predicate that sorts tuples alphabetically by vertex names and prioritizes vertices over edges;
after sorting by alphanumeric identities, executing a parallel name extension subroutine that extends the new integer vertex name across tuples with the same alphanumeric name;
shuffling the tuples with the new integer vertex names using a secure shuffle algorithm;
revealing the assigned addresses computed in step (b) of the shuffled tuples and sorting the tuples in the clear based on the revealed addresses to finalize the renaming of vertices and attribution of edges;
wherein the method is executed in a manner that is oblivious to the contents of the tuples, ensuring that the renaming process does not reveal any information about the graph other than the total number of vertices and edges.

30. The non-transitory computer-readable medium of claim 29, wherein the method further comprises adding a new variable to each tuple in the sorted list to represent the new integer vertex name, wherein the new variable is determined based on whether the tuple represents a vertex or an edge and the existence of a corresponding vertex tuple with the same alphanumeric name.
